(19) United States
(12) Patent Application Publication
(10) Pub. No.: US 2025/0114171 A1
(43) Pub. Date: Apr. 10, 2025

(54) HYBRID ABUTMENT FOR RESTORATIVE DENTAL SYSTEMS, AND METHODS FOR INSTALLING THE SAME

(71) Applicant: BIOMET 3i, LLC, Palm Beach Gardens, CO (US)

(72) Inventors: Werner Weithaler, Burgstall (IT); Ryan Weller, Palm City, FL (US); Juergen Fleischmann, Goldrain (IT); Andreas Geier, Gargazon (IT); Luke Austin, Palm Beach Gardens, FL (US); Zachary Suttin, Jupiter, FL (US)

(21) Appl. No.: 18/907,223

(22) Filed: Oct. 4, 2024

Related U.S. Application Data
(60) Provisional application No. 63/587,933, filed on Oct. 4, 2023.

(51) Int. Cl. A61C 8/00

(52) U.S. Cl. CPC A61C 8/005

(57) ABSTRACT

A hybrid abutment for restorative dental systems includes a restoration interface with an overdenture portion and a restoration portion that are each operable to couple to a plurality of restorative abutment components along a restorative axis, a receiver interface with at least one region operable to couple to a corresponding region on a receiver along an installation axis, and a restorative platform separating the restoration interface and the receiver interface. The restorative abutment component can include an overdenture or a restorative component with an optional resilient insert. The overdenture and the restorative component are interchangeable without switching either the hybrid abutment or the receiver. The hybrid abutment includes a main body with a single-build or multi-piece build or configuration. Where the receiver is an implant, at least a portion of the hybrid abutment and the implant can be formed as a monolithic component.

### CROSS-REFERENCE TO RELATED APPLICATIONS

This U.S. Non-Provisional patent application claims benefit of priority from U.S. Provisional Application Ser. No. 63/587,933, filed Oct. 4, 2023, the entire disclosure of which is hereby incorporated by reference.

### TECHNICAL FIELD

The present disclosure pertains generally, but not by way of limitation, to devices used in dental restoration systems and methods and, in particular, to a dental abutment. More specifically, the present disclosure relates to a hybrid abutment for restorative dental systems, and methods for installing the same, where the hybrid abutment is operable to interconnect with multiple types of restorative solutions.

### BACKGROUND

Restorative dental systems can use abutments to interconnect an implant installed within a patient to a restorative component (or “restoration”) such as a dental prosthesis. Restorative dental systems include a multi-unit restoration, or a restoration supported by multiple implants that traditionally replaces multiple teeth utilizing multi-unit abutments. In some instances, the multi-unit restoration is a full arch restoration. The multi-unit abutment-based restoration may be considered “fixed” in some restorative dental systems, meaning a patient cannot remove the multi-unit abutment without assistance from a medical professional such a clinician, an installing surgeon, or other dental practitioner. Restorative dental systems implementing the multi-unit abutment-based restoration may also include an overdenture (ODS) restoration, or a replacement of multiple teeth via a denture that mates with an abutment when positioned on gingival tissue. For fixed restorations and for removable restorations, there are intermediary elements between the restoration and the implants. In some instances, the intermediary elements are considered multi-unit abutments, as they are supporting a multi-unit restoration (e.g., including, but not limited to, a full arch or a shorter span). Fixed intermediary elements are one type of multi-unit abutment, and removable intermediary elements (e.g., overdenture-style) is another type of multi-unit abutment.

A fixed restoration is typically more desirable as it can provide a more stable and aesthetic configuration, leading to a more functional and realistic restorative solution. In particular, a fixed restoration can be entirely (or nearly entirely) supported by the installed implant (or implants) and does not require support from the underlying tissue and/or a fixation mechanism such as an adhesive as compared to a removable denture. However, known fixed restoration solutions are more expensive than implant-supported removable dentures. In addition, known fixed restoration solutions require a minimum amount of restorative platform within the mouth of the patient to conform to depth and/or thickness of the natural teeth of the patient. For example, conforming to the depth and/or thickness of the natural teeth is desirable to prevent an unnatural-appearing dental restoration, to prevent discomfort resulting from a new dental height within the mouth, and/or to conform to remaining natural teeth still within the patient's mouth.

### SUMMARY

As such, it would be beneficial to provide a hybrid dental abutment. The hybrid dental abutment should merge the fixed intermediary element and the removable intermediary element together to provide the full benefit of each, while minimizing any reduction in benefit of either. In particular, the hybrid dental abutment should combine aspects of the fixed multi-unit abutment with aspects of the overdenture abutment to provide an improvement over each design individually, while also providing a singular solution from which a wide range of removable and fixed restoration solutions can be achieved. The improvements of the hybrid dental abutment should include re-configurations of select aspects to minimize the height of the restoration system, as simply stacking aspects of both the fixed multi-unit abutment and the overdenture designs would likely result in a total height that is unworkable for most (or all) patients (e.g., such as where the restoration is too thick, too tall, and/or require unnecessary or excessive removal of bone to accommodate the dimensions of the restoration system). In addition, depending on the order of stacking, the overdenture abutment aspects would prevent the usability of the multi-unit abutment geometry, or alternatively, the multi-unit abutment aspects would prevent the usability of the overdenture abutment geometry.

Aspects of the present disclosure are directed to a hybrid dental abutment. The hybrid abutment for restorative dental systems includes a restoration interface with an overdenture portion and a restoration portion that are each operable to couple to a plurality of restorative abutment components along a restorative axis, a receiver interface with at least one region operable to couple to a corresponding region on a receiver along an installation axis, and a restorative platform separating the restoration interface and the receiver interface. The restorative abutment component can include either a resilient insert or other interior contoured surface (e.g., in a snap cap) at least partially embedded within an overdenture or a restorative component. The resilient insert or other interior contoured surface and the restorative component are interchangeable without switching either the hybrid abutment or the receiver. In embodiments, the receiver may be an implant installed within a patient or an analog or model that is before, during, or after installation to adjust the fit of the hybrid abutment and/or the overdenture or restorative component.

Aspects of the present disclosure are also directed to a restorative dental system or kit including a hybrid dental abutment, an implant, and a restoration component such as a prosthesis. The system includes a plurality of restorative abutment components and a hybrid abutment, where the hybrid abutment is couplable to the restorative abutment component and the implant. The hybrid abutment includes a restoration interface with an overdenture portion and a restoration portion that are each operable to couple to the plurality of restorative abutment components along a restorative axis, a receiver interface with at least one region operable to couple to a corresponding region on the implant along an installation axis, and a restorative platform separating the restoration interface and the receiver interface. The restorative abutment component can include either a resilient insert or other interior contoured surface (e.g., in a snap cap) at least partially embedded within the prosthesis. The resilient insert or other interior contoured surface and the restorative component are interchangeable without switching either the hybrid abutment or the implant.

Aspects of the present disclosure are also directed to a method for installing one or more components of the restorative dental system or kit, including the installation of a hybrid dental abutment. The method may include, but is not limited to, providing a receiver (e.g., an implant, an analog or model, or the like). The method may include, but is not limited to, coupling a hybrid abutment to an implant or other receiver. The hybrid abutment includes a restoration interface with an overdenture portion and a restoration portion that are each operable to couple to a plurality of restorative abutment components along a restorative axis, a receiver interface with at least one region operable to couple to a corresponding region on the implant or other receiver along an installation axis, and a restorative platform separating the restoration interface and the receiver interface. The method may include, but is not limited to, coupling a restorative abutment component to the hybrid abutment. The restorative abutment component can include either a resilient insert or other interior contoured coupling surface (e.g., within a snap cap) at least partially embedded within an overdenture or a restorative component. The resilient insert or interior contoured coupling surface and the restorative component are interchangeable without switching either the hybrid abutment or the implant or other receiver. It is noted that the implant may be pre-installed or may be installed as a part of the method herein.

Aspects of the present disclosure are directed to the hybrid abutment including an upper portion or restoration interface and a lower portion or receiver interface. The restoration interface includes an overdenture portion or denture section and a ridge sidewall. In some examples, the overdenture portion may include an arcuate surface operable to receive a restorative abutment component such as a resilient insert or interior contoured coupling surface or restorative component, while the ridge sidewall is operable to receive a restorative abutment component such as the restorative component. The receiver interface includes at least one receiver region, including a shaped region that is operable to mate with corresponding regions in the receivers.

Aspects of the present disclosure are directed to a hybrid abutment that is straight or substantially straight, with a restorative axis and an installation axis that are aligned. The hybrid abutment includes a restoration interface with a bore or aperture operable to receive a connector to secure a restorative implant component or other receiver to the hybrid abutment. The hybrid abutment may optionally include threading in a receiver interface that mates with corresponding threading of the implant or other receiver.

Aspects of the present disclosure are directed to a hybrid abutment that is angled, with a restorative axis and an installation axis being offset by an angle. The hybrid abutment includes a primary bore that is operable to receive a primary connector to secure a restorative implant component to the hybrid abutment. The hybrid abutment includes a secondary bore that is operable to receive a secondary connector to secure the hybrid abutment to the implant or other receiver. The hybrid abutment optionally includes a shaped region that corresponds to a shaped region in the implant or other receiver, to ensure proper alignment of the hybrid abutment to the implant or other receiver during installation.

In some instances, a plug may be necessary to prevent unwanted matter from entering the secondary bore. The plug may be partially or fully covered or protected by the restorative implant component.

In embodiments, select aspects of the hybrid abutment may be parts of the implant and/or the dental restoration to which the hybrid abutment is coupled. For example, the hybrid abutment could be fully part of the implant, and/or the dental restoration could be monolithic and include the mating component geometry. In one instance, where a resilient insert is required, the insert could be placed in the monolithic dental restoration or be assembled to or integrated with the hybrid abutment.

In embodiments, the hybrid abutment includes a main body with a first or distal portion and a second or proximal portion. The first or distal portion may include a receiver interface to engage with a receiver (e.g., an implant). Where the hybrid abutment is a monolithic build or configuration, the first or distal portion may include the implant. Where the hybrid abutment is not a monolithic build or configuration, a connector is inserted into the first or distal portion, and the second or proximal portion is then coupled to the first or distal portion to secure the connector within the main body. The seam between the portions may be at a restorative platform, or may be partially within a ridge sidewall.

In embodiments, the hybrid abutment includes a tool interface. For example, the tool interface may be an exterior tool interface that forms at least a portion of a ridge sidewall. By way of another example, the tool interface may be an interior tool interface within a bore or aperture operable to receive an optional connector, where a restorative component is coupled to the hybrid abutment with the optional connector. It is noted that the use of the optional connector may be in addition to a snapping or coupling of a resilient insert or other contoured interior surface of the restorative component onto a sidewall of the hybrid abutment. It is also noted that the snapping or coupling of the resilient insert or other contoured interior surface of the restorative component onto the sidewall of the hybrid abutment may be utilized without the optional connector.

It should be understood there may be a transient (or in-between) installation phase that exists between implant placement and the “final” restoration. It is contemplated that components both disclosed and not disclosed in this disclosure exist to facilitate this in-between phase, during which the implants and tissue are healing and the necessary data is being acquired to support the design and fabrication of a temporary or permanent prosthesis or dental restoration. These components are capable of interfacing with the hybrid abutment specified throughout the disclosure as a part of steps of a process of installing a dental restoration, where the steps may include, but are not limited to, helping heal the tissue, protecting the implant, supporting a temporary restoration (full arch or other restoration), deriving coordinate data from a digital scan, acquiring coordinate data from a temporarily placed marker, physically picking up the location of the hybrid abutment, and the like. In some instances, the data acquisition methods may include, but are not limited to, photography, computer tomography (CT) scanning, intra-oral scanning, photogrammetry, laser scanning, desktop (or extra-oral) scanning, magnetic resonance imaging (MRI) scanning, robotically sensed/probed/detected imaging, video recording, other data acquisition methods both with and without a fixed common coordinate system, a combination or one or more of these methods above, and the like.

This Summary is intended to provide an overview of subject matter of the present patent application. It is not intended to provide an exclusive or exhaustive explanation of the present disclosure. The detailed description is included to provide further information about the present patent application.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

It should be understood the drawings are not necessarily drawn to scale. In certain instances, details that are not necessary for an understanding of the disclosure or that render other details difficult to perceive may have been omitted. In addition, it should be understood that the disclosure is not necessarily limited to the particular embodiments illustrated herein. Further, it should be understood like numerals may describe similar components in different views. Like numerals having different letter suffixes may represent different instances of similar components. The drawings illustrate generally, by way of example, but not by way of limitation, various embodiments discussed in the present document.

FIG. 1A is a perspective view of a multi-unit abutment restorative solution.

FIG. 1B is a cross-section view of a multi-unit abutment restorative solution.

FIG. 2A is a perspective view of an overdenture restorative solution.

FIG. 2B is a cross-section view of an overdenture restorative solution.

FIG. 3A is a front elevation view of a hybrid abutment, in accordance with one or more embodiments of the present disclosure.

FIG. 3B is a top plan view of the hybrid abutment of FIG. 3A.

FIG. 3C is a partial perspective view of a variation of the hybrid abutment of FIG. 3A.

FIG. 3D is a top plan view of the hybrid abutment of FIG. 3C.

FIG. 3E is a front elevation view of a variation of the hybrid abutment of FIG. 3A.

FIG. 3F is a top plan view of the hybrid abutment of FIG. 3E.

FIG. 3G is a cross-section view of the hybrid abutment of FIG. 3E.

FIG. 4A is a cross-section view of a restorative system including the hybrid abutment of FIG. 3A, a restorative abutment component, and an implant.

FIG. 4B is a cross-section view of the restorative abutment component of FIG. 3A.

FIG. 4C is an alternate restorative system to FIG. 3A, including an abutment, a cap, and a connector.

FIG. 4D is a cross-section view of a restorative system including the hybrid abutment of FIG. 3A and a restorative abutment component.

FIG. 5A is a side elevation view of a hybrid abutment, in accordance with one or more embodiments of the present disclosure.

FIG. 5B is a cross-section view of the hybrid abutment of FIG. 5A.

FIG. 5C is a perspective view of the hybrid abutment of FIG. 5A.

FIG. 5D is a rear perspective view of the hybrid abutment of FIG. 5A.

FIG. 5E is a top plan view of the hybrid abutment of FIG. 5A.

FIG. 5F is a front elevation view of the hybrid abutment of FIG. 5A.

FIG. 5G is a perspective view of the hybrid abutment of FIG. 5A.

FIG. 5H is a top perspective view of the hybrid abutment of FIG. 5A.

FIG. 5I is a rear elevation view of the hybrid abutment of FIG. 5A.

FIG. 6A is a front elevation view of a plug for use with the hybrid abutment of FIG. 5A.

FIG. 6B is a side elevation view of the plug of FIG. 6A.

FIG. 6C is a top plan view of the plug of FIG. 6A.

FIG. 6D is a side elevation view of the plug of FIG. 6A.

FIG. 6E is a bottom plan view of the plug of FIG. 6A.

FIG. 7A is a cross-section view of a restorative system including the hybrid abutment of FIG. 5A, the plug of FIG. 6A, a restorative abutment component, an implant, and an implant screw.

FIG. 7B is a cross-section view of the restorative abutment component of FIG. 7A.

FIG. 7C is a partial cross-section and perspective view of the restorative system of FIG. 7A.

FIG. 7D is a partial cross-section and perspective view of the restorative system of FIG. 7A.

FIG. 7E is a cross-section view of a restorative system including the hybrid abutment of FIG. 5A and a restorative abutment component.

FIG. 7F is a cross-section view of the restorative system of FIG. 7E.

FIG. 7G is a cross-section view of a restorative system including the hybrid abutment of FIG. 5A and a restorative abutment component.

FIG. 8A is a side elevation view of a hybrid abutment, in accordance with one or more embodiments of the present disclosure.

FIG. 8B is a cross-section view of the hybrid abutment of FIG. 8A.

FIG. 8C is a perspective view of the hybrid abutment of FIG. 8A.

FIG. 8D is a rear perspective view of the hybrid abutment of FIG. 8A.

FIG. 8E is a top plan view of the hybrid abutment of FIG. 8A.

FIG. 8F is a front elevation view of the hybrid abutment of FIG. 8A.

FIG. 8G is a perspective view of the hybrid abutment of FIG. 8A.

FIG. 8H is a top perspective view of the hybrid abutment of FIG. 8A.

FIG. 8I is a rear elevation view of the hybrid abutment of FIG. 8A.

FIG. 9A is a front elevation view of a plug for use with the hybrid abutment of FIG. 8A.

FIG. 9B is a side elevation view of the plug of FIG. 9A.

FIG. 9C is a top plan view of the plug of FIG. 9A.

FIG. 9D is a side elevation view of the plug of FIG. 9A.

FIG. 9E is a bottom plan view of the plug of FIG. 9A.

FIG. 10A is a cross-section view of a restorative system including the hybrid abutment of FIG. 8A, the plug of FIG. 9A, a restorative abutment component, an implant, and an implant screw.

FIG. 10B is a cross-section view of the restorative abutment component of FIG. 10A.

FIG. 10C is a partial cross-section and perspective view of the restorative system of FIG. 10A.

FIG. 10D is a partial cross-section and perspective view of the restorative system of FIG. 10A.

FIG. 11A is a front elevation view of the abutment of FIG. 4C.

FIG. 11B is a front elevation view of the hybrid abutment of FIG. 5A.

FIG. 12A is a front elevation view of a restorative component with the abutment of FIG. 4C.

FIG. 12B is a front elevation view of a restorative component.

FIG. 12C is a front elevation view of the restorative component of FIG. 12B.

FIG. 13A is a perspective view of a restorative, in accordance with one or more embodiments of the present disclosure.

FIG. 13B is a see-through front elevation view of the restorative of FIG. 13A.

FIG. 13C is a second perspective view of the restorative of FIG. 13A.

FIG. 13D is a transparent perspective view of the restorative of FIG. 13C.

FIG. 13E is a series of images representing a process flow to assemble the restorative of FIG. 13C.

FIG. 13F is a series of images representing a process flow to install an overdenture solution without screws.

FIG. 13G is a series of images representing a process flow to install an overdenture solution with screws.

FIG. 14 is a see-through front elevation view of a restorative, in accordance with one or more embodiments of the present disclosure.

FIG. 15 is a perspective view of a scan body, in accordance with one or more embodiments of the present disclosure.

FIG. 16A is a cross-section view of a variation of the scan body of FIG. 15 with the hybrid abutment of FIG. 5A.

FIG. 16B is a cross-section view of a variation of the scan body of FIG. 15 with the hybrid abutment of FIG. 5A.

FIG. 16C is a cross-section view of a variation of the scan body of FIG. 15 with the hybrid abutment of FIG. 5A.

FIG. 17A is a cross-section view of the cap and hybrid abutment, in accordance with one or more embodiments of the present disclosure.

FIG. 17B is a cross-section view of a cap and abutment.

FIG. 17C is a front elevation view of a portion of a hybrid abutment, in accordance with one or more embodiments of the present disclosure.

FIG. 17D is a cross-section view of a cap and hybrid abutment, in accordance with one or more embodiments of the present disclosure.

FIG. 18A is a front elevation view of an implant, according to one or more embodiments of the present disclosure.

FIG. 18B is a front perspective view of the implant of FIG. 18A.

FIG. 18C is a side cross-section view of the implant of FIG. 18A.

FIG. 19 is a side elevation view of a monolithic hybrid abutment, according to one or more embodiments of the present disclosure.

FIG. 20A is a side elevation view of a hybrid abutment, in accordance with one or more embodiments of the present disclosure.

FIG. 20B is a cross-section view of the hybrid abutment of FIG. 20A.

FIG. 20C is a front elevation view of the hybrid abutment of FIG. 20A.

FIG. 20D is a rear elevation view of the hybrid abutment of FIG. 20A.

FIG. 20E is a top perspective view of the hybrid abutment of FIG. 20A.

FIG. 20F is an exploded perspective view of the hybrid abutment of FIG. 20A.

FIG. 21A is a side elevation view of a hybrid abutment, in accordance with one or more embodiments of the present disclosure.

FIG. 21B is a cross-section view of the hybrid abutment of FIG. 21A.

FIG. 21C is a front elevation view of the hybrid abutment of FIG. 21A.

FIG. 21D is a rear elevation view of the hybrid abutment of FIG. 21A.

FIG. 21E is a top perspective view of the hybrid abutment of FIG. 21A.

FIG. 21F is an exploded perspective view of the hybrid abutment of FIG. 21A.

FIG. 22A is a side elevation view of a hybrid abutment, in accordance with one or more embodiments of the present disclosure.

FIG. 22B is a cross-section view of the hybrid abutment of FIG. 22A.

FIG. 22C is a front elevation view of the hybrid abutment of FIG. 22A.

FIG. 22D is a rear elevation view of the hybrid abutment of FIG. 22A.

FIG. 22E is a top perspective view of the hybrid abutment of FIG. 22A.

FIG. 22F is an exploded perspective view of the hybrid abutment of FIG. 22A.

FIG. 22G is a side elevation view of a variation of the hybrid abutment of FIG. 22A.

FIG. 22H is a cross-section view of the hybrid abutment of FIG. 22G.

FIG. 22I is a front elevation view of the hybrid abutment of FIG. 22G.

FIG. 22J is a rear elevation view of the hybrid abutment of FIG. 22G.

FIG. 22K is a top perspective view of the hybrid abutment of FIG. 22G.

FIG. 22L is an exploded perspective view of the hybrid abutment of FIG. 22G.

FIG. 23A is a front elevation view of a hybrid abutment, in accordance with one or more embodiments of the present disclosure.

FIG. 23B is a cross-section view of the hybrid abutment of FIG. 23A.

FIG. 23C is a top plan view of the hybrid abutment of FIG. 23A.

FIG. 23D is an exploded view of the hybrid abutment of FIG. 23A.

FIG. 24A is a front elevation view of a monolithic hybrid abutment, in accordance with one or more embodiments of the present disclosure.

FIG. 24B is a cross-section view of the monolithic hybrid abutment of FIG. 24A.

FIG. 24C is a top plan view of the monolithic hybrid abutment of FIG. 24A.

FIG. 24D is an exploded view of the monolithic hybrid abutment of FIG. 24A.

FIG. 25A is a front elevation view of a monolithic hybrid abutment, in accordance with one or more embodiments of the present disclosure.

FIG. 25B is a cross-section view of the monolithic hybrid abutment of FIG. 25A.

FIG. 25C is a top plan view of the monolithic hybrid abutment of FIG. 25A.

FIG. 25D is an exploded view of the monolithic hybrid abutment of FIG. 25A.

FIG. 26A is a flow diagram for a method or process of installing a hybrid abutment in a restorative dental system, in accordance with one or more embodiments of the present disclosure.

FIG. 26B a flow diagram for a method or process of installing a hybrid abutment in a restorative dental system, in accordance with one or more embodiments of the present disclosure.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Various aspects of the present disclosure will be described herein with reference to drawings that may be schematic illustrations of idealized configurations.

Restorative dental systems can use abutments to interconnect an implant installed within a patient to a restorative component (or “restoration”) such as a dental prosthesis. One type of abutment is a multi-unit abutment (MUA), that supports a multi-unit restoration (e.g., a restoration “tied together” or supported by multiple implants), which traditionally replaces multiple teeth as part of the multi-unit abutment. Multi-unit abutments are utilized to raise a restorative platform of the implant, which is traditionally an uppermost or lowermost surface of the implant depending on the location of the implant in the lower jawbone (or mandible) or upper jawbone (or maxilla) of the patient, to instead be at or close to a surface of gingival tissue at or surrounding the location of the implant.

In some cases, the multi-unit abutment is retained to the implant via a fastener such as a screw inserted into both the multi-unit abutment and the implant. In addition, the restoration is additionally retained to the multi-unit abutment. For example, the restoration is retained to the multi-unit abutment via a fastener such as a screw inserted into at least the restoration and the multi-unit abutment.

At locations within the mouth of the patient, at least one of the multi-unit abutment and the implant is angled, or is set at a non-zero angle, relative to the respective jaw in which the multi-unit abutment and implant are installed. Alternatively, or in addition, at least one of the multi-unit abutment and the implant may be substantially straight, or may be set at an approximately 0 degree (0°) angle, relative to the respective jaw in which the multi-unit abutment and implant are installed. In embodiments, the angled placement of the multi-unit abutment and/or implant at the non-zero angle corrects the angulation of the implant axes (or assists in parallelizing the angulation of the restorative axes), which assists in the placement and removal of the restoration, to a possible end solution of all components being parallel or substantially parallel within the mouth of the patient. In general, the multi-unit abutment and/or the implant may be angled, may be straight or substantially straight, or may be a combination of angled and (substantially) straight. It is noted that the 0° angle is defined relative to the jawbone, including in non-limiting embodiments approximately perpendicular to an upper surface of the lower jawbone and/or a lower surface of the upper jawbone.

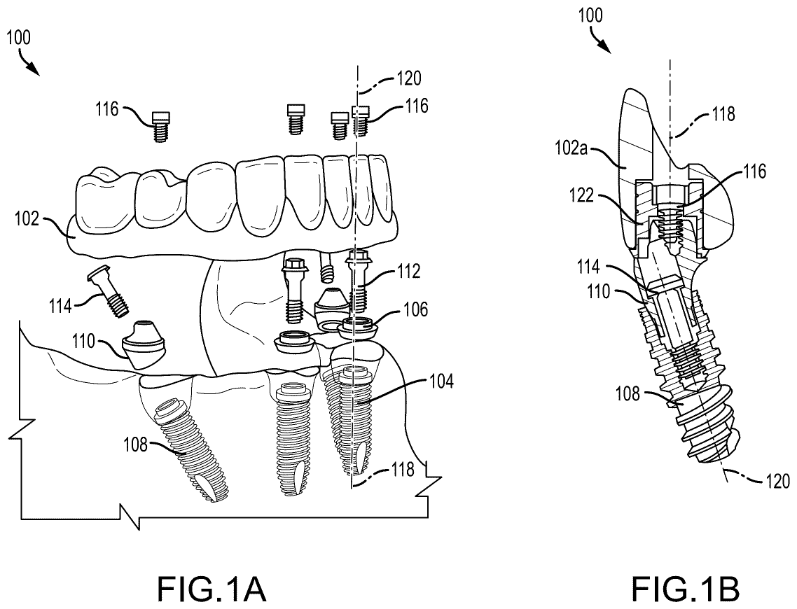

Restorative and implant axes may align where at least one of the multi-unit abutment and the implant are substantially straight, but may be unaligned where at least one of the multi-unit abutment and the implant are set at the non-zero angle. FIGS. 1A and 1B illustrate one example of a known “fixed” restorative solution in which an installation includes both aligned and non-aligned restorative and implant axes. In FIG. 1A, restorative system 100 includes a restoration 102, substantially straight implants 104 and substantially straight multi-unit abutments 106, and angled implants 108 and angled multi-unit abutments 110. Connectors 112, 114 (e.g., including a fastener such as a screw) couple the multi-unit abutments 106 to the implants 104 and the multi-unit abutments 110 to the implants 108, respectively. Similarly, connectors 116 (including a fastener such as a screw) couple the restoration 102 to the multi-unit abutments 106, 110. In FIG. 1B, an example angled restoration dental solution is illustrated, in which the angled multi-unit abutment 110 is coupled to the angled implant 108 via the connector 114, and in which the restoration 102a is coupled to the angled abutment 110 via the connector 116.

As illustrated in FIG. 1B, a restorative axis 118 is not in alignment with (or is not co-axial with) an implant axis 120, which causes the engaging features of the connector 116 (i.e., threading within the insertion bore or channel of the connector 116) to cut into the engaging features of the connector 114 (i.e., insertion bore or channel of the connector 114) for comparison in FIG. 1A, the restorative axis 118 is in alignment with the implant axis 120 for the substantially straight configuration.

There are a number of types of restorations, including bridges, bars, frameworks, permanent dentures (i.e., 102 in FIG. 1A), single-tooth installation (i.e., 102a in FIG. 1B), and the like that can utilize the connector type used for the multi-unit abutments. In addition, there are a number of types of restorative components that can mate to the multi-unit abutments and/or be embedded within the restoration, including titanium (Ti) bases, Ti cylinders, and the like. It is noted that restorative components may be useful to create an interface between the implant and the prosthesis, allowing for a universal connection between the general implant and the specifically-design prosthesis at a location at or above the jawline/gingival tissue line. Again referring to FIG. 1B, the solution in FIG. 1B includes a restorative component 122 positioned at least in part between the angled abutment 110 and the restoration 102a.

Although attempts have been made to keep the total height of the restorative platform as compact as possible, patients have limited inter-arch spacing. In some cases, installation of the known fixed restoration solutions may require modification of the patient, including removal of jawbone (e.g., shaving height from the jawbone) to respectively lower/raise the restorative platform and create “restorative space”, to afford a patient a proper closing position when the patient bites down or closes their mouth. The issue of inter-arch spacing is at least partially dictated by the restorative and implant axes, including whether they are aligned or not aligned. In particular, aligned restorative and implant axes may allow for a more compact configuration. Un-aligned restorative and implant axes, such as illustrated in a comparison of FIGS. 1A and 1B, however, require a minimum height to ensure the connectors 114 and 116 have sufficient engagement (i.e., complementary threading) with the implant 108, abutment 110, and/or restorative component 122, or at least to ensure that the connector 116 has sufficient engagement along the restorative axis 118.

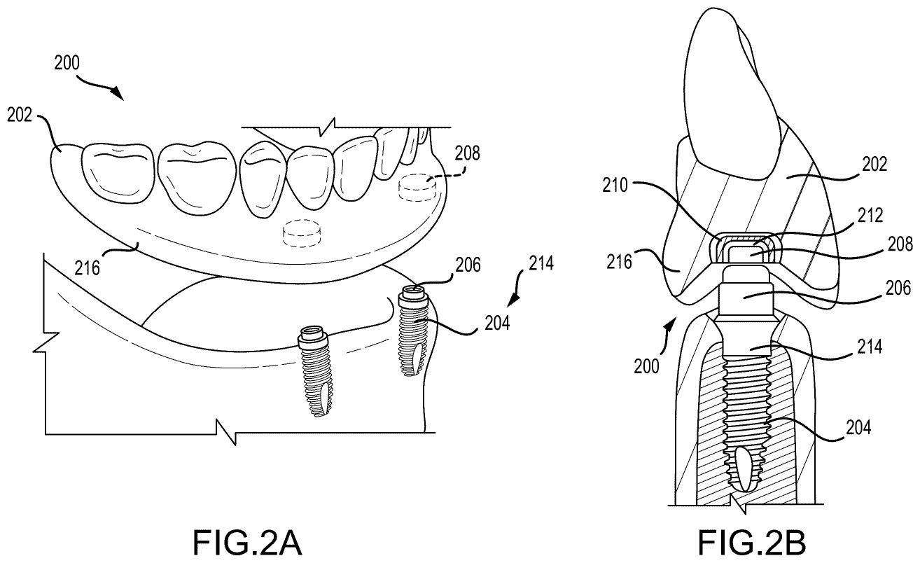

Another type of abutment is an overdenture (ODS) abutment. The overdenture abutment supports multi-unit restorations that traditionally replaces multiple teeth via a denture that mates with the abutment before being positioned on the tissue proximate to the respective jawbone. FIGS. 2A and 2B illustrate an example overdenture solution. In FIGS. 2A and 2B, restorative system 200 includes a restoration 202, one or more implants 204 installed within a jawbone, and one or more abutments 206 that are couplable to a corresponding implant 204. The restoration 202 includes caps 208 that each correspond to a respective abutment 206. Each cap 208 includes an outer portion 210 and an inner portion 212. For example, the outer portion 210 is fabricated from a largely rigid material, while the inner portion 212 is fabricated from a resilient material that allows for the continued connecting and disconnecting of the restoration 202 to an assembly 214 including the implant 204 and the abutment 206 installed within the jawbone.

Due to the resilient material of the inner portion 212, the overdenture restoration 202 is removable by a patient for cleaning. Requiring only a few implants per overdenture restoration 202, this is a more-cost effective solution than a completely fixed restoration. However, although the overdenture is better than a non-implant supported denture, it is not as stable or aesthetic as a completely fixed solution, meaning it is neither as functional nor as realistic-looking as a fixed solution. Notably, the restoration 202 as a flange or lip 216 that sits over the top and sides of the gingiva, leading to a poor aesthetic appearance. This flange or lip 216 is at least partially necessary to ensure the cap 208 is fully embedded within the overdenture restoration 202. It is noted that the caps 208 in FIG. 2A are shown only for purposes of visualization, but that the caps 208 would typically be fully embedded within the overdenture restoration 202 and not viewable from the exterior.

The present disclosure is directed to hybrid dental abutments for restorative solutions. The hybrid dental abutments provide an improvement over the multi-unit abutment and the overdenture abutment individually, while also providing a singular solution from which a wide range of removable and fixed restoration solutions can be achieved. The improvements of the hybrid dental abutment re-configures select aspects reduce the overall height of the restoration system to a minimum. In addition, the improvements of the hybrid dental abutment allow for the usability of both the multi-unit abutment geometry and the overdenture abutment geometry.

Although embodiments of the present disclosure are directed to the use of hybrid abutments to install multi-unit restorations that includes two or more teeth (e.g., up to a partial or full span), it should be understood that the hybrid abutments are usable with individual tooth or crown installations, where the individual tooth or crown is coupled directly to the hybrid abutments (e.g., via snapping of resilient inserts and/or connectors such as fasteners, or the like). In this regard, a hybrid abutment for purposes of the present disclosure may be considered usable with a restoration that includes a single tooth or crown configuration or build, or with a multi-tooth configuration or build with two or more teeth (e.g., up to a partial or full span installation like an overdenture).

It should be understood that some or all of the hybrid abutments of the present disclosure are couplable to a receiver. For example, the receiver may be an implant installed within a jawline of a patient or user. By way of another example, the receiver may be an analog or other temporary structure that is used as a model when determining fit prior to, during, or after installation in a patient (e.g., in the case of during or after, to make adjustments where the fit with an implant is not within (or becomes damaged to not be within) a pre-determined threshold value).

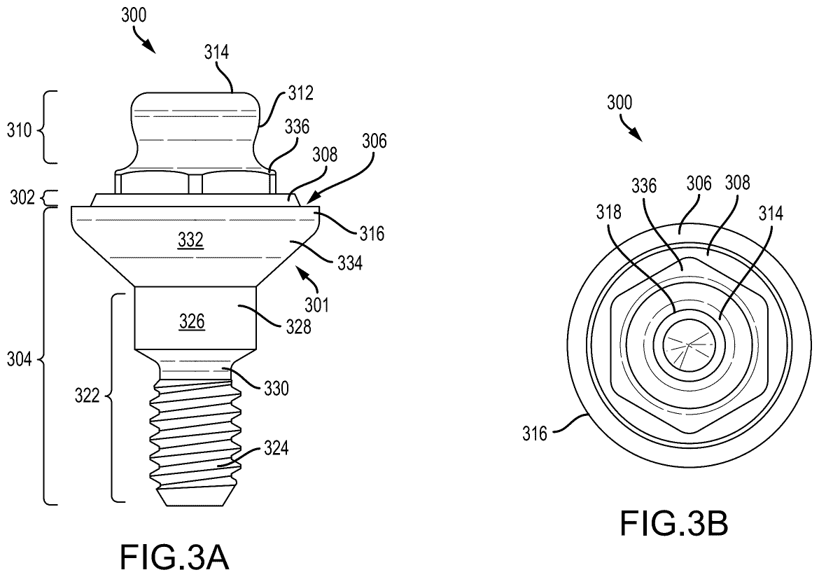

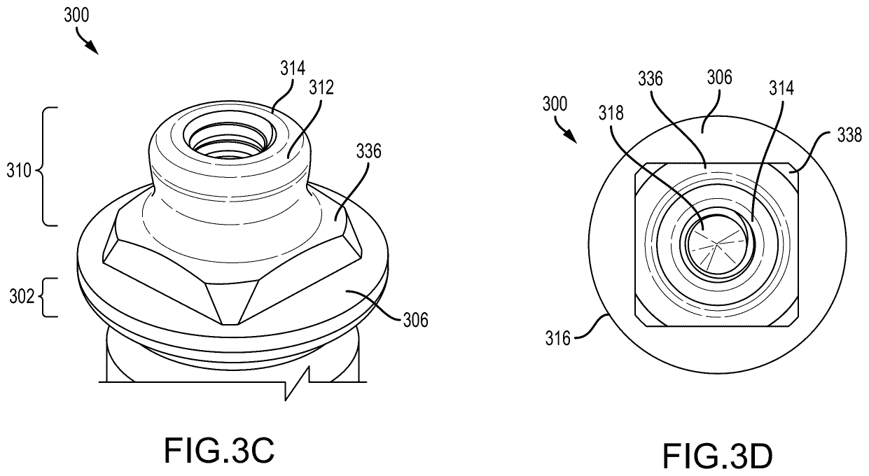

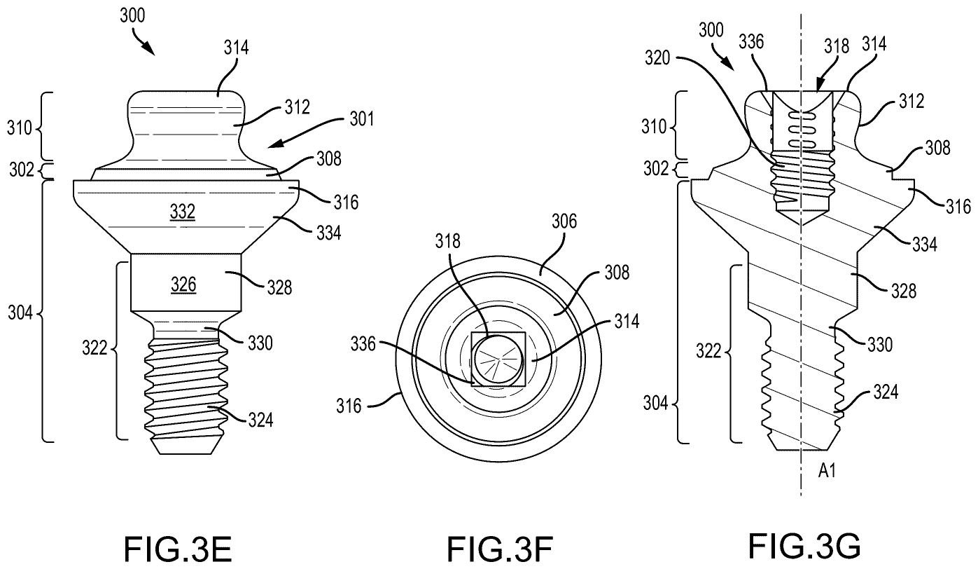

FIGS. 3A-3G illustrate a hybrid abutment 300, in accordance with one or more embodiments of the present disclosure. It is noted that the hybrid abutment 300 may be considered a straight, non-angled, or substantially straight abutment 300, for purposes of the present disclosure.

The hybrid abutment 300 has a main body 301. The hybrid abutment 300 includes a restorative feature 302 and a receiver interface 304, which are separated by a restorative surface or platform 306. The restorative feature 302 includes a ridge sidewall 308. For example, the ridge sidewall 308 may be straight, substantially straight, sloped, or contoured to conform to an arcuate shape. It is noted that the restorative feature 302 may be considered a restoration portion of the hybrid abutment 300, for purposes of the present disclosure. In addition, it is noted that the restorative feature 302 is operable as a locating or centering feature of the hybrid abutment 300 with respect to a dental restoration, as described in detail further herein.

The hybrid abutment 300 includes a denture section 310 with a sidewall 312 that is contoured to conform to an arcuate shape, which extends between the ridge sidewall 308 and a proximal surface 314. It is noted that the denture section 310 may be considered an overdenture portion of the hybrid abutment 300, for purposes of the present disclosure.

In some embodiments, the ridge sidewall 308 may include a sloped surface set at an angle defined relative to the restorative platform 306. For example, the angle of the sloped surface may be selected such that the ridge sidewall 308 does not intersect with the denture section 310. For instance, the ridge sidewall 308 may form a portion of a cone around the denture section 310.

In embodiments, a platform section 316 of the receiver interface 304 that includes the restorative platform 306 has a greater diameter than the ridge sidewall 308, and the ridge sidewall 308 has a greater diameter than the proximal surface 314. In these embodiments, the arcuate shape of the sidewall 312 causes the denture section 310 of the restorative feature 302 to have a different diameter that at least ranges between the diameter of the ridge sidewall 308 and the proximal surface 314 at different cross-sections along the height of the denture section 310. As described further herein, the arcuate shape of the sidewall 312 is capable of coupling to a resilient insert or interior contoured coupling surface, depending on what is necessary to couple a particular restoration type to the hybrid abutment 300.

A bore or aperture 318 extends through the proximal surface 314 and at least into the denture section 310. In some embodiments, the bore or aperture 318 is operable to engage with a connector (e.g., a fastener, or the like) operable to couple a restoration element to the hybrid abutment 300, as described in detail further herein. In one non-limiting example, the bore or aperture 318 may include threading 320, where the threading 320 is operable to engage with complementary threading on the connector.

The receiver interface 304 includes a receiver engagement section 322. In embodiments, at least a portion of the receiver engagement section 322 includes threading 324. For example, the threading 324 may at least be at a distal end of the receiver engagement section 322. In embodiments, at least a portion of the receiver engagement section 322 includes a shaped region 326. For example, the shaped region 326 may be substantially cylindrical in shape with a single sidewall 328 that is formed by a circular cross-section along the length of the shaped region 326. By way of another example, the shaped region 326 may be contoured or shaped to have a polygonal cross-section along the length of the shaped region 326. For instance, the polygonal cross-section may be a hexagon, such that the shaped region 326 has six sidewalls 328.

It is noted the shaped region 326 may assist in alignment and/or prevent rotation (e.g., by interlocking with a receiver) of the hybrid abutment 300 during installation. In addition, it is noted herein that the receiver engagement section 322 may be considered a receiver portion operable to be inserted into a jawbone along an installation axis A1, for purposes of the present disclosure. Further, it is noted that the shaped region 326 may include an external configuration (e.g., a protrusion that is inserted into a mated receptacle in the receiver) or may include an internal configuration (e.g., a receptacle that is configured to receive a mated protrusion from the receiver), without departing from the scope of the present disclosure.

In embodiments, the receiver engagement section 322 may generally be of lesser diameter than the platform section 316. In some embodiments, the threading 324 may be wound on a region 330 that has a lesser diameter than the shaped region 326. Due to the difference in diameters, the receiver interface 804 may include one or more transition regions 332 between the various regions 316, 326, 330. It is noted the one or more transition regions 332 may be curved or linear such that the one or more transition regions 332 create an abrupt change in diameter, a constant slope change in diameter, a change in diameter that is contoured to conform to an arcuate shape between the adjacent regions, or a combination thereof. For example, a transition region 332 may connect the platform section 316 and the shaped region 326, where the transition region 332 includes an exterior sidewall 334 with a substantially constant slope.

As the hybrid abutment 300 includes an integrated receiver engagement section 322 (e.g., including, but not limited to, having threading 324), the hybrid abutment 300 includes one or more tool engagement features. The tool engagement feature is operable to receive a tool and transfer a force imparted upon the tool to the hybrid abutment 300 when the hybrid abutment 300 is installed in a receiver (e.g., such as an analog or an implant). The tool engagement feature may be configured to an exteriorly received tool (e.g., a surface or set of surfaces operable to engage with a tool such as a wrench, socket, screwdriver, or the like) or an interiorly received tool (e.g., a slot, bore, or another aperture operable to engage with a hex wrench, a flat, Philips, square, Torx or star screwdriver or bit, or the like).

For example, as illustrated in FIGS. 3A-3D, the hybrid abutment 300 may include a tool engagement feature 336 positioned between the restorative feature 302 and the denture section 310 (e.g., such that the sidewall 312 extends between the tool engagement feature 336 and the proximal surface 314). It is noted herein, however, that the tool engagement feature 336 may be a portion of the restorative feature 302 and/or a portion of the denture section 310, without departing from the scope of the present disclosure.

It is noted that FIGS. 3A and 3B illustrate a hexagonal cross-section for the tool engagement feature 336 and the ridge sidewall 308. However, FIGS. 3C and 3D illustrate a variation of the exterior tool engagement feature 336, which includes a square cross-section for the exterior engagement feature 336. In FIGS. 3C and 3D, the tool engagement feature 336 extends fully to the restorative platform 306, such that the ridge sidewall 312 is not present. Rather, the tool engagement feature 336 includes sloped sidewalls 338 that function like the ridge sidewall 312, in that the sloped sidewalls 338 similarly form a portion of a cone around the denture section 310 and allows for coupling to abutment restoratives as described herein, while still maintaining the height as illustrated in FIGS. 3A and 3B. It is noted that the sloped sidewalls 338 may be substantially evenly spaced, where the sidewalls 338 are positioned relative to the corners of the square drive version of the tool engagement feature 336.

By way of another example, as illustrated in FIGS. 3E-3G, the restorative feature 302 may include a tool engagement feature 336 that is integrated with or at least partially surrounding the bore or aperture 318. As illustrated in FIG. 3G, a restorative axis (e.g., the axis for coupling a restoration to the hybrid abutment 300) and an installation axis (e.g., the axis for coupling the hybrid abutment 300 to a receiver) of the hybrid abutment 300 are aligned or coaxial, both being depicted by the longitudinal axis A1.

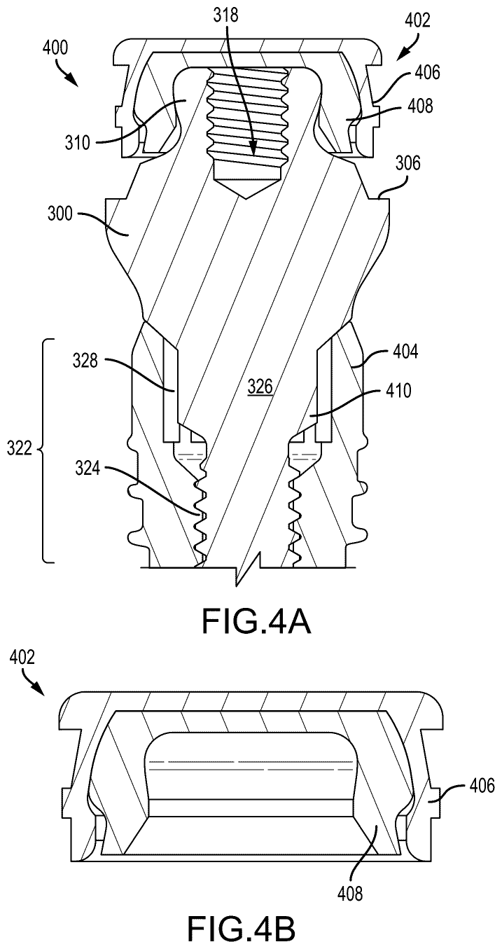

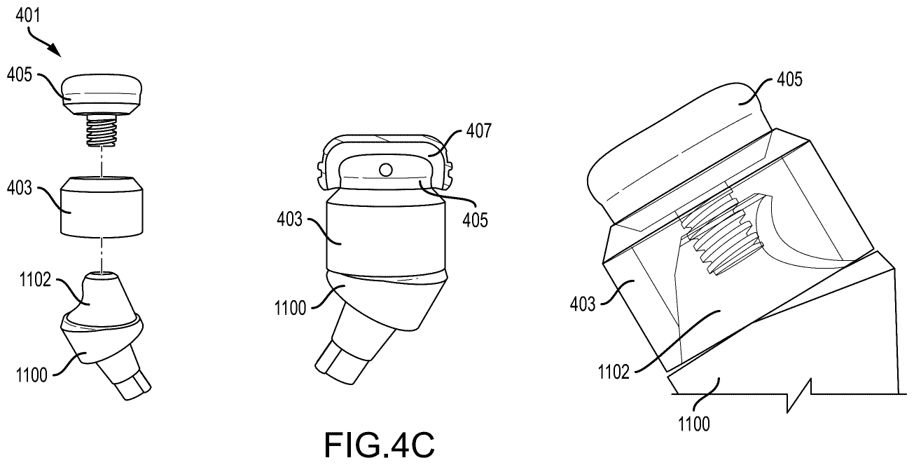

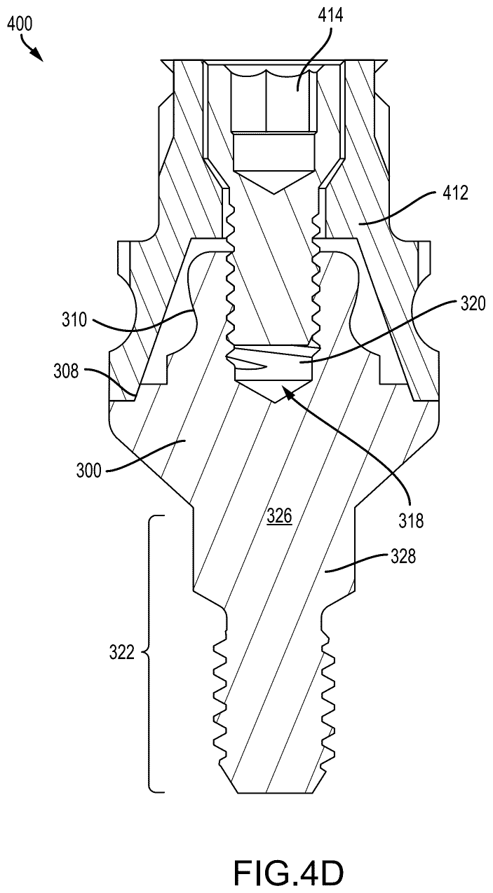

FIGS. 4A, 4B, and 4D illustrate a system 400, in accordance with one or more embodiments of the present disclosure.

The system 400 includes the hybrid abutment 300, a snap cap 402 (e.g., such as that used when embedded in an overdenture solution) including a resilient insert or other interior contoured coupling surface, and an implant 404. The hybrid abutment 300 is coupled to the implant 404 via the threading 324 on the receiver engagement section 322. The snap cap 402 is couplable to the hybrid abutment 300. Coupling the snap cap 402 to the hybrid abutment 300 covers and protects the primary bore or aperture 318 within the hybrid abutment 300. It is noted herein the snap cap 402 may be considered a secondary or restorative abutment component 402, for purposes of the present disclosure.

Referring now to FIG. 4A, the snap cap 402 only couples to the denture section 310 of the hybrid abutment 300. In this regard, designing the denture section 310 of the hybrid abutment 300 to be as short and/or as narrow as possible, while still allowing for the ability for the snap cap 402 to couple to the denture section 310 of the hybrid abutment 300, results in a more natural-sized and comfortable restoration element such as the abutment or overdenture, as described throughout the present disclosure.

Referring now to FIG. 4B, the snap cap 402 is an assembly that may be fabricated from one or more materials. For example, the snap cap 402 may include a first layer 406 fabricated from a first material, and a second layer 408 fabricated from a second material. For instance, the first layer 406 or externally communicating portion of the snap cap 402 may be fabricated from a stiff or semi-rigid polymer or a metal (e.g., is an outer shell or housing 406), while the second layer 408 or internally communicating portion of the snap cap 402 may be fabricated from a resilient material (e.g., is a resilient insert 408) able to elastically deform to accept and engage with the denture section 310 when the snap cap 402 is installed and/or removed from the hybrid abutment 300. In this regard, the resilient insert 408 may be removeable by a medical professional (e.g., with the overdenture solution, when removed for cleaning). It is noted herein that the resilient insert 408 may be fabricated from a material or materials that do not allow for removal of the resilient insert 408 or prosthesis in which the resilient insert 408 is embedded (e.g., with the overdenture solution) except for by a medical professional.

It is noted herein that the implant 404 may include a shaped region 410 that corresponds to the sidewall 328 of the shaped region 326 of the hybrid abutment 300. The mating of the shaped regions 326, 410 may assist in alignment and/or prevent rotation of the hybrid abutment 300 by interlocking with the implant 404 during installation.

As illustrated in FIG. 4A, in one non-limiting example the height from the seating platform 306 to the proximal surface of the cap is 2.68 millimeters (mm) (0.106 inches (in)) In contrast, alternative builds such as system 401 with an abutment 1100 with surface 1102 (e.g., as described in detail further herein) that is converted to work with an overdenture by adding a secondary attachment 403 and a connector 405 that receives a cap 407, may result in a height from the seating platform to the proximal surface of the cap 407 of 5.35 mm (0.211 in). As such, FIG. 4A represents a potential improvement of nearly 50% reduction in size versus an alternative example build as shown in FIG. 4C.

Referring now to FIG. 4D, a restorative component 412 is coupled to denture section 310 and ridge sidewall 308 of the hybrid abutment 300 via a connector 414. It is noted herein that, with the restorative and installation axes A1 being the same as the longitudinal axis A1 through the hybrid abutment 300, the connector 414 may pass entirely through the restorative component 412 and the hybrid abutment 300 to couple to the implant 404 shown in FIG. 4A, such that the threading 324 is not required on the hybrid abutment 300. In this example, the sidewall 328 of the shaped region 326 of the receiver engagement section 322 may correspond to a region in the implant 404 similar to the configuration of the hybrid abutments 500, 800 and implants 704, 1004 as described in detail further herein. It is noted herein the restorative component 412 may be considered a secondary or restorative abutment component 412, for purposes of the present disclosure.

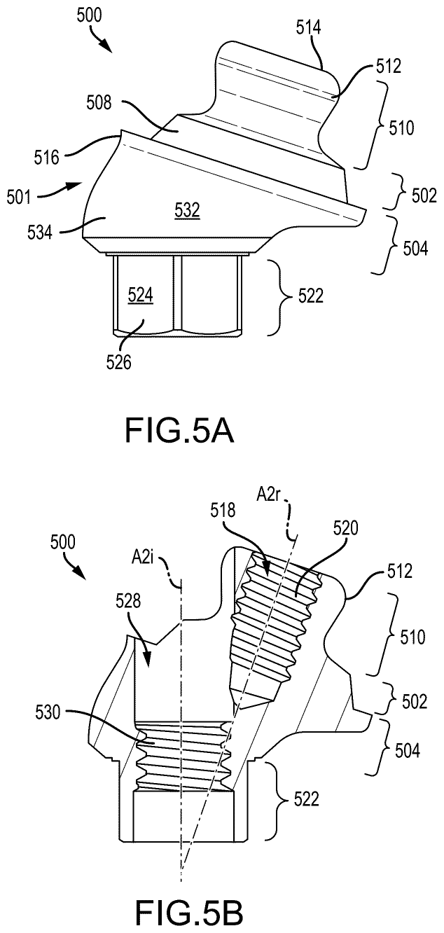

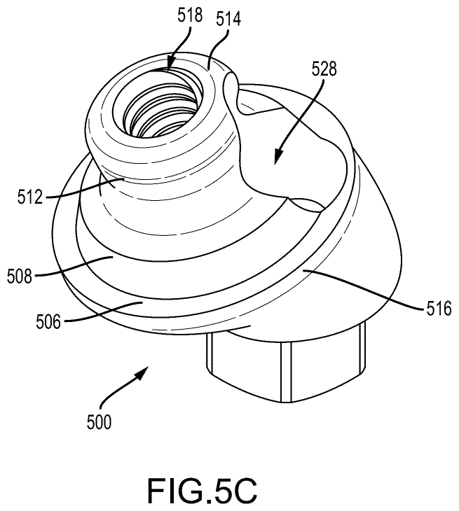

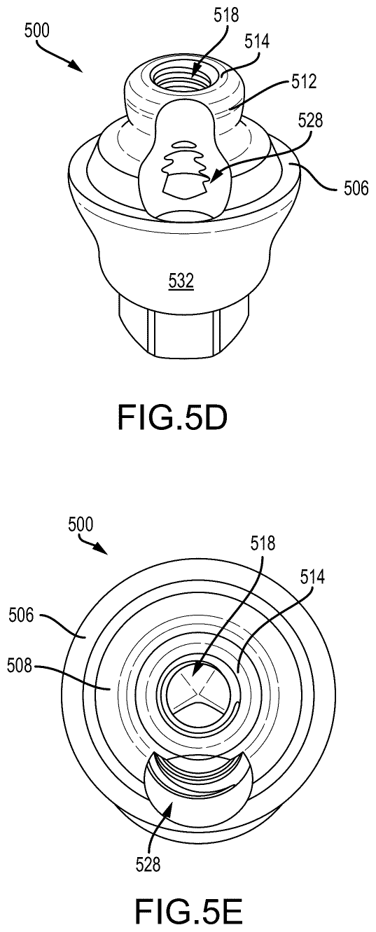

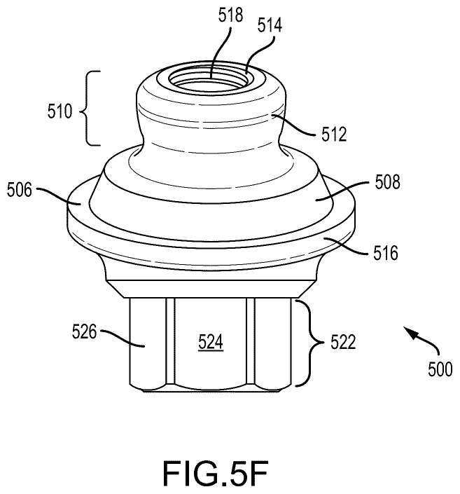

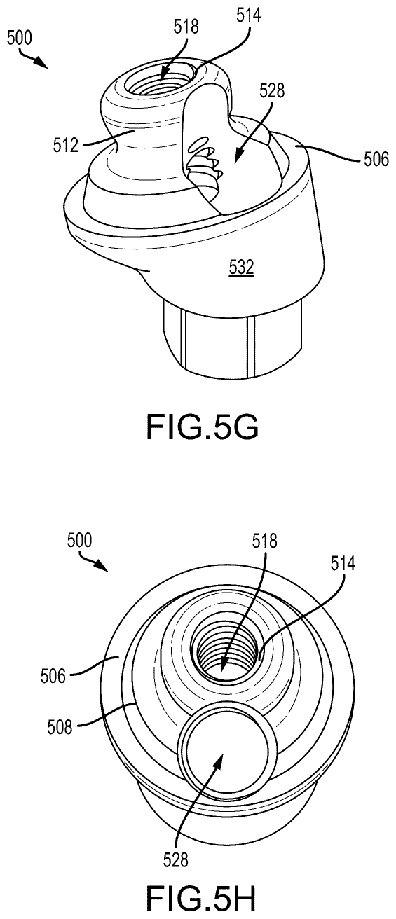

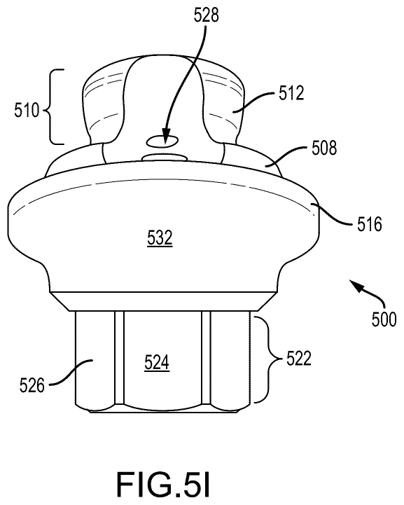

FIGS. 5A-5I generally illustrate an angled hybrid abutment 500, in accordance with one or more embodiments of the present disclosure. For example, the hybrid abutment 500 may be set at an angle ranging from 0° to 65°. In particular, FIGS. 5A-51 generally illustrate an angled hybrid abutment 500 with a 17° angle, in accordance with one or more embodiments of the present disclosure. To the extent possible, aspects of the hybrid abutments 300 and 500 are interchangeable and usable with one another, unless otherwise noted.

The hybrid abutment 500 includes a main body 501. The hybrid abutment 500 includes a restorative feature 502 and a receiver interface 504, which are separated by a restorative surface or platform 506. In embodiments, the receiver interface 504 includes a minimum cuff height (e.g., proximate to a front surface of the hybrid abutment 500) and a maximum cuff height (e.g., proximate to a rear surface of the hybrid abutment 500).

The restorative feature 502 includes a ridge sidewall 508. For example, the ridge sidewall 508 may be straight, substantially straight, sloped, or contoured to conform to an arcuate shape. It is noted that the restorative feature 502 may be considered a restoration portion of the hybrid abutment 500, for purposes of the present disclosure. In addition, it is noted that the restorative feature 502 is operable as a locating or centering feature of the hybrid abutment 500 with respect to a dental restoration, as described in detail further herein.

The hybrid abutment 500 includes a denture section 510 with a sidewall 512 that is contoured to conform to an arcuate shape, which extends between the ridge sidewall 508 and a proximal surface 514. It is noted that the denture section 510 may be considered an overdenture portion of the hybrid abutment 500, for purposes of the present disclosure.

In some embodiments, the ridge sidewall 508 may include a sloped surface set at an angle defined relative to the restorative platform 506. For example, the angle of the sloped surface may be selected such that the ridge sidewall 508 does not intersect with the denture section 510. For instance, the ridge sidewall 508 may form a portion of a cone around the denture section 510.

In embodiments, a platform section 516 of the receiver interface 504 that includes the restorative platform 506 has a greater diameter than the ridge sidewall 508, and the ridge sidewall 508 has a greater diameter than the proximal surface 514. In these embodiments, the arcuate shape of the sidewall 512 causes the denture section 510 of the restorative feature 502 to have a different diameter that at least ranges between the diameter of the ridge sidewall 508 and the proximal surface 514 at different cross-sections along the height of the denture section 510. As described further herein, the arcuate shape of the sidewall 512 is capable of coupling to a resilient insert or interior contoured coupling surface, depending on what is necessary to couple a particular restoration type to the hybrid abutment 500.

A primary bore or aperture 518 extends through the proximal surface 514 and at least into the denture section 510. In some embodiments, the primary bore or aperture 518 is operable to engage with a connector (e.g., a fastener, or the like) operable to couple a restoration element to the hybrid abutment 500, as described in detail further herein. In one non-limiting example, the primary bore or aperture 518 may include threading 520, where the threading 520 is operable to engage with complementary threading on the connector.

The hybrid abutment 500 includes a receiver engagement section 522. In embodiments, at least a portion of the receiver engagement section 522 includes a shaped region 524. For example, the shaped region 524 may be contoured or shaped to have a polygonal cross-section along the length of the shaped region 524, as shown in FIG. 5A. For instance, the polygonal cross-section may be a hexagon, such that the shaped region 524 has six sidewalls 526. By way of another example, the shaped region 524 may be substantially cylindrical in shape with a single sidewall 526 that is formed by a circular cross-section along the length of the shaped region 524.

It is noted the shaped region 524 may assist in alignment and/or prevent rotation (e.g., by interlocking with a receiver) of the hybrid abutment 500 during installation. In addition, it is noted herein that the receiver engagement section 524 may be considered a receiver portion operable to be inserted into a jawbone along an installation axis A2i, for purposes of the present disclosure. Further, it is noted that the shaped region 524 may include an external configuration (e.g., a protrusion that is inserted into a mated receptacle in the receiver) or may include an internal configuration (e.g., a receptacle that is configured to receive a mated protrusion from the receiver), without departing from the scope of the present disclosure.

In addition to the receiver engagement section 522, a secondary bore or aperture 528 extends through one or more surfaces of the hybrid abutment 500, though the denture section 510, and through the receiver engagement section 522. For example, the secondary bore or aperture 528 may extend through a portion of the proximal surface 514, the sidewall 512 of the denture section 510, a surface of the ridge sidewall 508, and/or the restorative platform 506. In some embodiments, the secondary bore or aperture 528 is operable to engage with a connector (e.g., a fastener, or the like) operable to couple the hybrid abutment 500 to a receiver, as described in detail further herein. In one non-limiting example, the secondary bore or aperture 528 may include threading 530, where the threading 530 is operable to engage with complementary threading on the connector. It is noted that the secondary bore or aperture 528 may at least partially intersect with the primary bore or aperture 518.

As illustrated in FIG. 5B, the restorative axis (e.g., the axis for coupling a restoration to the hybrid abutment 500) is depicted by the longitudinal axis A2r, and the installation axis (e.g., the axis for coupling the hybrid abutment 500 to a receiver) is depicted by the longitudinal axis A2i. The longitudinal axes A2r, A2i are not co-axially aligned but instead are offset at an angle relative to one another (e.g., where the angle is substantially equivalent to the angle of the hybrid abutment 500 including, but not limited to, 17°).

In embodiments, the shaped region 524 of the receiver engagement section 522 may generally be of lesser width or diameter than the platform section 516. Due to the difference in diameters, the receiver interface 504 may include one or more transition regions 532 between the various regions 516, 524. It is noted the one or more transition regions 532 may be curved or linear such that the one or more transition regions 532 create an abrupt change in diameter, a constant slope change in diameter, a change in diameter that is contoured to conform to an arcuate shape between the adjacent regions, or a combination thereof. For example, a transition region 532 may connect the platform section 516 and the shaped region 524, where the transition region 532 includes an exterior sidewall 534 that is arcuate to conform to the angle of the hybrid abutment 500. However, it is noted that the shaped region 524 of the receiver engagement section 522 may be of equal or greater width or diameter than the platform section 516, without departing from the scope of the present disclosure.

The primary bore or aperture 518 may be protected by the restoration element such that unwanted matter (e.g., food, saliva, dental cleaning aids, surrounding tissue, etc.) do not get into the hybrid abutment 500. However, the second bore or aperture 528 may not be fully protected by the restoration element depending on the configuration of the hybrid abutment 500, and particularly in abutment configurations. In this regard, it would be beneficial to provide a plug that is insertable into the secondary bore or aperture 528 to prevent unwanted matter from entering and/or packing into an interior of the hybrid abutment 500.

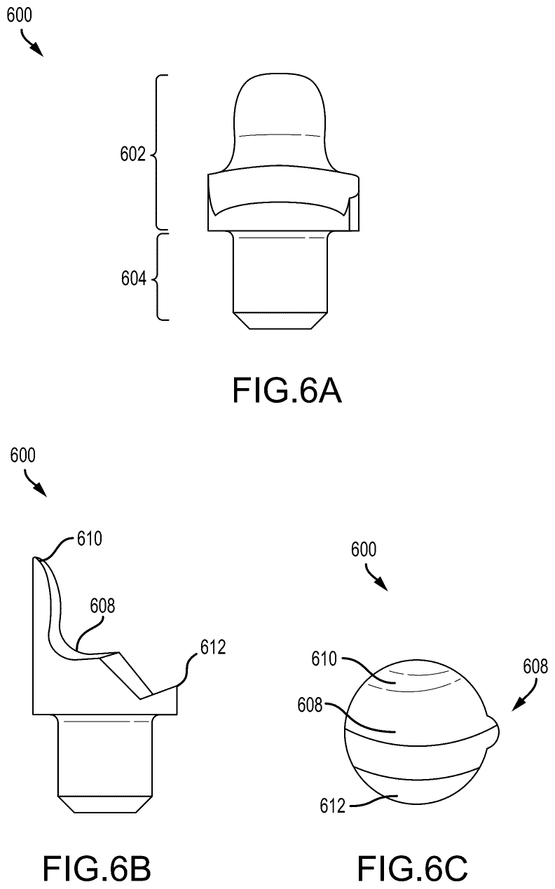

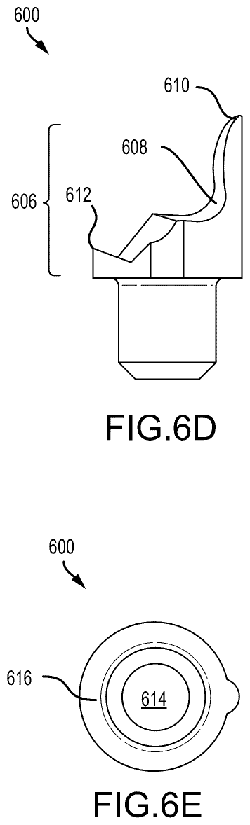

FIGS. 6A-6E generally illustrate a plug 600 for the hybrid abutment 500, in accordance with one or more embodiments of the present disclosure.

The plug 600 includes an upper portion 602 and a lower portion 604. The upper portion 602 includes a denture section with a sidewall 608 (or ridge sidewall region 608) that is contoured to conform to an arcuate shape between an upper edge 610 (or restoration region 610) and a lower edge 612 (or platform region 612).

In some embodiments, the sidewall 608 may include one or more regions that conform to corresponding regions on the hybrid abutment 500. For example, the restoration region 610 may conform to the sidewall 512 of the denture section 510 of the hybrid abutment 500. By way of another example, the ridge sidewall region 608 may conform to the ridge sidewall 508 of the hybrid abutment 500. By way of another example, the platform region 612 may conform to the restorative surface or platform 506 of the hybrid abutment 500 (e.g., as illustrated in FIGS. 5A-51). In general, the plug 600 includes a sidewall 608 that conforms to any surface or surfaces in which the secondary bore or aperture 528 is positioned, to provide a smooth or substantially smooth transition between the plug 600 and the hybrid abutment 500 and to reduce the possibility of damage to a resilient insert or interior contoured coupling surface coupled to the hybrid abutment 500 (e.g., caused by edges of the plug 600 and/or general friction from components rubbing together following installation).

The lower portion 604 includes a protrusion 616 that extends downward from a lower surface 616 of the upper portion 602. In embodiments, a protrusion 616 of the lower portion 604 includes a smaller diameter than the lower surface 616 of the upper portion 602 (and thus a smaller diameter than the upper portion 602 in general). The combination of the differing diameters may create a seal-like element at the surface of the hybrid abutment 500 with the larger diameter of the upper portion 602, while allowing for a smaller secondary bore or aperture 528 within the hybrid abutment 500 that is filled with the smaller diameter protrusion 616. In some embodiments, the protrusion 616 may be press-fit in the secondary bore or aperture 528, may be secured in the hybrid abutment 500 via an adhesive, and/or may include threading that is complementary to threading within the secondary bore or aperture 528.

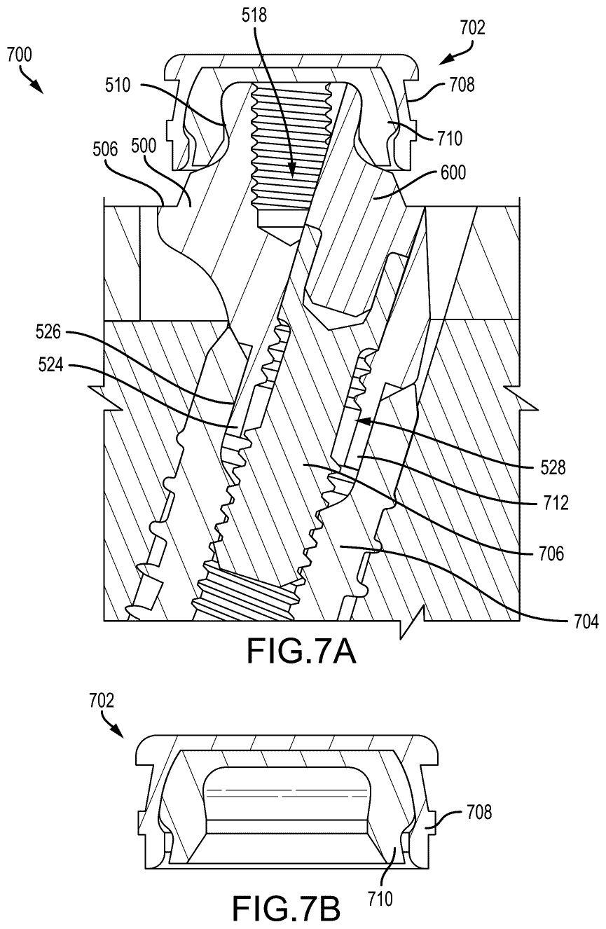

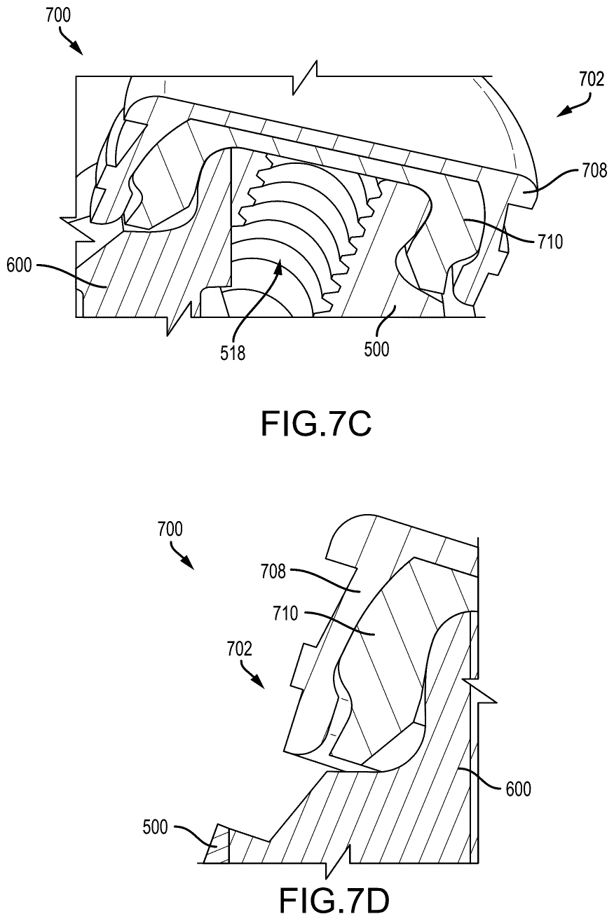

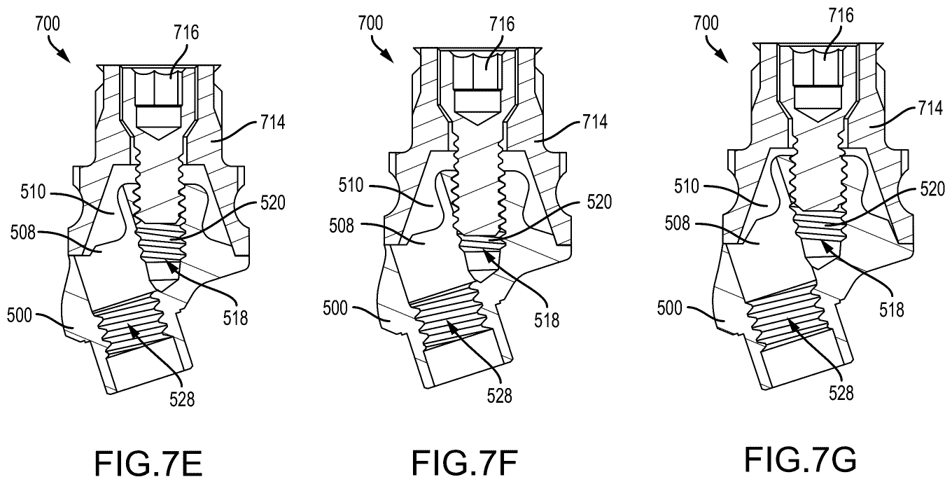

FIGS. 7A-7G illustrate a system 700, in accordance with one or more embodiments of the present disclosure. To the extent possible, aspects of the systems 400 and 700 are interchangeable and usable with one another, unless otherwise noted.

The system 700 includes the hybrid abutment 500 and the plug 600, along with a snap cap 702 (e.g., such as that used when embedded in an overdenture solution) including a resilient insert or other interior contoured coupling surface, and an implant 704, in accordance with one or more embodiments of the present disclosure. The hybrid abutment 500 is coupled to the implant 704 via a connector 706 (e.g., a fastener) through the second bore or aperture 528. It is noted herein the snap cap 702 may be considered a secondary or restorative abutment component 702, for purposes of the present disclosure.

Following insertion of the plug 600 into the secondary bore or aperture 528 of the hybrid abutment 500, the snap cap 702 is couplable to both the hybrid abutment 500 and the plug 600. Coupling the snap cap 702 to both the hybrid abutment 500 and the plug 600 covers and protects the primary bore or aperture 518 within the hybrid abutment 500.

In FIGS. 7A-7D, the snap cap 702 only couples to the denture section 510 of the hybrid abutment 500 and the corresponding restoration region 614 of the plug 600. In this regard, designing the denture section 510 of the hybrid abutment 500 and the corresponding restoration region 614 of the plug 600 to be as short and/or as narrow as possible, while still allowing for the ability for the snap cap 702 to couple to the denture section 510 of the hybrid abutment 500 and the corresponding restoration region 614 of the plug 600, results in a more natural-sized and comfortable restoration element such as the abutment or overdenture, as described throughout the present disclosure.

It is noted, however, that the plug 600 may be configured with a restoration region 614 that does not make contact when the cap or secondary abutment 702 is installed on the hybrid abutment 500. For example, the amount of the denture section 510 and sidewall 512 of the hybrid abutment 500 remaining after the secondary bore or aperture 528 is cut into the hybrid abutment 500 may be sufficient to hold onto the snap cap 702 after installation, without need for additional support and/or securing from the restoration region 614 of the plug 600.

Referring now to FIG. 7B, the snap cap 702 is an assembly that may be fabricated from one or more materials. For example, the snap cap 702 may include a first layer 708 fabricated from a first material, and a second layer 710 fabricated from a second material. For instance, the first layer 708 or externally communicating portion of the snap cap 702 may be fabricated from a stiff or semi-rigid polymer or a metal (e.g., is an outer shell or housing 708), while the second layer 710 or internally communicating portion of the snap cap 702 may be fabricated from a resilient material (e.g., is a resilient insert 710) able to elastically deform to accept and engage with the denture section 510 when the snap cap 702 is installed and/or removed from the hybrid abutment 500. In this regard, the resilient insert 710 may be removeable by a medical professional (e.g., with the overdenture solution, when removed for cleaning). It is noted herein that the resilient insert 710 may be fabricated from a material or materials that do not allow for removal of the resilient insert 710 or prosthesis in which the resilient insert 710 is embedded (e.g., with the overdenture solution) except for by a medical professional.

It is noted herein that the implant 704 may include a shaped region 712 that corresponds to the sidewall 526 of the shaped region 524 of the hybrid abutment 500. The mating of the shaped regions 524, 712 may assist in alignment and/or prevent rotation of the hybrid abutment 500 by interlocking with the implant 704 during installation.

Referring now to FIGS. 7E-7G, a restorative component 714 is coupled to the hybrid abutment 500 via a connector 716. For example, FIGS. 7E and 7F illustrate a low-profile version of the hybrid abutment 500, while FIG. 7G illustrates a standard-profile version of the hybrid abutment 500.

It is noted herein that the connector 716 needs to be of a length to ensure proper connection between the connector 716 and the threading 520 in the primary bore or aperture 518 and retaining of the restorative component 714 to the hybrid abutment 500, but not so long as to interfere with a connector 706 coupling the hybrid abutment 500 to the implant 704 (e.g., as shown in FIG. 7A). In one-non-limiting example, a comparison of FIGS. 7E, 7F, and 7G illustrates a shorter connector 716 for the low-profile hybrid abutment 500 in FIG. 7E and the standard-profile hybrid abutment 500 in FIG. 7G, versus a longer connector 716 for the low-profile version of the hybrid abutment 500 in FIG. 7F. As illustrated in the comparison of FIGS. 7E-7G, the low-profile (or low-cone) height for the hybrid abutment 500 illustrated in FIGS. 7E-7F may require the connector 716 to be of increased length (e.g., FIG. 7F) to provide the same holding force via threading between the connector 716 and the hybrid abutment 500, whereas the connector 716 may be of reduced length (e.g., FIG. 7G) with a standard-profile height for the hybrid abutment 500.

In addition, it is noted herein that the plug 600 may be optional when the restorative component 714 is coupled to the hybrid abutment 500, as the restorative component 714 may be configured to fully cover or protect the secondary bore or aperture 528. It is noted herein the restorative component 714 may be considered a secondary or restorative abutment component 714, for purposes of the present disclosure.

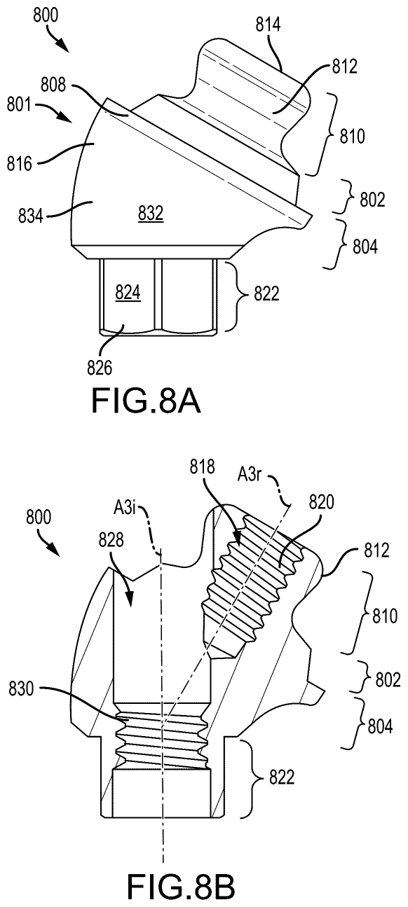

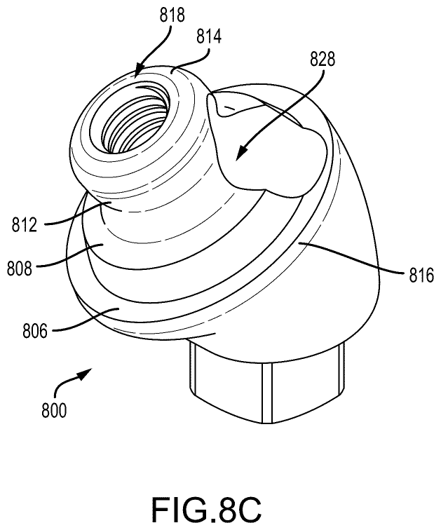

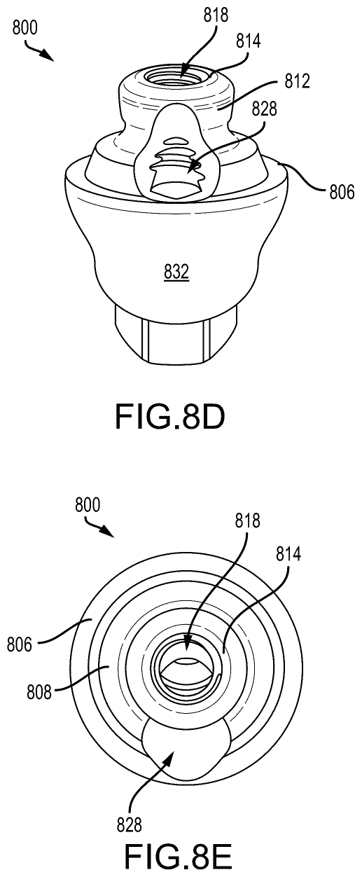

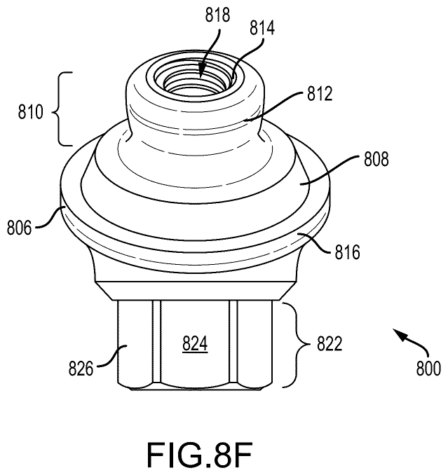

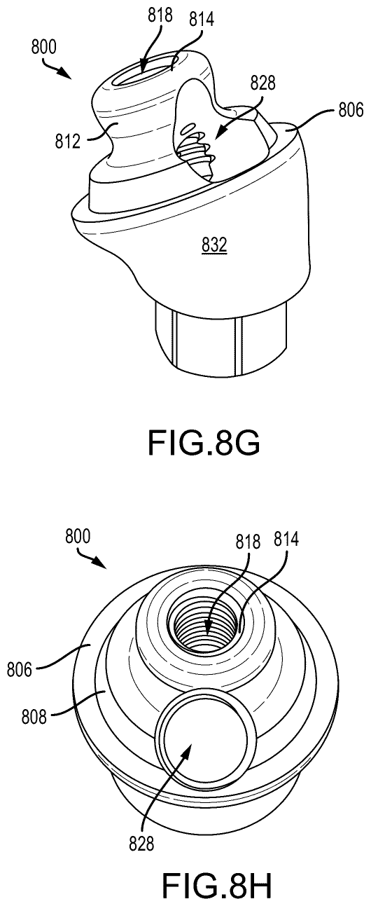

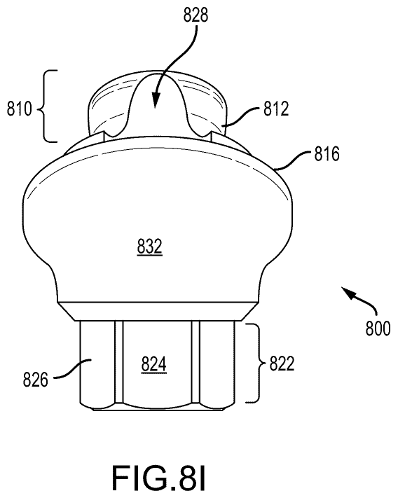

FIGS. 8A-81 generally illustrate an angled hybrid abutment 800, in accordance with one or more embodiments of the present disclosure. For example, the hybrid abutment 800 may be set at an angle ranging from 0° to 65°. In particular, FIGS. 8A-8I generally illustrate an angled hybrid abutment 800 with a 30° angle, in accordance with one or more embodiments of the present disclosure. To the extent possible, aspects of the hybrid abutments 300, 500, and 800 are interchangeable and usable with one another, unless otherwise noted.

The hybrid abutment 800 includes a main body 801. The hybrid abutment 800 includes a restorative feature 802 and a receiver interface 804, which are separated by a restorative surface or platform 806. In embodiments, the receiver interface 804 includes a minimum cuff height (e.g., proximate to a front surface of the hybrid abutment 800) and a maximum cuff height (e.g., proximate to a rear surface of the hybrid abutment 800).

The restorative feature 802 includes a ridge sidewall 808. For example, the ridge sidewall 808 may be straight, substantially straight, sloped, or contoured to conform to an arcuate shape. It is noted that the restorative feature 802 may be considered a restoration portion of the hybrid abutment 800, for purposes of the present disclosure. In addition, it is noted that the restorative feature 802 is operable as a locating or centering feature of the hybrid abutment 800 with respect to a dental restoration, as described in detail further herein.

In some embodiments, the ridge sidewall 808 may include a sloped surface set at an angle defined relative to the restorative platform 806. For example, the angle of the sloped surface may be selected such that the ridge sidewall 808 does not intersect with the denture section 810. For instance, the ridge sidewall 808 may form a portion of a cone around the denture section 810.

The hybrid abutment 800 includes a denture section 810 with a sidewall 812 that is contoured to conform to an arcuate shape, which extends between a ridge sidewall 808 and a proximal surface 814. It is noted that the denture section 810 may be considered an overdenture portion of the hybrid abutment 800, for purposes of the present disclosure.

In embodiments, a platform section 816 of the receiver interface 804 that includes the restorative platform 806 has a greater diameter than the ridge sidewall 808, and the ridge sidewall 808 has a greater diameter than the proximal surface 814. In these embodiments, the arcuate shape of the sidewall 812 causes the denture section 810 of the restorative feature 802 to have a different diameter that at least ranges between the diameter of the ridge sidewall 808 and the proximal surface 814 at different cross-sections along the height of the denture section 810. As described further herein, the arcuate shape of the sidewall 812 is capable of coupling to a resilient insert or interior contoured coupling surface, depending on what is necessary to couple a particular restoration type to the hybrid abutment 800.

A primary bore or aperture 818 extends through the proximal surface 814 and at least into the denture section 810. In some embodiments, the primary bore or aperture 818 is operable to engage with a connector (e.g., a fastener, or the like) operable to couple a restoration element to the hybrid abutment 800, as described in detail further herein. In one non-limiting example, the primary bore or aperture 818 may include threading 820, where the threading 820 is operable to engage with complementary threading on the connector.

The hybrid abutment 800 includes a receiver engagement section 822. In embodiments, at least a portion of the receiver engagement section 822 includes a shaped region 824. For example, the shaped region 824 may be contoured or shaped to have a polygonal cross-section along the length of the shaped region 824, as shown in FIG. 8A. For instance, the polygonal cross-section may be a hexagon, such that the shaped region 824 has six sidewalls 826. By way of another example, the shaped region 824 may be substantially cylindrical in shape with a single sidewall 826 that is formed by a circular cross-section along the length of the shaped region 824.

It is noted the shaped region 824 may assist in alignment and/or prevent rotation (e.g., by interlocking with a receiver) of the hybrid abutment 800 during installation. In addition, it is noted herein that the receiver engagement section 824 may be considered a receiver portion operable to be inserted into a jawbone along an installation axis A3i, for purposes of the present disclosure. Further, it is noted that the shaped region 824 may include an external configuration (e.g., a protrusion that is inserted into a mated receptacle in the receiver) or may include an internal configuration (e.g., a receptacle that is configured to receive a mated protrusion from the receiver), without departing from the scope of the present disclosure.

In addition to the receiver engagement section 822, a secondary bore or aperture 828 extends through one or more surfaces of the hybrid abutment 800, though the denture section 810, and through the receiver engagement section 822. For example, the secondary bore or aperture 828 may cut through a portion of the proximal surface 814, the sidewall 812 of the denture section 810, a surface of the ridge sidewall 808, and/or the restorative platform 806. In some embodiments, the secondary bore or aperture 828 is operable to engage with a connector (e.g., a fastener, or the like) operable to couple the hybrid abutment 800 to a receiver, as described in detail further herein. In one non-limiting example, the secondary bore or aperture 828 may include threading 830, where the threading 830 is operable to engage with complementary threading on the connector. It is noted that the secondary bore or aperture 828 may at least partially intersect with the primary bore or aperture 818.

As illustrated in FIG. 8B, the restorative axis (e.g., the axis for coupling a restoration to the hybrid abutment 800) is depicted by the longitudinal axis A3r, and the installation axis (e.g., the axis for coupling the hybrid abutment 800 to a receiver) is depicted by the longitudinal axis A3i. The longitudinal axes A3r, A3i are not co-axially aligned but instead are offset at an angle relative to one another (e.g., where the angle is substantially equivalent to the angle of the hybrid abutment 800 including, but not limited to, 30°).

In embodiments, the shaped region 824 of the receiver engagement section 822 may generally be of lesser width or diameter than the platform section 816. Due to the difference in diameters, the receiver interface 804 may include one or more transition regions 832 between the various regions 816, 824. It is noted the one or more transition regions 832 may be curved or linear such that the one or more transition regions 532 create an abrupt change in diameter, a constant slope change in diameter, a change in diameter that is contoured to conform to an arcuate shape between the adjacent regions, or a combination thereof. For example, a transition region 832 may connect the platform region 816 and the shaped region 824, where the transition region 832 includes an exterior sidewall 834 that is arcuate to conform to the angle of the hybrid abutment 800. However, it is noted that the shaped region 824 of the receiver engagement section 822 may be of equal or greater width or diameter than the platform section 816, without departing from the scope of the present disclosure.

The primary bore or aperture 818 may be protected by the restoration element such that unwanted matter (e.g., food, saliva, dental cleaning aids, surrounding tissue, etc.) do not get into the hybrid abutment 800. However, the second bore or aperture 828 may not be fully protected by the restoration element depending on the configuration of the hybrid abutment 800, and particularly in abutment configurations. In this regard, it would be beneficial to provide a plug that is insertable into the secondary bore or aperture 828 to prevent unwanted matter from entering and/or packing into an interior of the hybrid abutment 800.

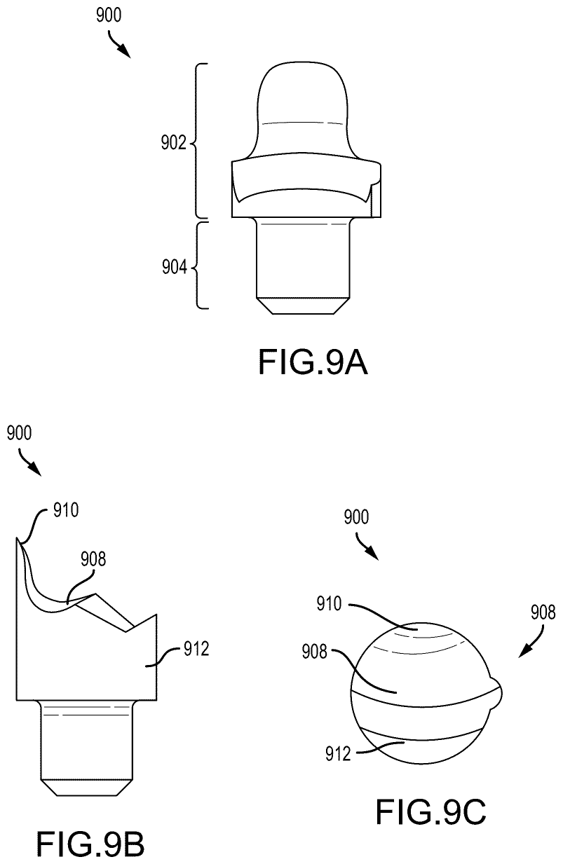

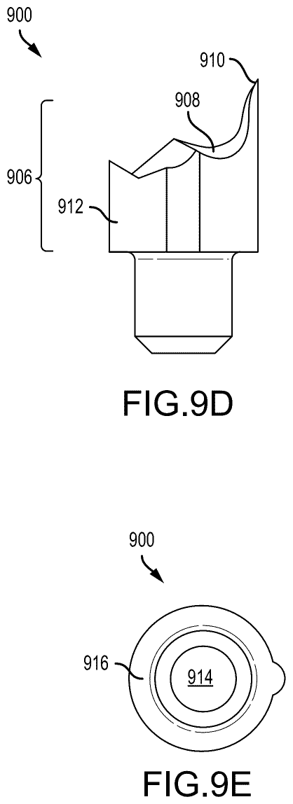

FIGS. 9A-9E generally illustrate a plug 900 for the hybrid abutment 800, in accordance with one or more embodiments of the present disclosure. To the extent possible, aspects of the plugs 600 and 900 are interchangeable and usable with one another, unless otherwise noted.

The plug 900 includes an upper portion 902 and a lower portion 904. The upper portion 902 includes a denture section with a first sidewall 908 (or ridge sidewall region 908) that is contoured to conform to an arcuate shape between an upper edge 910 (or restoration region 910) and a lower edge 912 (or platform region 912).

In some embodiments, the sidewall 908 may include one or more regions that conform to corresponding regions on the hybrid abutment 800. For example, the restoration region 910 may conform to the sidewall 812 of the denture section 810 of the hybrid abutment 800. By way of another example, the ridge sidewall region 908 may conform to the ridge sidewall 808 of the hybrid abutment 800 By way of another example, the platform region 912 may conform to the restorative platform 806 of the hybrid abutment 800 (e.g., as illustrated in FIGS. 8A-81). In general, the plug 900 includes a sidewall 908 that conforms to any surface or surfaces in which the secondary bore or aperture 828 is positioned, to provide a smooth or substantially smooth transition between the plug 900 and the hybrid abutment 800 and to reduce the possibility of damage to a resilient insert or interior contoured coupling surface coupled to the hybrid abutment 800 (e.g., caused by edges of the plug 900 and/or general friction from components rubbing together following installation).

The lower portion 904 includes a protrusion 914 that extends downward from a lower surface 916 of the upper portion 902. In embodiments, a protrusion 914 of the lower portion 904 includes a smaller diameter than the lower surface 916 of the upper portion 902 (and thus a smaller diameter than the upper portion 902 in general). The combination of the differing diameters may create a seal-like element at the surface of the hybrid abutment 800 with the larger diameter of the upper portion 902, while allowing for a smaller secondary bore or aperture 828 within the hybrid abutment 800 that is filled with the smaller diameter protrusion 914. In some embodiments, the protrusion 914 may be press-fit in the secondary bore or aperture 828, may be secured in the hybrid abutment 800 via an adhesive, and/or may include threading that is complementary to threading within the secondary bore or aperture 828.

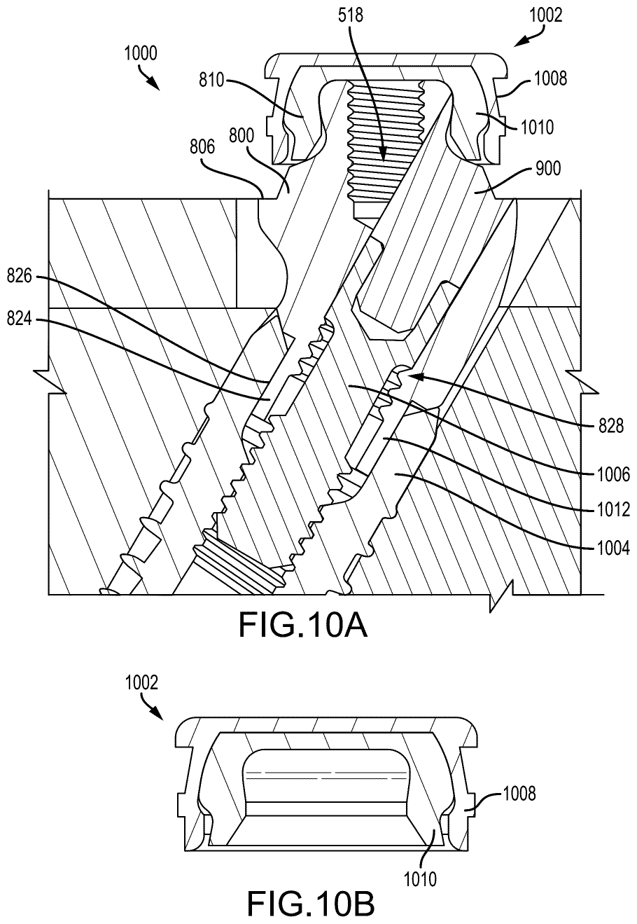

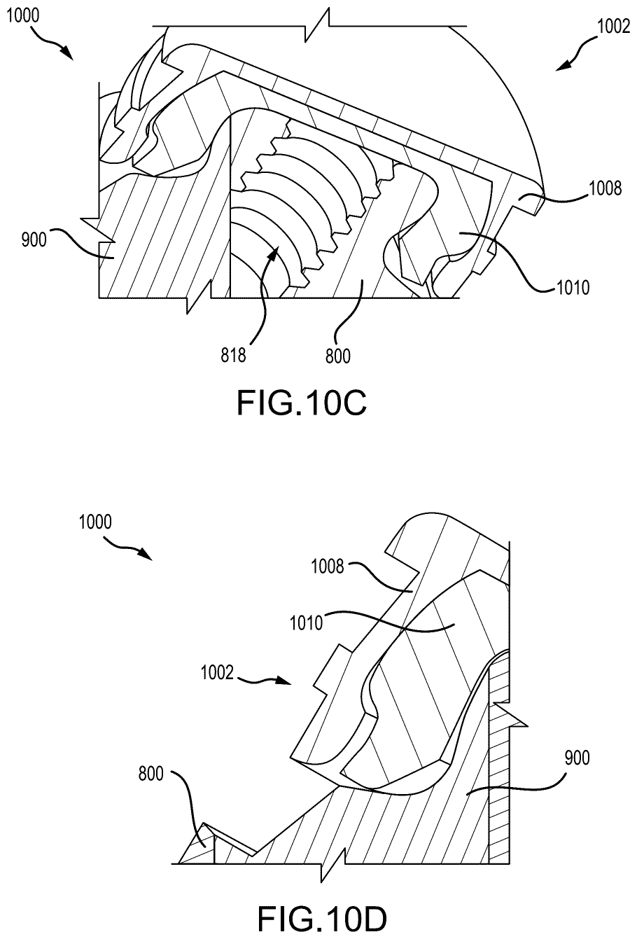

FIGS. 10A-10D illustrate a system 1000, in accordance with one or more embodiments of the present disclosure. To the extent possible, aspects of the systems 400, 700, and 1000 are interchangeable and usable with one another, unless otherwise noted.

The system 1000 includes the hybrid abutment 800 and the plug 900, along with a snap cap 1002 (e.g., such as that used when embedded in an overdenture solution) including a resilient insert or other interior contoured coupling surface, and an implant 1004, in accordance with one or more embodiments of the present disclosure. The hybrid abutment 800 is coupled to the implant 1004 via a connector 1006 (e.g., a fastener) through the second bore or aperture 828. It is noted herein the snap cap 1002 may be considered a secondary or restorative abutment component 1002, for purposes of the present disclosure.

Following insertion of the plug 900 into the secondary bore or aperture 828 of the hybrid abutment 800, the snap cap 1002 is couplable to both the hybrid abutment 800 and the plug 900. Coupling the snap cap 1002 to both the hybrid abutment 800 and the plug 900 covers and protects the primary bore or aperture 818 within the hybrid abutment 800.

In FIGS. 10A-10D, the snap cap 1002 only couples to the denture section 810 of the hybrid abutment 800 and the corresponding restoration region 914 of the plug 900. In this regard, designing the denture section 810 of the hybrid abutment 800 and the corresponding restoration region 914 of the plug 900 to be as short and/or as narrow as possible, while still allowing for the ability for the snap cap 1002 to couple to the denture section 810 of the hybrid abutment 800 and the corresponding restoration region 914 of the plug 900, results in a more natural-sized and comfortable restoration element such as the abutment or overdenture, as described throughout the present disclosure.

It is noted, however, that the plug 900 may be configured with a restoration region 914 that does not make contact when the cap or secondary abutment 1002 is installed on the hybrid abutment 800. For example, the amount of the denture section 810 and sidewall 812 of the hybrid abutment 800 remaining after the secondary bore or aperture 828 is cut into the hybrid abutment 800 may be sufficient to hold onto the snap cap 1002 after installation, without need for additional support and/or securing from the restoration region 914 of the plug 900.

Referring now to FIG. 10B, the snap cap 1002 is an assembly that may be fabricated from one or more materials. For example, the snap cap 1002 may include a first layer 1008 fabricated from a first material, and a second layer 1010 fabricated from a second material. For instance, the first layer 1008 or externally communicating portion of the snap cap 1002 may be fabricated from a stiff or semi-rigid polymer or a metal (e.g., is an outer shell or housing 1008), while the second layer 1010 or internally communicating portion of the snap cap 1002 may be fabricated from a resilient material (e.g., is a resilient insert 1010) able to elastically deform to accept and engage with the denture section 810 when the snap cap 1002 is installed and/or removed from the hybrid abutment 800. In this regard, the resilient insert 1010 may be removeable by a medical professional (e.g., with the overdenture solution, when removed for cleaning). It is noted herein that the resilient insert 1010 may be fabricated from a material or materials that do not allow for removal of the resilient insert 1010 (e.g., with the overdenture solution) except for by a medical professional.

It is noted herein that the implant 1004 may include a shaped region 1012 that corresponds to the sidewall 826 of the shaped region 824 of the hybrid abutment 800. The mating of the shaped regions 824, 1012 may assist in alignment and/or prevent rotation of the hybrid abutment 800 by interlocking with the implant 1004 during installation.

It is noted herein the system 1000 may include a similar restorative component 714 that is couplable to the hybrid abutment 800 via a connector 716, as shown in FIGS. 7E-7G. In one non-limiting example, a restorative component and corresponding connector of the system 1000 that is couplable to the hybrid abutment 800 may be identical or substantially similar to the restorative component 714 and corresponding connector 716 as described in detail previously herein. In addition, it is noted that similar considerations as those described with respect FIGS. 7E-7G. In addition, it is noted that similar considerations as those described with respect to FIGS. 7E-7G for the installing of the restorative component 714 on the hybrid abutment 500 with the connector 716, including the length of the connector 716, may also need to be taken into consideration with the installing of a restorative component on the hybrid abutment 800 with a connector in the system 1000 of FIGS. 10A-10D.

Due to the differences in the contouring of the denture sections 510, 810 of the hybrid abutments 500, 800, respectively, the size and/or shape of the plugs 600, 900 may be different from one another. However, it is noted herein that the plugs may be universal to any abutment, such as where the plug is configured to fit within the secondary bore or apertures 528, 828 of the hybrid abutments 500, 800 but is not configured to (or needing to) make contact with the resilient insert or other interior contoured coupling surface (e.g., of the snap caps 702, 1002).

It is noted herein that the embodiments illustrated in FIGS. 7A-7D and FIGS. 10A-10D are directed to configurations of systems 700, 1000 where the hybrid abutments 500, 800 are used with plugs 600, 900 and caps or secondary or restorative abutment components 702, 1002, respectively, such as part of an overdenture solution. However, where the hybrid abutments 500, 800 are used as part of an abutment solution, it is noted herein that the plugs 600, 900 may not need to be installed in the hybrid abutments 500, 800, respectively due to the configuration of the necessary components for the abutment solutions. In this regard, the geometry necessary (e.g., on the denture sections 510, 810 on the hybrid abutments 500, 800, respectively) for the overdenture solutions may be disrupted by the secondary bore or apertures 528, 828, respectively, whereas the geometry necessary for the abutment solutions are not as modified or otherwise affected.

In general, to install the components of the restorative systems of the present disclosure during a restorative procedure, clinicians may use select devices or tools during the design, installation, and healing phases (e.g., which may be considered intermediate phases in some non-limiting examples, for purposes of the present disclosure) of the restorative procedure. For example, the devices may allow the implants and/or surrounding tissue to heal, as well as to transfer the implant locations from the patient to either a physical or digital model (e.g., which may be used to develop the restoration). These devices may be coupled to the components of the restorative system via conventional threading (e.g., in the case of an abutment system), via engagement of surfaces of the features 302, 502, 802, 1902, 2002, 2102, 2119, 2202, 2219, 2302, 2319, 2402, 2419, 2502, 2519 of the respective abutments 300, 500, 800, 1900, 2000, 2100, 2200, 2300, 2400, 2500 by corresponding inner surfaces of the tools (e.g., such as inner sidewalls, or the like), via engagement of surfaces of the features 306, 506, 806, 1906, 2006, 2106, 2206, 2306, 2406, 2506 of the respective abutments 300, 500, 800, 1900, 2000, 2100, 2200, 2300, 2400, 2500 by corresponding inner surfaces of the devices (e.g., such as inner sidewalls, or the like), and/or via internal resilient inserts that can be added to allow to the devices or tools for snapping onto the sections 310, 510, 810, 1910, 2100, 2110, 2210, 2310, 2410, 2510 of the respective abutments 300, 500, 800, 1900, 2000, 2100, 2200, 2300, 2400, 2500.

During the intermediate phases of the restorative procedure, the features 302, 502, 802, 1902, 2002, 2102, 2119, 2202, 2219, 2302, 2319, 2402, 2419, 2502, 2519, the features 306, 506, 806, 1906, 2006, 2106, 2206, 2306, 2406, 2506, and/or the sections 310, 510, 810, 1910, 2100, 2110, 2210, 2310, 2410, 2510 of the respective abutments 300, 500, 800, 1900, 2000, 2100, 2200, 2300, 2400, 2500 may be usable with the devices or tools. In particular, the features 302, 502, 802, 1902, 2002, 2102, 2119, 2202, 2219, 2302, 2319, 2402, 2419, 2502, 2519 may be able to engage an inner surface (or surfaces) of a tool, the features 306, 506, 806, 1906, 2006, 2106, 2206, 2306, 2406, 2506 may be able to engage an inner surface (or surfaces) of a device, and/or the sections 310, 510, 810, 1910, 2100, 2110, 2210, 2310, 2410, 2510 may be able to engage a retentive top installed within a device or tool used for the intermediate phases of the restorative procedure during which the case or final restoration (or prosthesis) is being designed. For example, the abutments 300, 500, 800, 1900, 2000, 2100, 2200, 2300, 2400, 2500 may be used as a coupling element for the device or tool used for the intermediate phases of the restorative procedure between the placement of an implant and/or abutment and the installation of the final restoration. For instance, the abutment 500 may be used with the intermediate phase device or tool while data is taken (i.e., digitally or physically) for designing and/or manufacturing the final restoration, where the data is transferred to a lab or other manufacturing facility and is converted into the final restoration being designed and/or fabricated, which is provided and installed within the patient.

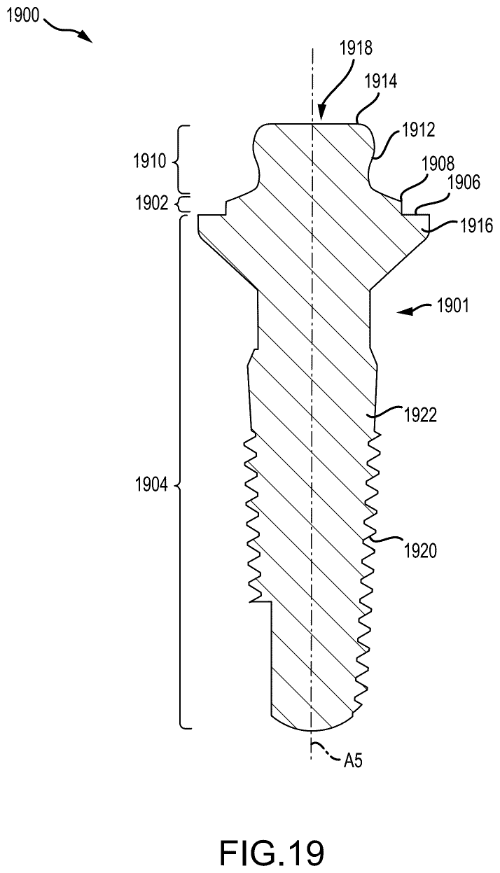

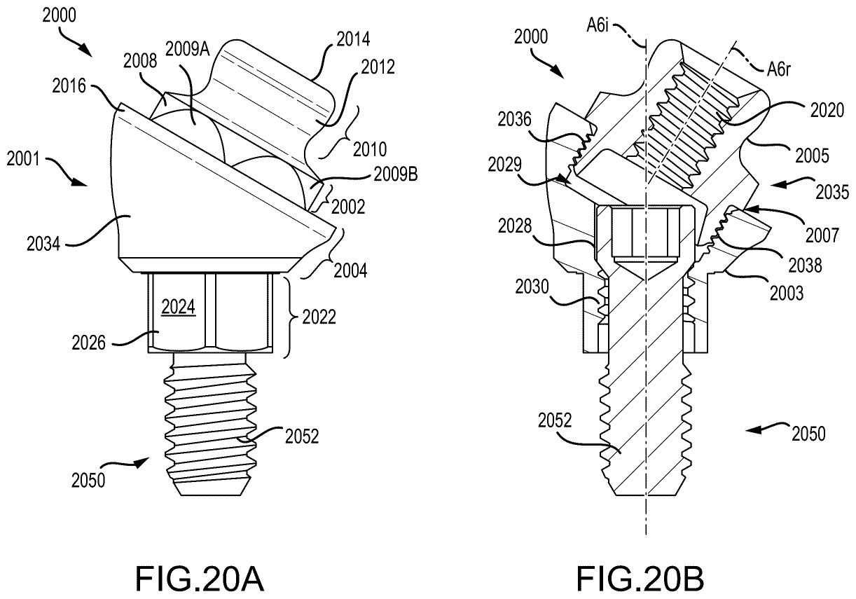

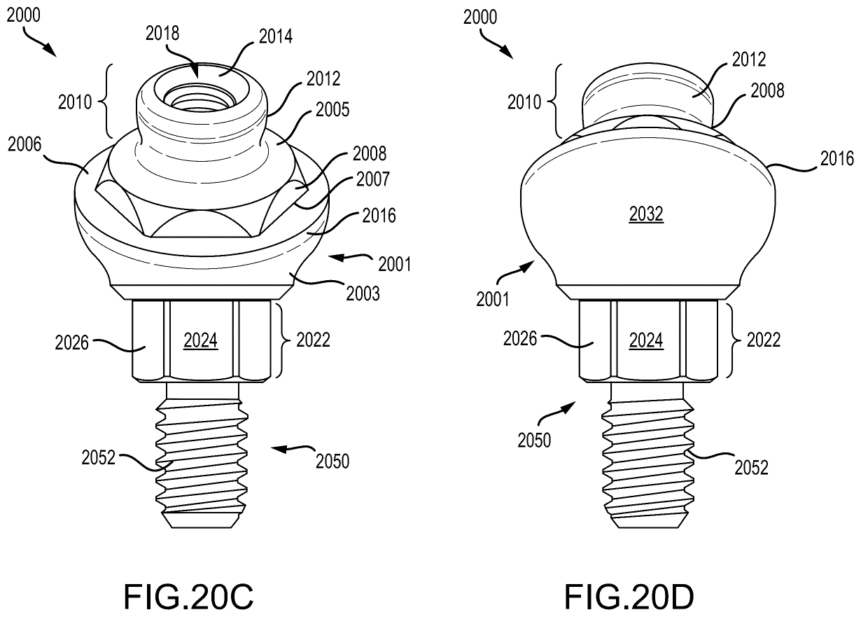

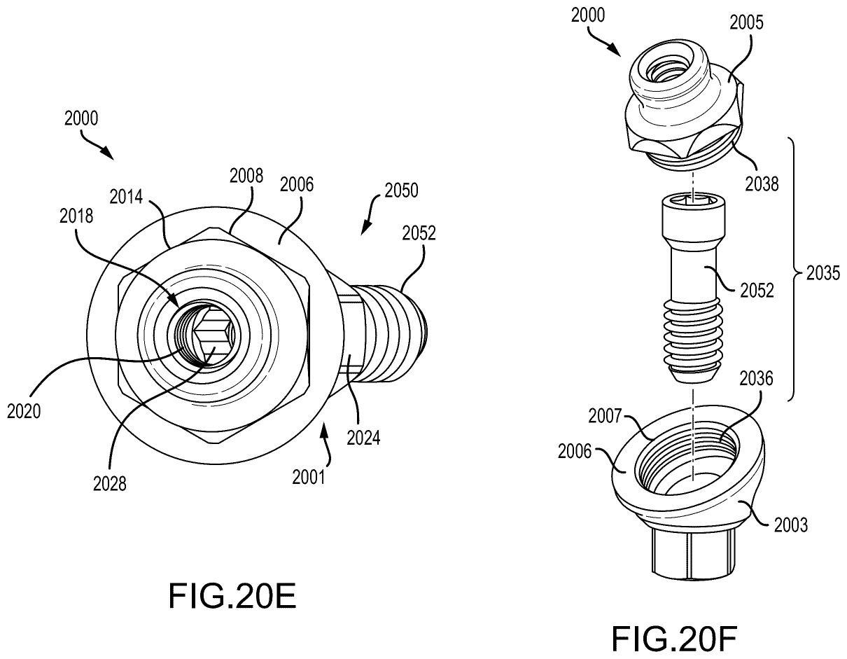

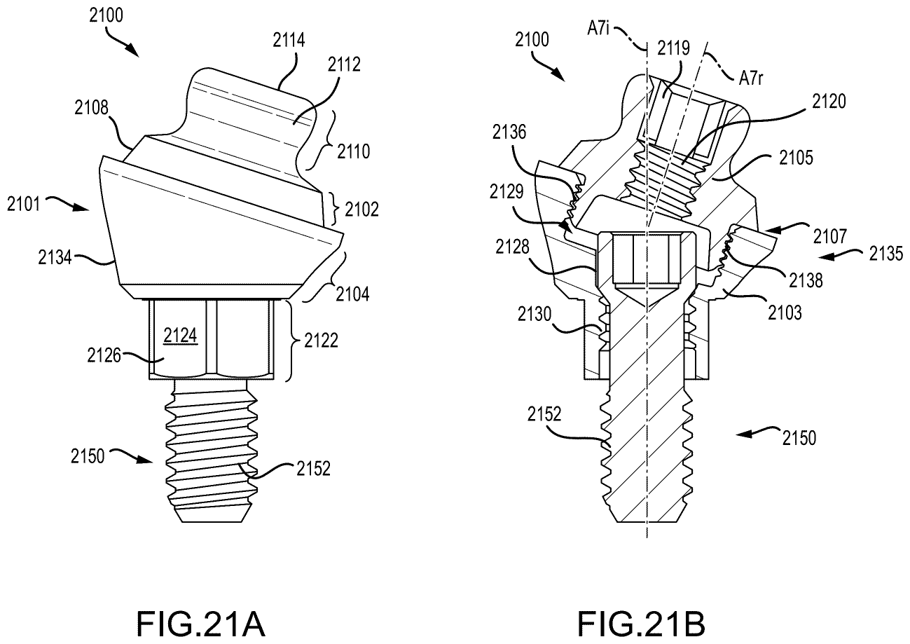

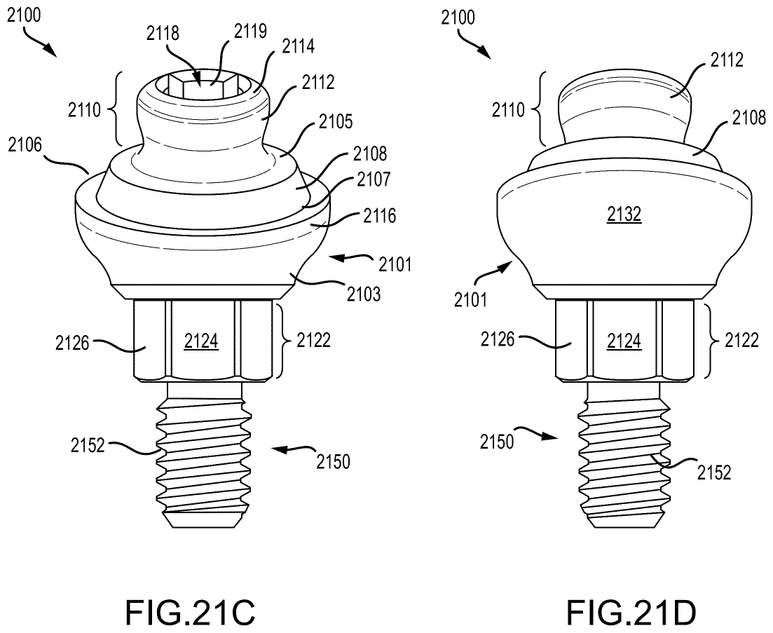

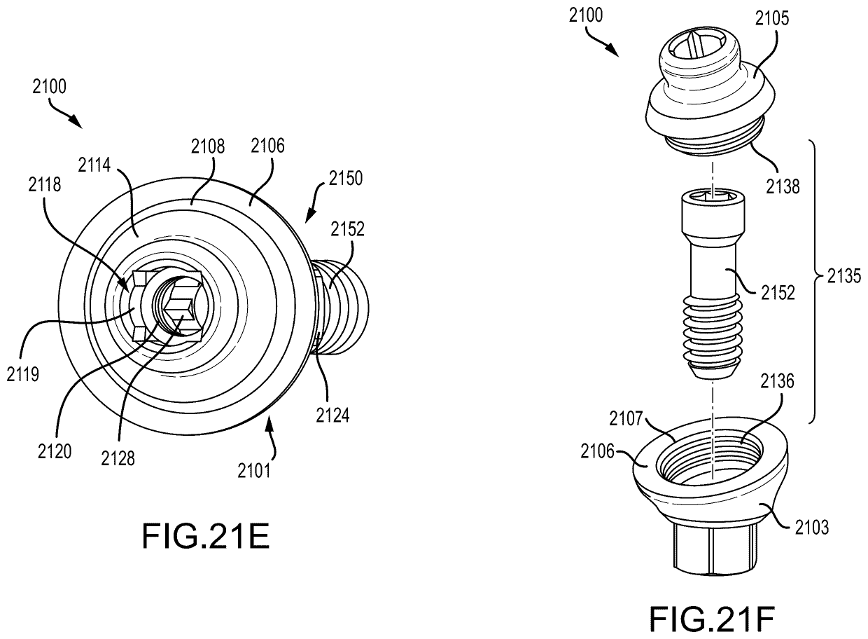

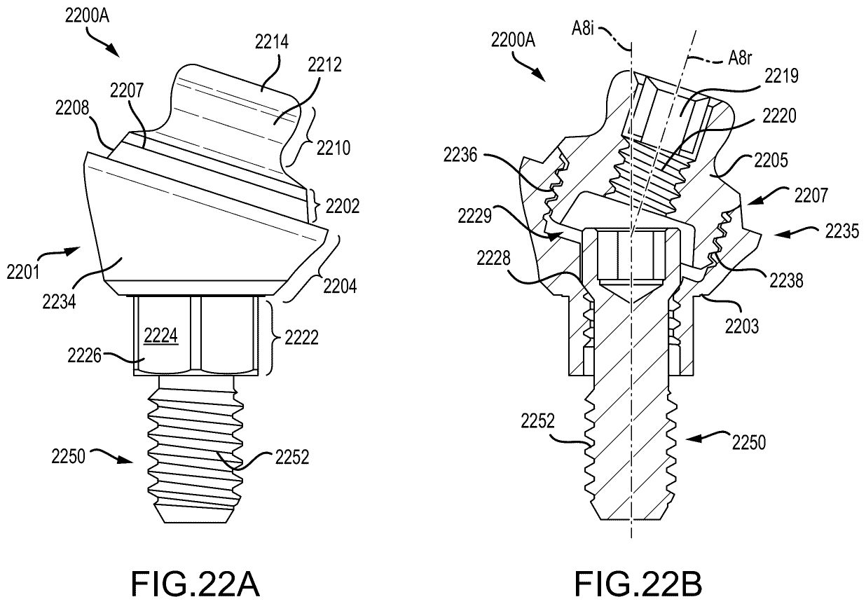

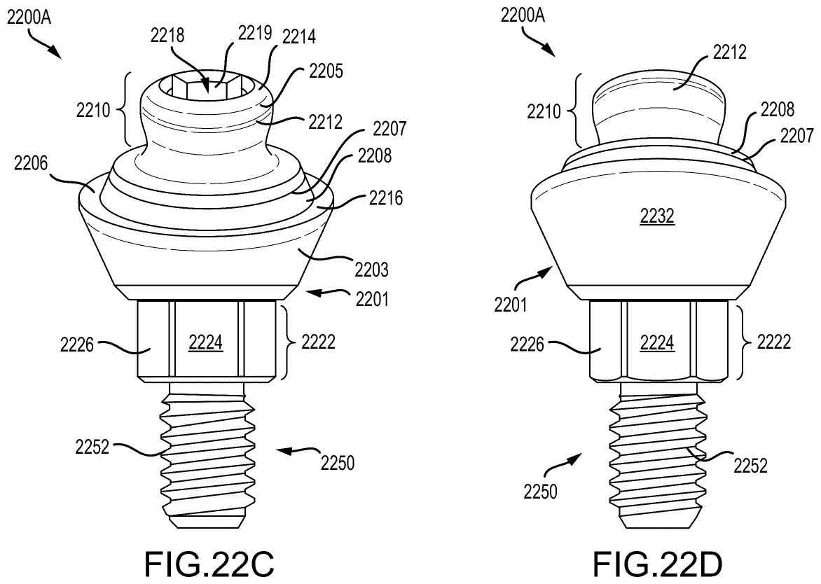

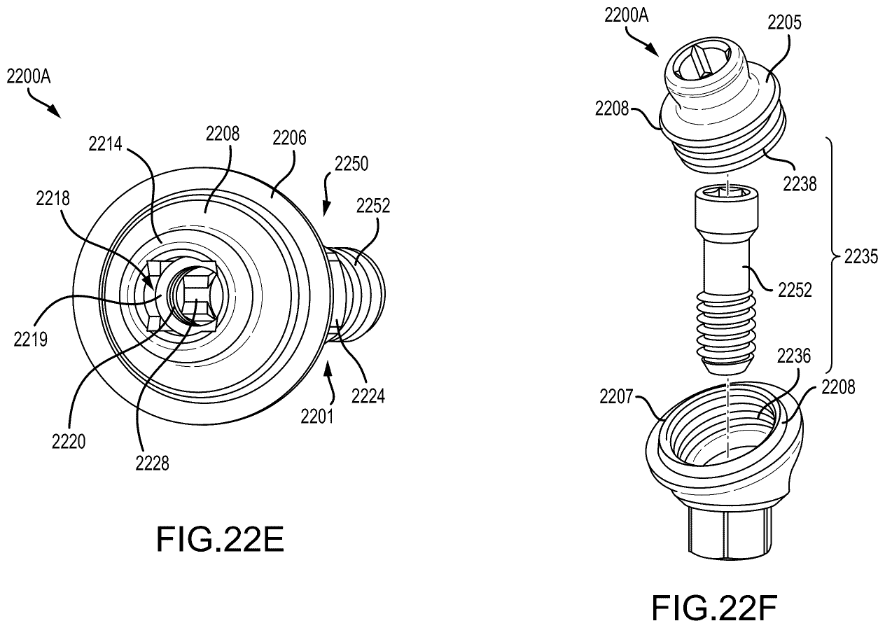

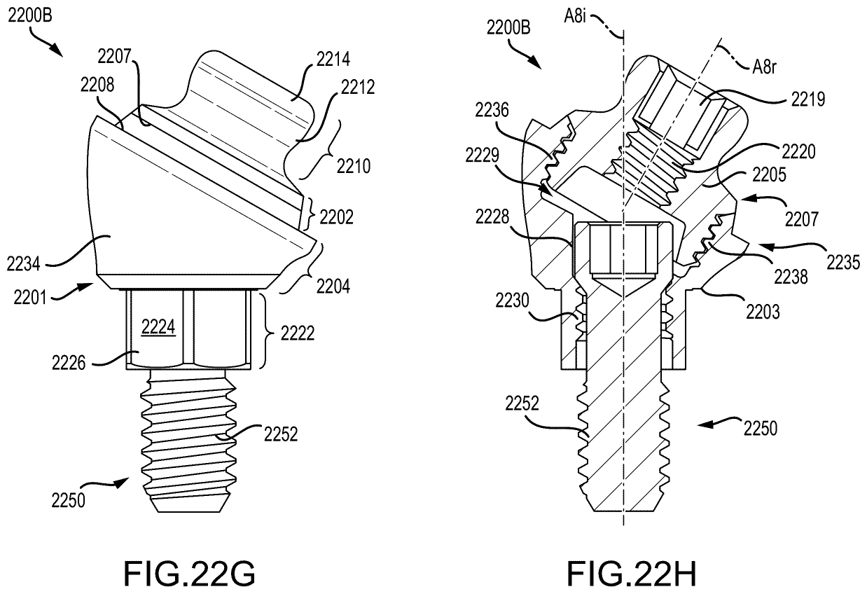

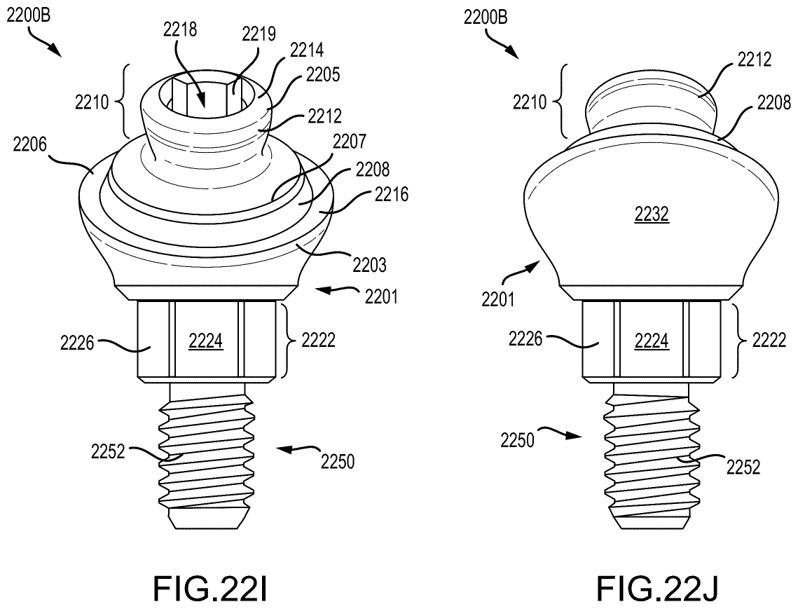

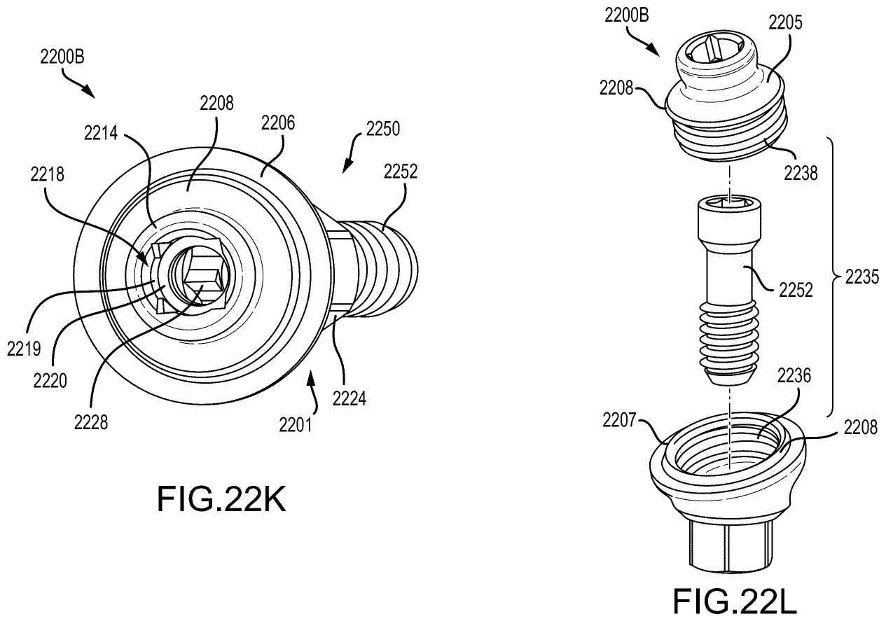

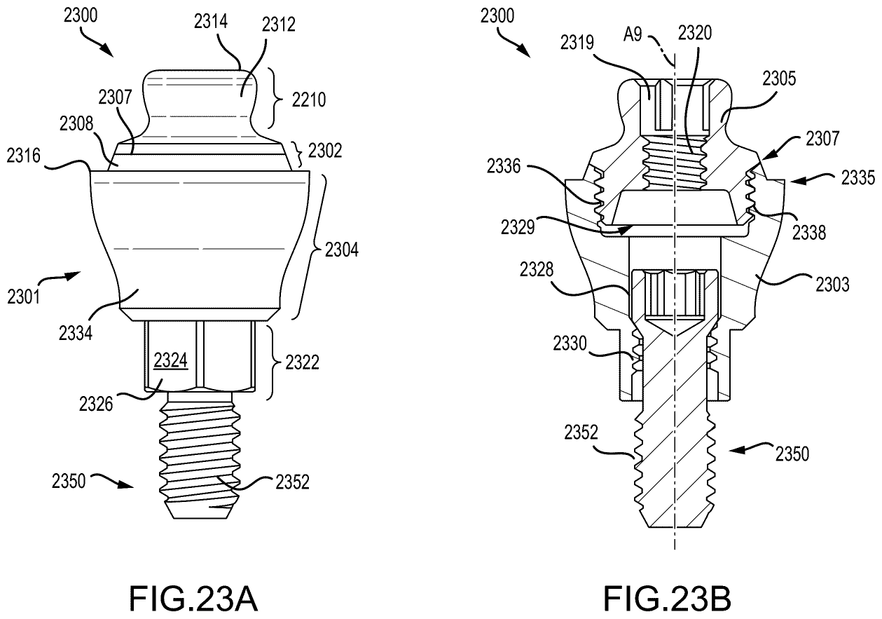

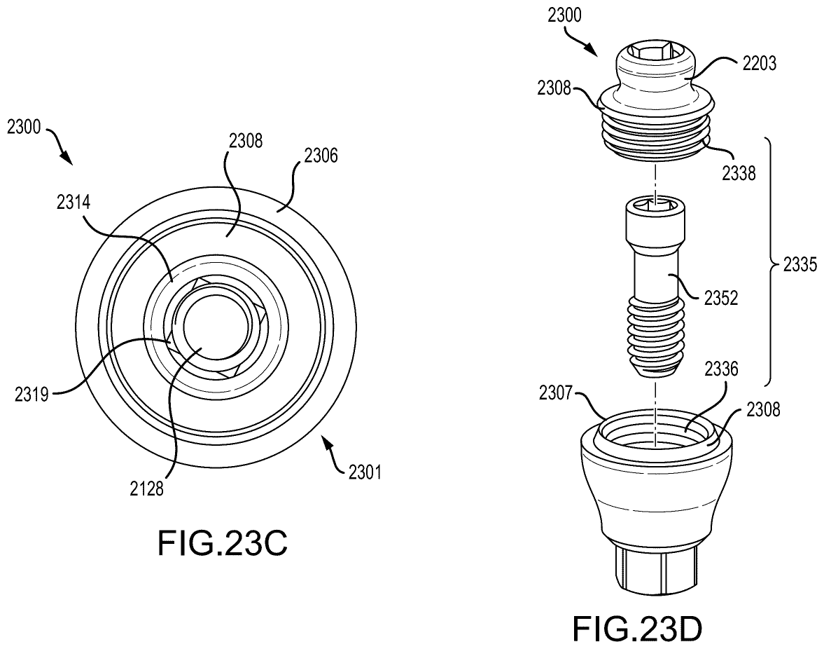

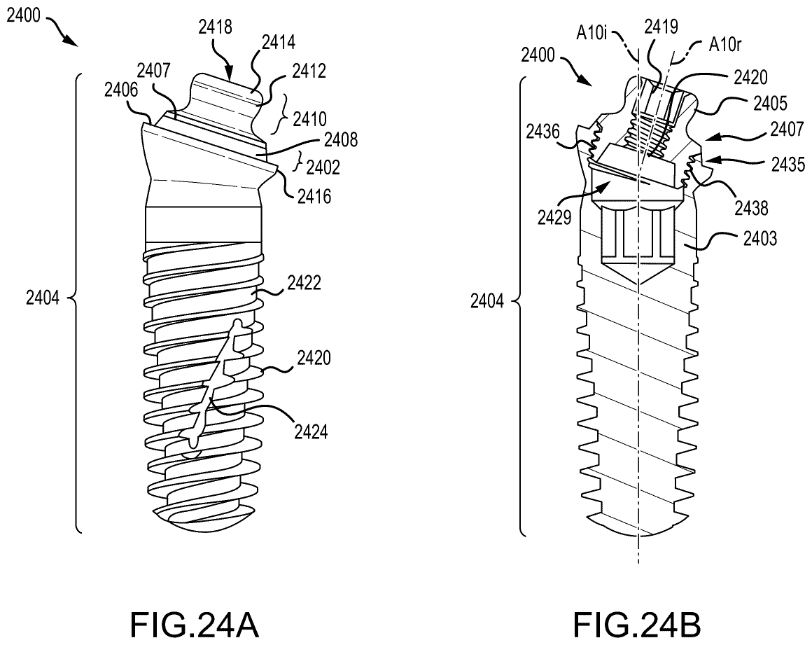

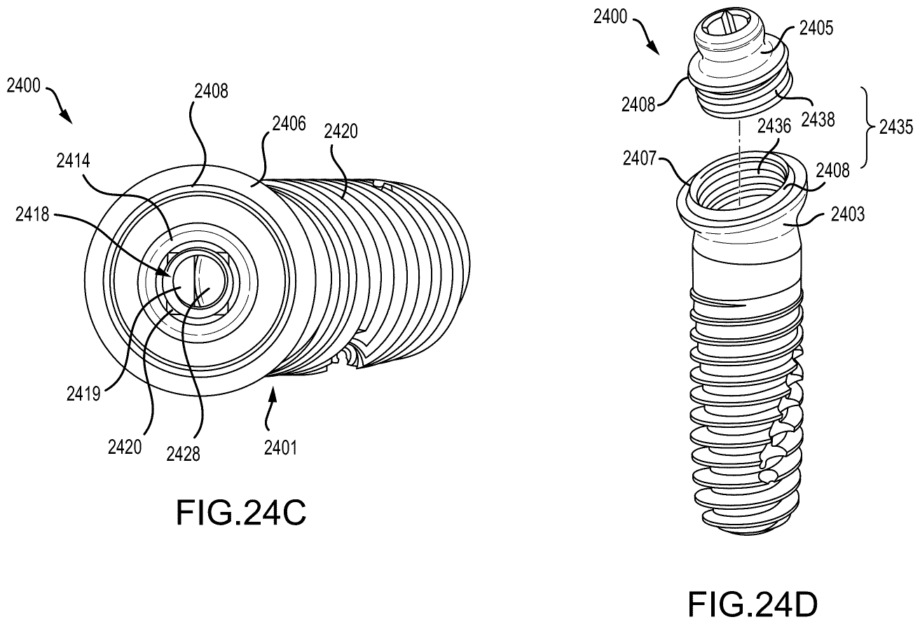

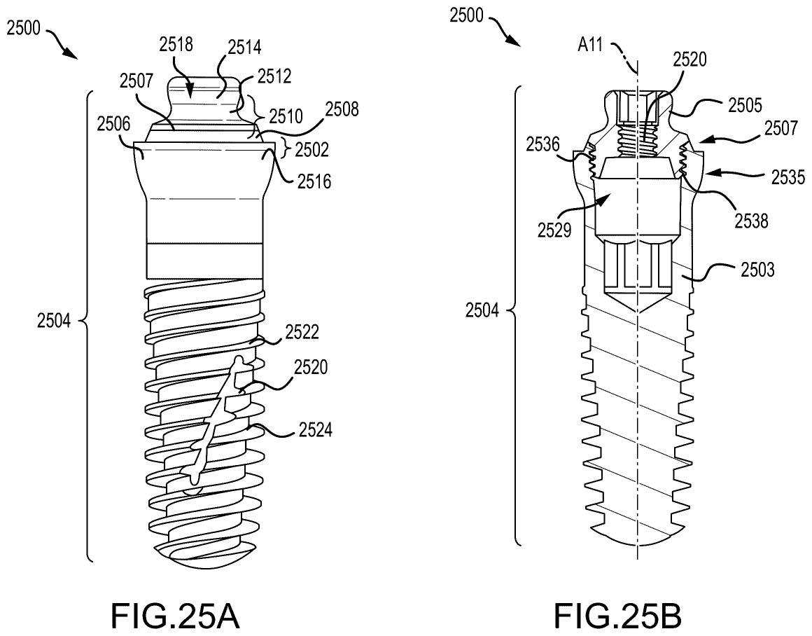

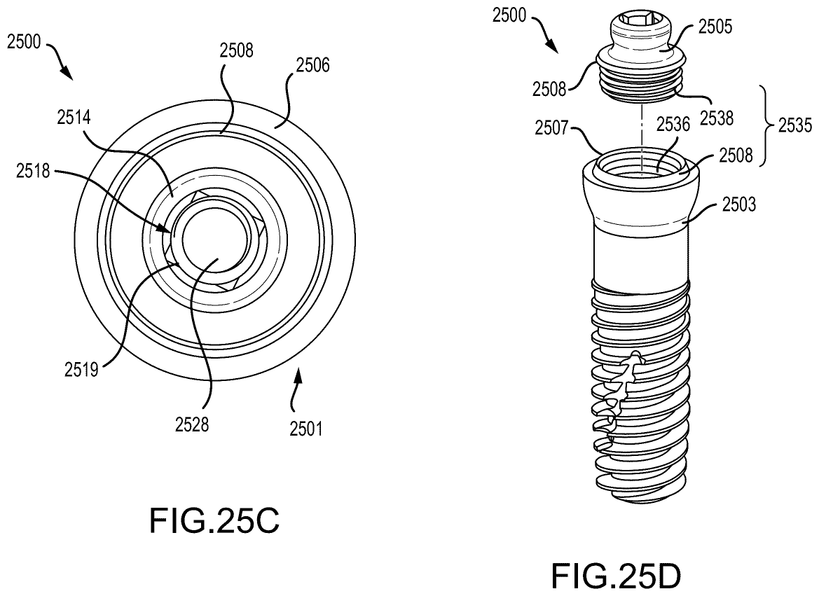

Referring to the feature 506 and/or the section 510 of the abutment 500 of at least FIG. 5A (though feature 506 and/or section 310 of the abutment 300 in at least FIG. 3A, and/or feature 806 and/or section 810 of the abutment 800 in at least FIG. 8A, feature 1906 and/or section 1910 of the abutment 1900 in at least FIG. 19, feature 2006 and/or section 2010 of the abutment 2000 in at least FIG. 20A, feature 2106 and/or section 2110 of the abutment 2100 in at least FIG. 21A, feature 2206 and/or section 2210 of the abutment 2200 in at least FIG. 22A, feature 2306 and/or section 2310 of the abutment 2300 in at least FIG. 23A, feature 2406 and/or section 2410 of the abutment 2400 in at least FIG. 24A, and/or feature 2506 and/or section 2510 of the abutment 2500 in at least FIG. 25A may be similarly referred to, without departing from the scope of the present disclosure), the abutment 500 (or a similarly-configured abutment) is usable for intermediate phases of the dental restoration procedure. The feature 506 and/or the section 510 is utilized to improve the performance of the intermediate phases of the restorative process for the clinician, patient, lab or other manufacturing facility designing and/or manufacturing a final restoration, or the like by accepting devices that include inner surfaces able to removably engage the feature 506 and/or components able to removably snap (or otherwise removably couple) to the section 510. It is noted that due to the temporary nature of the installation of the devices or tools used for the intermediate phases of the restorative process, a fastener or other attachment element in addition to the engaging inner surfaces and/or the retentive cap may not be used to secure the devices to the abutment 500 (i.e., as compared to a final restoration, as described throughout the present disclosure). Rather, engaging only an inner surface and/or utilizing only a retentive cap to removably snap (or otherwise removably couple) the device to the abutment 500 allows for the devices to be more quickly and easily attached to the feature 506 and/or the section 510 of the abutment 500.

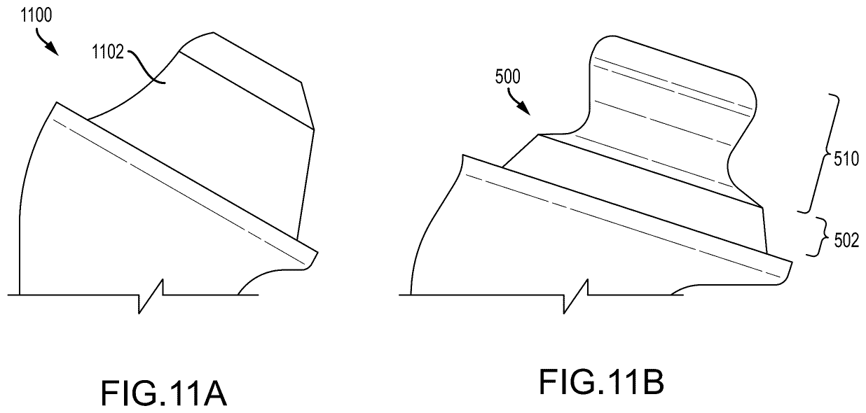

In this regard, any known devices or tools currently coupled via a fastener or similar hardware may instead be modified without the scope of the present disclosure to include inner surfaces that engage the features 302, 502, 802, 1902, 2002, 2102, 2119, 2202, 2219, 2302, 2319, 2402, 2419, 2502, 2519, the features 306, 506, 806, 1906, 2006, 2106, 2206, 2306, 2406, 2506, and/or retentive components that can be snapped (or otherwise coupled) onto the sections 310, 510, 810, 1910, 2100, 2110, 2210, 2310, 2410, 2510 of the abutments 300, 500, 800, 1900, 2000, 2100, 2200, 2300, 2400, 2500 respectively. For example, the devices and tools may include, but are not limited to, impression copings, scan bodies, temporary cylinders, healing abutments, sockets, wrenches, screwdrivers, and the like. Example devices or tools usable by clinicians during the intermediate phases of the restorative process are shown in FIGS. 11A-16C.

FIG. 11A illustrates a version of an abutment 1100 (e.g., such as one used in a restoration system), and FIG. 11B illustrates the hybrid abutment 500 as illustrated in FIGS. 5A-51 and as described herein for comparison. As shown in FIGS. 11A and 11B, the height of the hybrid abutments 500 and 1100 relative to the platform is approximately the same, and the platform diameter is approximately the same for the hybrid abutments 500 and 1100. However, the hybrid abutment 500 is operable for both abutment systems and overdenture systems due to the configuration of the restorative feature 502 and the denture section 510 as described throughout the present disclosure, as compared to the abutment 1100 only being usable for abutment systems due to the configuration of an upper portion 1102 of the abutment 1100. It is noted that any excess raised portion of the hybrid abutment 500 for overdenture usage may be reduced or minimized so long as internal thread engagement is ensured.

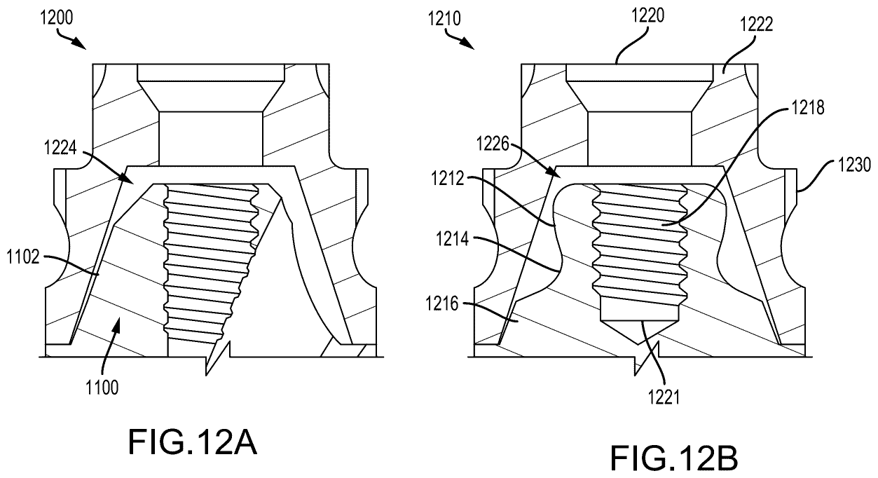

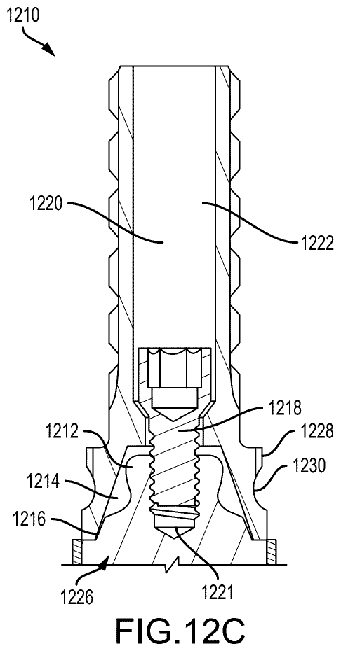

FIG. 12A illustrates a version of a restorative component 1200, and FIGS. 12B-12C illustrate a restorative component 1210 in accordance with one or more embodiments of the present disclosure for comparison. As shown in FIG. 12A, the restorative component 1200 may be usable with an abutment 1100 similar to that illustrated in FIG. 11A. In contrast, the restorative component 1210 of FIGS. 12B and 12C is operable with any of the hybrid abutments 300, 500, 800 as described throughout the present disclosure and illustrated in at least FIGS. 3A-3E, 5A-5I, and 8A-8I. Similarly, the restorative component 1210 is operable with any of the hybrid abutments 1900, 2000, 2100, 2200, 2300, 2400, 2500 as described through the present disclosure and illustrated in at least FIGS. 19, 20A-20F, 21A-21F, 22A-22L, 23A-23D, 24A-24D, and 25A-25D.

The restorative component 1210 includes an interior surface 1212 that is contoured to conform to any of the hybrid abutments 300, 500, 800, 1900, 2000, 2100, 2200, 2300, 2400, 2500. For example, the interior surface 1212 may include a denture section 1214 that is contoured to conform to the sidewalls 312, 512, 812, 1912, 2012, 2112, 2212, 2312, 2412, 2512 of the respective denture sections 310, 510, 810, 1910, 2010, 2110, 2210, 2310, 2410, 2510. By way of another example, the interior surface 1212 may include a ridge sidewall section 1216 that is contoured to conform to the ridge sidewalls 308, 508, 808, 1908, 2008, 2108, 2208, 2308, 2408, 2508.

In some embodiments, the restorative component 1210 is configured to receive a connector 1218 (e.g., a fastener) via a bore or aperture 1220 in a body 1222. For example, the connector 1218 may pass through the body 1222 to engage threading 1221 or another component of an interlocking assembly in the respective primary bores or apertures 318, 518, 818, 1918, 2018, 2118, 2218, 2318, 2418, 2518 of the hybrid abutments 300, 500, 800, 1900, 2000, 2100, 2200, 2300, 2400, 2500.

In comparing the known restorative component 1200 against the restorative component 1210 of the present disclosure, the restorative component 1200 utilizes 100% of an internal cavity 1224 to engage with an abutment 1100. However, the restorative component 1210 utilizes approximately 28% of an internal cavity 1226 to engage an abutment and approximately 72% to engage an overdenture abutment portion (e.g., a denture section 310, 510, 810, 1910, 2010, 2110, 2210, 2310, 2410, 2510 of the hybrid abutments 300, 500, 800, 1900, 2000, 2100, 2200, 2300, 2400, 2500), where the approximately 72% may be considered a snap cone portion. In addition, it is noted that the height of the external features of the abutment may be reduced to allow for an increase in snap cone height percentage. In one non-limiting example, the restorative component 1210 may utilize approximately 10.6% of an internal cavity 1226 to engage an abutment and approximately 89.4% to engage an overdenture abutment portion (e.g., a denture section 310, 510, 810, 1910, 2010, 2110, 2210, 2310, 2410, 2510 of the hybrid abutments 300, 500, 800, 1900, 2000, 2100, 2200, 2300, 2400, 2500), where the approximately 89.4% may be considered a snap cone portion. In general, the abutment portion of the internal cavity 1226 may range between approximately 10% and 30%, and the overdenture abutment portion of the internal cavity 1226 may range between approximately 70% and 90%, such that the ratio of the internal cavity 1226 may range between approximately 10/90 and approximately 30/70.

In one non-limiting example, internal dimensions of the respective cavities 1224, 1226 for interfacing the abutments are substantially equal. For instance, the cavities 1224, 1226 have a height of 2.2 mm (0.087 in), and a lower width of 4.04 mm (0.159 in). In addition, the total width of the restorative components 1200, 1210 are substantially equal. For instance, the total width may be 4.8 mm (0.189 in). This allows for the retrofitting of the restorative component 1210 with existing abutment systems. As such, although intended for use with the hybrid abutments 300, 500, 800, is noted that the restorative component 1210 may be considered backwards compatible with existing abutment style restorative attachments such as the abutment 1100 shown in FIG. 11A.

It should be understood that the restorative component 1210 is not limited to an exterior surface 1228 including one or more protrusions and/or grooves on a distal portion 1230 that houses the interior surfaces 1212, 1214, 1216 and the cavity 1226. Rather, the exterior surface 1228 may be substantially smooth, may include one or more ridges, may include one or more tool interface sections, or generally may have an exterior surface 1228 that is contoured to transition from a distal end of the distal portion 1230 to the body 1222 (or the proximal portion), without departing from the scope of the present disclosure.

One benefit of the restorative component 1210 is the inclusion of an elongated connector channel (e.g., the bore or aperture 1220) through the body 1222, to assist in guiding the connector 1218 into the hybrid abutment 300, 500, 800, 1900, 2000, 2100, 2200, 2300, 2400, 2500. In contrast, it would be more difficult to insert a connector in solutions that only include a neck extending from an exterior portion (e.g., similar to the exterior portion 1230 above) without assistance from a secondary tool coupled to/uncoupled from the neck, especially in consideration of the millimeter sizing of the connectors. It is noted that these neck solutions additionally may not be designed to contain a head of a connector, but instead that the head of the connector seats outside the neck, such that there are additional seams between the connector and the neck that may be subject to collection of unwanted matter within the neck via the seam.

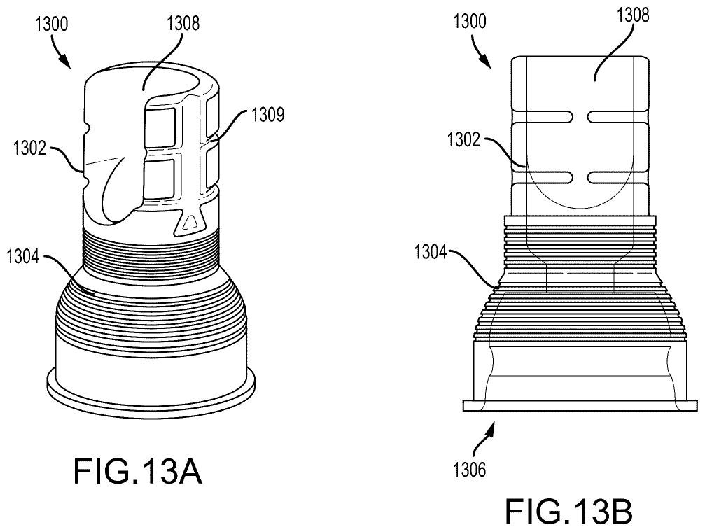

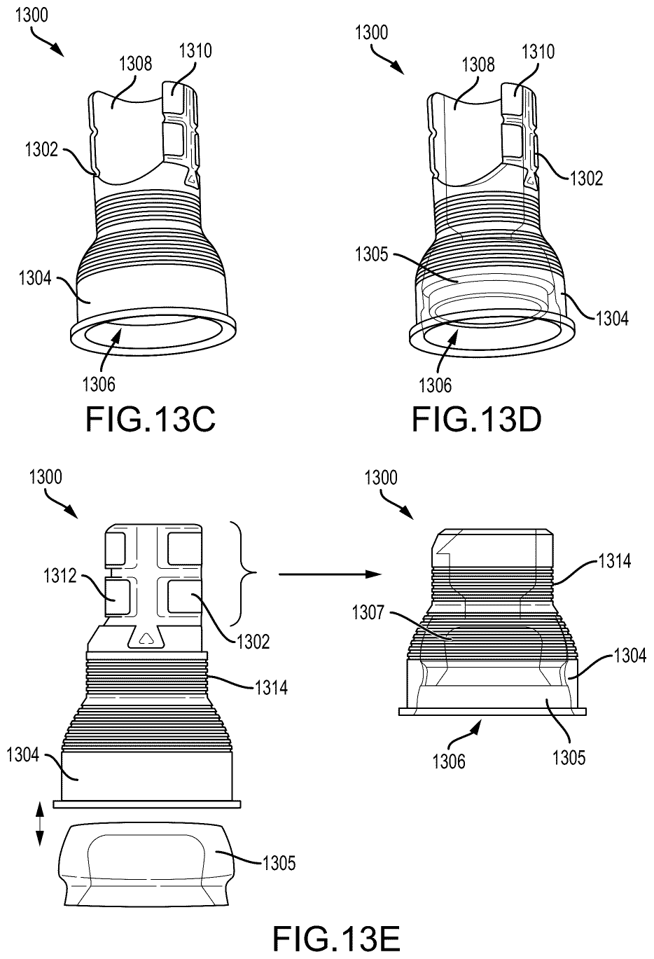

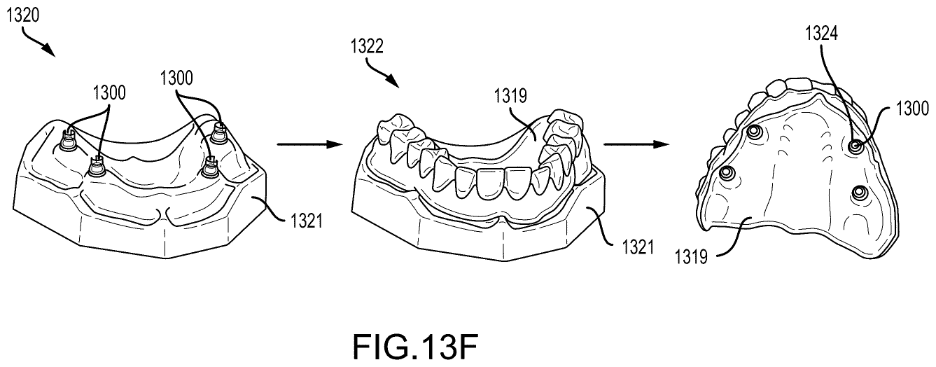

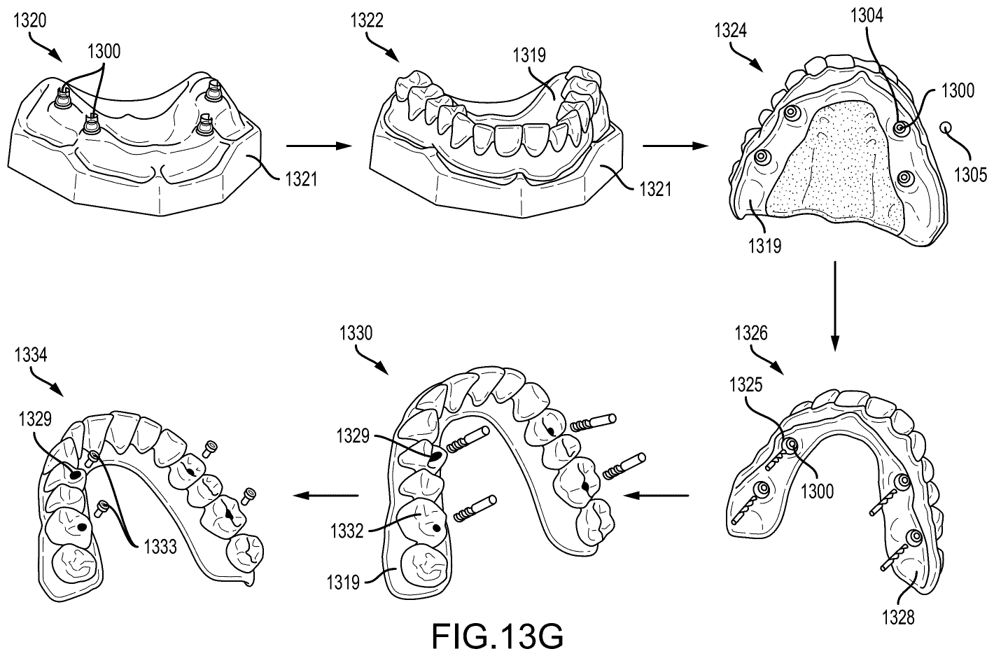

Another benefit of the restorative component is the ability to create a compact installation once the connector 1218 is seated within the hybrid abutment 300, 500, 800, 1900, 2000, 2100, 2200, 2300, 2400, 2500. FIGS. 13A-13E illustrate a restorative 1300 that is convertible from an initial connector installation build or configuration to a second, more compact installation including a neck that houses a head of the connector, in accordance with one or more embodiments of the present disclosure. The restorative 1300 includes a proximal portion 1302 (e.g., that may correspond to the body 1222) and a distal portion 1304 (e.g., that may correspond to the lower portion 1230). The restorative 1300 may be at least partially hollow through the interior of the proximal portion 1302 and/or the distal portion 1304.

In some examples, the restorative 1300 may engage the hybrid abutment 300, 500, 800, 1900, 2000, 2100, 2200, 2300, 2400, 2500 used in an abutment system. For instance, the restorative 1300 may optionally include a resilient member 1305 within a cavity 1306 of the distal portion 1304, where the resilient member 1305 is configured to seat on and engage with one or more surfaces of the hybrid abutment 300, 500, 800, 1900, 2000, 2100, 2200, 2300, 2400, 2500. However, it should be understood that, in alternative builds, the cavity 1306 may be contoured to couple directly to the hybrid abutment 300, 500, 800, 1900, 2000, 2100, 2200, 2300, 2400, 2500 and/or fabricate from a select material to provide a sufficient interference or friction fit without need for the resilient member, without departing from the scope of the present disclosure. In some instances with respect to these alternative builds, however, the contouring may be only to prevent movement or rotation during installation, and a connector (e.g., connector 1333) may be necessary to secure the restorative 1300 to the hybrid abutment 300, 500, 800, 1900, 2000, 2100, 2200, 2300, 2400, 2500.

In embodiments, an exterior surface 1307 of the distal portion 1304 may be substantially smooth, may include one or more ridges, may include one or more tool interface sections, or generally may be contoured to transition from a distal end of the distal portion 1304 to the proximal portion 1302. In embodiments, the proximal portion 1302 includes a pattern 1309 that provides a guide for customizing the restorative 1300 at respective heights, dependent on a patient's need with respect to the design of the final restoration. In additional embodiments, the proximal portion 1302 may include a channel 1308, which is operable to receive a connector in a straight, substantially straight, or angulated direction (e.g., while being driven by a tool in a same or similar direction). For example, the channel 1308 may be accessible via a hole or aperture 1310 in a proximal surface of the proximal portion 1302 (e.g., including, but not limited to, for 0° or low-angle builds up to approximately 20°). By way of another example, the channel 1308 may be accessible via a hole or aperture 1310 in a side surface, either in addition to or instead of being in the proximal surface, of the proximal portion 1302 (e.g., including, but not limited to, for mid- or high-angle builds between approximately 20° and 65°).

In further embodiments, the proximal portion 1302 includes a channel section 1312 at a proximal end, and a neck section 1314 at a distal end (and proximate to the distal portion 1304). As illustrated in FIG. 13E, the distal portion 1304 may receive the resilient member 1305. Once the distal portion 1304 with the resilient member 1305 is seated on the hybrid abutment 300, 500, 800, 1900, 2000, 2100, 2200, 2300, 2400, 2500, a connector may optionally be inserted through the channel section 1312 to engage the hybrid abutment 300, 500, 800, 1900, 2000, 2100, 2200, 2300, 2400, 2500. The channel section 1312 may then be removed (e.g., along a groove within the pattern 1309), leaving only the neck section 1314 and the distal portion 1304 installed on the hybrid abutment 300, 500, 800, 1900, 2000, 2100, 2200, 2300, 2400, 2500 via the optional connector. In this regard, the restorative 1300 includes both the benefits of the channel for the optional connector and the compact build with the neck.

FIGS. 13F and 13G illustrate two examples of overdenture installation of the restorative 1300. In particular, FIG. 13F is for a non-connector installation of the overdenture, and FIG. 13G is for installation of the overdenture using a connector.

In FIG. 13F, installation of an overdenture 1319 without connectors includes coupling 1320 (e.g., snapping) the restorative 1300 to the hybrid abutment 300, 500, 800, 1900, 2000, 2100, 2200, 2300, 2400, 2500 installed in gingivae 1321 (or a pre-designed gingivae mold, if the process is completely external to a patient's mouth). The overdenture 1319 is then bonded 1322 to the gingivae (or gingivae mold) over the restorative 1300, where the overdenture includes apertures 1325 that align with the restorative 1300. Once bonded, the overdenture 1319 may be removed, and the restoratives 1300 are seated within the apertures 1325.

In FIG. 13G, installation of the overdenture 1319 may additionally require the use of connectors in some or all regions of the mouth. Following the coupling 1320 and bonding 1322 of FIG. 13F, the overdenture 1319 may be further modified for connectors. First, optional resilient members 1305 may be removed 1324 from the restorative 1300 (e.g., from the distal portion 1304). Next, holes or apertures 1325 may be formed 1326 (e.g., via drilling, or the like) from an underside 1328 (e.g., gingivac-side) of the overdenture 1319. The holes or apertures 1325 may go through the entire overdenture 1319 or only into the overdenture 1319 a pre-determined depth.

Optionally, secondary holes or apertures 1329 that align with the holes or apertures 1325 may be formed 1330 (e.g., via drilling or the like) from an overside 1332 (e.g., teeth-side) of the overdenture 1319. For example, the holes or apertures 1329 may be optional where the hole or apertures 1325 pass through the entire overdenture 1319. By way of another example, the holes or apertures 1329 may align with and connect to the holes or apertures 1325, and/or further bore out the holes or apertures 1325 from a first smaller diameter to a second larger diameter. It is noted, however, that the holes or apertures 1329 may be the only holes or apertures formed in the overdenture 1319, without departing from the scope of the present disclosure.

Where the resilient members 1305 were removed 1324, the resilient members 1305 may be re-inserted after either the forming 1326 or forming 1326 of holes or apertures. Although not shown, the overdenture 1319 is then installed on a patient's gingivae, and connectors 1333 are inserted 1334 into the overdenture 1319 via the holes or apertures 1329, to couple the overdenture 1319 to the hybrid abutment 300, 500, 800, 1900, 2000, 2100, 2200, 2300, 2400, 2500. Optionally, the holes or apertures 1329 are filled into to prevent unwanted matter from entering the overdenture 1319 (and the hybrid abutment 300, 500, 800, 1900, 2000, 2100, 2200, 2300, 2400, 2500).

It should be understood that only a first portion of the overdenture 1319 may include only the coupling via the optional resilient members 1305, and a second portion of the overdenture 1319 may be drilled with the holes or apertures 1325 and/or 1329 in addition to the coupling via the optional resilient members 1305, without departing from the scope of the present disclosure. In one non-limiting example, the portion of the overdenture 1319 including replacement incisors and/or canines may only require the coupling via the resilient members 1305, while the portion of the overdenture 1319 including replacement premolars and/or molars may require both the coupling via the resilient members 1305 and the connectors 1333. It is contemplated that this may be beneficial for operational reasons (e.g., less force necessary to bite into a food item versus chewing the food item) and/or for aesthetic reasons (e.g., not having visible holes or apertures in the overdenture 1319 proximate to or at the front of the mouth). In general, the use of coupling via the resilient members 1305 and/or the connectors 1333 should be considered as illustrative, and not limiting on the present disclosure.

In this regard, the restorative 1300 provide a single solution for multiple different installation needs. For example, the restorative 1300 provides an option for a medical professional to utilize the initial snap-on stages from FIG. 13F while preparing the user for later connector stages from FIG. 13G, as both solutions utilize the initial snap-on coupling. As there may be time that passes between the various stages of the installation procedure, the snap-on coupling would still allow a patient to use the overdenture between the various stages. In addition, the positioning of the restorative 1300 within the overdenture 1319 and subsequent alignment and drilling of the holes or apertures 1325 and/or 1329 allows for a more precise drilling that results in a smaller total hole or aperture for the connector 1333, as compared to other known methods of installation. This increased level of preciseness can considerably reduce the time and/or steps required to place a partial or full arch abutment (e.g., the overdenture 1319), as the guess and check of other known methods of installation is more time-intensive and can result in larger-diameter holes or apertures.

By way of another example, the restorative 1300 allows for the determination of either a removable or a connected solution. As the no-connector and connector installations require the same initial steps, a user can decide to have the complete connector-based solution done, and then elect to switch between the full connector-based coupling and only utilizing the snap-on coupling, as both solutions utilize the initial snap-on coupling, by removing the connector with tools provided by a medical professional.

By way of another example, the optional resilient member 1305 offers different friction options by interchanging or removing the resilient member 1305. This allows a user to obtain the desired level of security in the fit of the overdenture 1319.

In contrast, solutions that require different bases for snap-on, non-engaging, and engaging restoratives do not provide the level of flexibility for the medical professional and/or the patient/user that is provided by the restorative 1300. Each of the different bases require different fit and features that are unique to the bases, which would require additional installation work to switch between as desired by a patient/user.

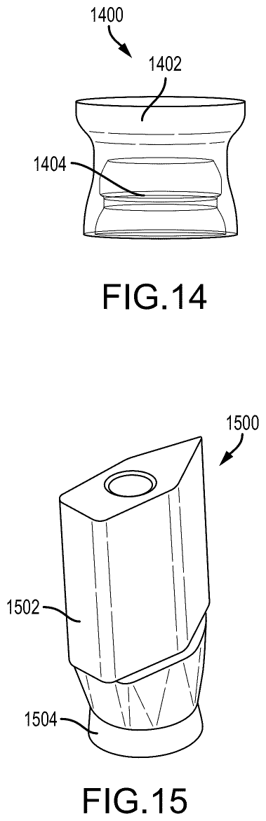

FIG. 14 illustrates a healing snap cap 1400, in accordance with one or more embodiments of the present disclosure. The healing cap 1400 includes an upper portion 1402 and a lower portion 1404. The healing cap 1400 may be at least partially hollow through the interior of the upper portion 1402 and/or the lower portion 1404, and include internal threading to engage an abutment used in an abutment system. It is contemplated the healing cap 1400 may include a resilient member within the lower portion 1404, and/or an interior contoured coupling surface.

FIG. 15 illustrates a scan body 1500, in accordance with one or more embodiments of the present disclosure. The scan body 1500 includes an upper portion 1502 and a lower portion 1504. The scan body 1500 may be at least partially hollow through the interior of the upper portion 1502 and/or the lower portion 1504 and include internal threading to engage an abutment used in an abutment system. It is contemplated the scan body 1500 may include a resilient member within the lower portion 1504. The scan body 1500 may include one or more externally set and/or internally set markers, including physical markers, radiopaque markers, and the like that are usable for the design phase to map the components of the restorative system to the patient and/or during the installation phase to assist in positioning the components of the restorative system within the mouth of the patient. It is noted herein the devices or tools may include an impression coping, which operates as an “analog” version of the scan body 1500.

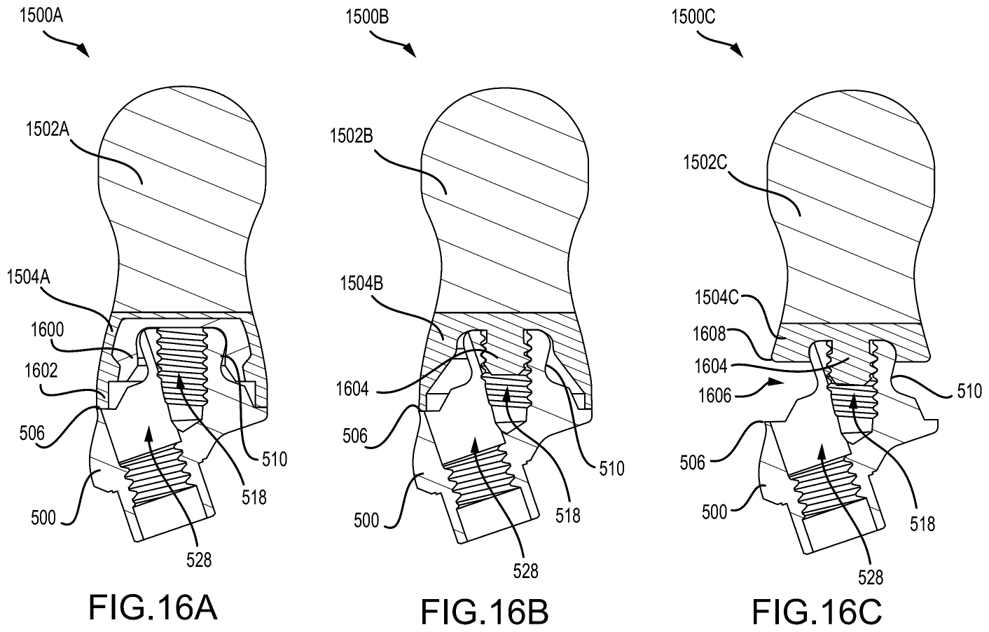

FIGS. 16A-16C illustrate variations of the scan body 1500, in accordance with one or more embodiments of the present disclosure.

In FIG. 16A, a scan body 1500A is coupled to the hybrid abutment 500 (but may be coupled to any of the hybrid abutments 300, 500, 800, 1900, 2000, 2100, 2200, 2300, 2400, 2500 and corresponding components) and includes upper portion 1502A and lower portion 1504A. The lower portion 1504A includes a resilient member 1600 within an outer layer 1602. The resilient member 1600 is operable to couple to the denture section 510 of the hybrid abutment 500. Optionally, the lower portion 1504A may come into contact with the restorative platform 506, such that when coupled to the hybrid abutment 500, the scan body 1500A may cover and protect a portion or all of the primary bore or aperture 518 and/or the secondary bore or aperture 528 from unwanted matter.

In FIG. 16B, a scan body 1500B is coupled to the hybrid abutment 500 and includes upper portion 1502B and lower portion 1504B. The lower portion 1504B includes threading 1604 (e.g., on an exterior surface of a protrusion extending downward within an interior cavity of the lower portion 1504B) that is operable to engage with the primary bore or aperture 518. Optionally, the lower portion 1504B may come into contact with the restorative platform 506, such that when coupled to the hybrid abutment 500, the scan body 1500B may cover and protect a portion or all of the primary bore or aperture 518 and/or the secondary bore or aperture 528 from unwanted matter.

In FIG. 16C, a scan body 1500C is coupled to the hybrid abutment 500 and includes upper portion 1502C and lower portion 1504C. The lower portion 1504C includes threading 1604 (e.g., on an exterior surface of a protrusion extending downward within an interior cavity of the lower portion 1504C) that is operable to engage with the primary bore or aperture 518. Where the lower portion 1504C does not come into contact with the restorative platform 506, a gap 1606 between the restorative platform 506 and a lower surface 1608 of the lower portion 1504C may be formed. However, it is noted that the gap height or distance between the platform 506 and lower surface 1608 may be known or measurable, such that it does not interfere with the design and/or installation phases of the restorative procedure.

In this regard, embodiments of the present disclosure are directed to utilizing the features 302, 502, 802, 1902, 2002, 2102, 2119, 2202, 2219, 2302, 2319, 2402, 2419, 2502, 2519, the features 306, 506, 806, 1906, 2006, 2106, 2206, 2306, 2406, 2506, and/or the sections 310, 510, 810, 1910, 2010, 2110, 2210, 2310, 2410, 2510 of the abutments 300, 500, 800, 1900, 2000, 2100, 2200, 2300, 2400, 2500 to couple a device or tool used during intermediate phases of the restorative procedure, couple a temporary dental prosthesis to the abutments 300, 500, 800, and/or couple a final prosthesis to the abutments 300, 500, 800, 1900, 2000, 2100, 2200, 2300, 2400, 2500. It is noted herein, however, that the features 302, 502, 802, 1902, 2002, 2102, 2119, 2202, 2219, 2302, 2319, 2402, 2419, 2502, 2519, the features 306, 506, 806, 1906, 2006, 2106, 2206, 2306, 2406, 2506, and/or the sections 310, 510, 810, 1910, 2010, 2110, 2210, 2310, 2410, 2510 of the abutments 300, 500, 800, 1900, 2000, 2100, 2200, 2300, 2400, 2500 may be utilized only during select phases of the restorative procedure, without departing from the scope of the present disclosure.

For example, the features 302, 502, 802, 1902, 2002, 2102, 2119, 2202, 2219, 2302, 2319, 2402, 2419, 2502, 2519, the features 306, 506, 806, 1906, 2006, 2106, 2206, 2306, 2406, 2506, and/or the sections 310, 510, 810, 1910, 2010, 2110, 2210, 2310, 2410, 2510 of the abutments 300, 500, 800, 1900, 2000, 2100, 2200, 2300, 2400, 2500 may only be utilized to couple devices or tools used during intermediate phases of the restorative procedure (e.g., as described above), while a temporary prosthesis and/or a final prosthesis may only be attached to the abutments 300, 500, 800, 1900, 2000, 2100, 2200, 2300, 2400, 2500 via an alternative means of coupling (e.g., a threaded fastener or other interlocking mechanism), without departing from the scope of the present disclosure.

By way of another example, the features 302, 502, 802, 1902, 2002, 2102, 2119, 2202, 2219, 2302, 2319, 2402, 2419, 2502, 2519, the features 306, 506, 806, 1906, 2006, 2106, 2206, 2306, 2406, 2506, and/or the sections 310, 510, 810, 1910, 2010, 2110, 2210, 2310, 2410, 2510 of the abutments 300, 500, 800, 1900, 2000, 2100, 2200, 2300, 2400, 2500 may only be used to couple a temporary prosthesis, while an alternative means of coupling (e.g., a threaded fastener or other interlocking mechanism) may be utilized to couple devices or tools used during intermediate phases of the restorative procedure (e.g., as described above) and/or a final prosthesis to the abutments 300, 500, 800, 1900, 2000, 2100, 2200, 2300, 2400, 2500, without departing from the scope of the present disclosure.

By way of another example, the features 302, 502, 802, 1902, 2002, 2102, 2119, 2202, 2219, 2302, 2319, 2402, 2419, 2502, 2519, the features 306, 506, 806, 1906, 2006, 2106, 2206, 2306, 2406, 2506, and/or the sections 310, 510, 810, 1910, 2010, 2110, 2210, 2310, 2410, 2510 of the abutments 300, 500, 800, 1900, 2000, 2100, 2200, 2300, 2400, 2500 may only be used to couple a final prosthesis, while an alternative means of coupling (e.g., a threaded fastener or other interlocking mechanism) may be utilized to couple devices or tools used during intermediate phases of the restorative procedure (e.g., as described above) and/or a temporary prosthesis to the abutments 300, 500, 800, 1900, 2000, 2100, 2200, 2300, 2400, 2500, without departing from the scope of the present disclosure.

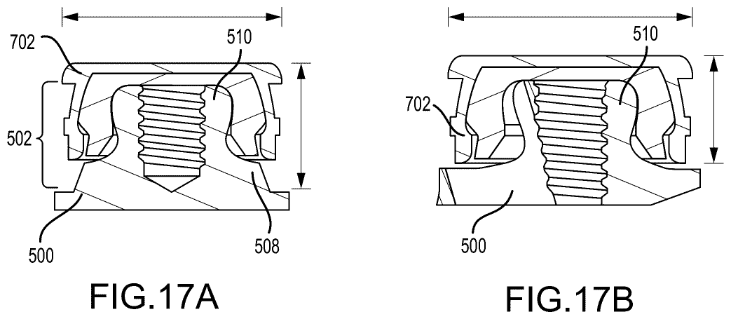

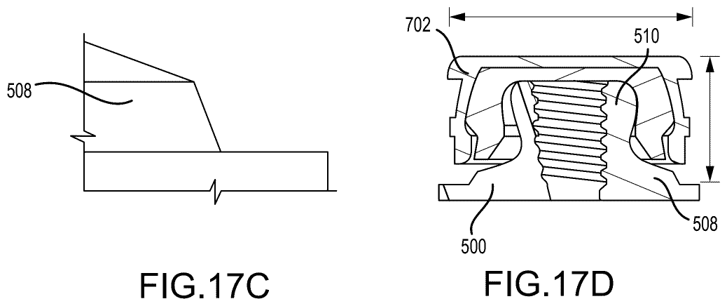

FIGS. 17A-17D depict example embodiments of the denture section of a hybrid abutment of the present disclosure. Although denture section 510 of the hybrid abutment 500 is provided in FIGS. 17-17D, it is noted that the Figs. may be directed to any of the hybrid abutments 300, 500, 800, 1900, 2000, 2100, 2200, 2300, 2400, 2500 and corresponding components.

In FIG. 17A, the hybrid abutment 500 with the restorative feature 502 includes a denture section 510 and a ridge sidewall 508 that totals to 2.68 mm (0.106 in) in height when the snap cap 702 is installed. FIG. 17B illustrates that an overdenture abutment may have a total height of 2.1 mm (0.083 in). However, as illustrated in FIGS. 17C and 17D, reducing the ridge sidewall 508 to a height of 0.1905 mm (0.0075 in) allows for the total height of the denture section 510, ridge sidewall 508, and snap cap 702 to be reduced to 2.3815 mm (0.094 in) in height, while maintaining similar widths or diameters of 4.4 mm (0.173 in). As such, FIGS. 17C and 17D illustrate that by lowering the external features of the abutment portion, the overall height of the hybrid abutment 500 can be reduced to be shorter than a known abutment while having only a nominal increase in height as compared to a known overdenture abutment (which results in only a nominal increase in height for the overdenture restorative). This affords the hybrid abutment 500 the ability to operate as a solution for both abutment restorations and overdenture restorations.

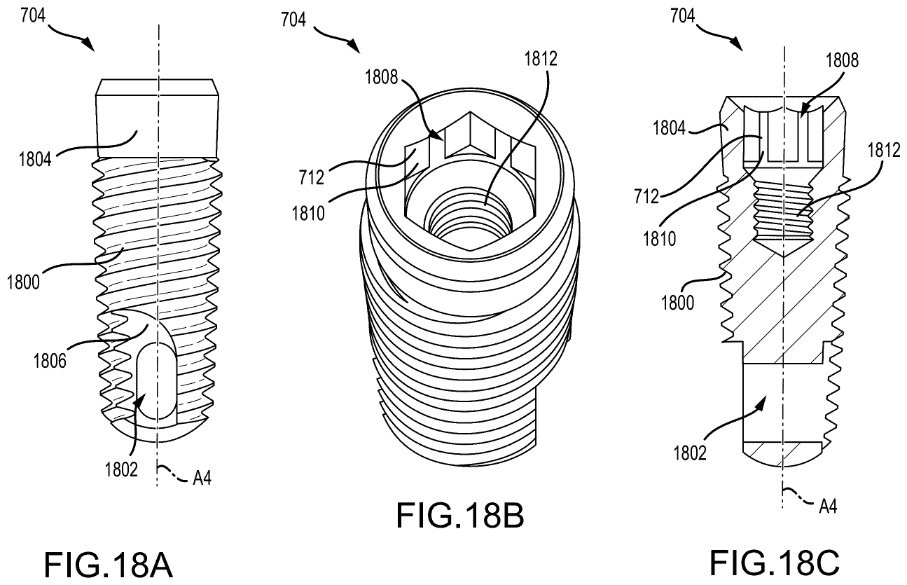

FIGS. 18A-18C illustrate an example dental implant, in accordance with one or more embodiments of the present disclosure. Although the implant 704 of the system 700 is provided in FIGS. 18A-18C, it is noted that the Figs. may be directed to any of the implants 404, 704, 1004 and corresponding systems 400, 700, and 1000, without departing from the scope of the present disclosure.

The implant 704 includes threading 1800 at a distal end. An aperture or bore 1802 may pass through a body 1804 of the implant 704. For example, the aperture or bore 1802 may be orthogonal to a longitudinal axis A4 of the implant 704. One or more teeth 1806 may be positioned along the body 1804. For example, the one or more teeth 1806 may be positioned within the threading 1800. In addition, the one or more teeth 1806 may include a tooth proximate to the aperture or bore 1802, such that osseous tissue or other biological tissue may be collected in the aperture or bore 1802 during installation and/or to allow for osseointegration with the jawbone by the implant 704 after installation.

The implant 704 includes an aperture or bore 1808 along the longitudinal axis A4 and operable to receive the receiver engagement section 322, 522, 822, 2022, 2122, 2222, 2322 of the hybrid abutments 300, 500, 800, 2000, 2100, 2200, 2300, respectively. For example, the aperture or bore 1808 may include the shaped region 712 with one or more sidewalls 1810, where the one or more sidewalls 1810 correspond to the sidewalls 328, 526, 826, 2026, 2126, 2226, 2326 of the shaped regions 326, 524, 824, 2024, 2124, 2224, 2324 of the receiver engagement section 322, 522, 822, 2022, 2122, 2222, 2322 of the hybrid abutments 300, 500, 800, 2000, 2100, 2200, 2300, respectively. By way of another example, the implant or bore 1808 includes threading 1812 that is complementary to threading operable to secure the hybrid abutments 300, 500, 800, 2000, 2100, 2200, 2300 to the implant 704. For instance, the threading 1812 may be complementary to the threading 324 of the receiver engagement region 322 of the hybrid abutment 300 (e.g., as illustrated in FIG. 3A). In addition, the threading 1812 may be complementary to the threading of a connector (e.g., connector 706 that passes through the hybrid abutment 500, as illustrated in FIG. 7A, or similarly connector 1006 that passes through the hybrid abutment 800, as illustrated in FIG. 10A).

In embodiments, the shaped region 712 may additionally include (or be used as) an interior tool interface to assist in installation of the implant 704. In some non-limiting examples, the interior tool interface includes a polygonal cross-section formed from 2, 3, . . . up to an N number of sides. In some instances, the exterior tool interface includes six sides, or alternatively four sides, to receive and engage with a tool such as a wrench, socket, screwdriver, or other device. In additional instances, the interior tool interface may include grooves into which protrusions from a tool may be inserted, without departing from the scope of the present disclosure.

It is noted that the implant of FIGS. 18A-18C is provided only as an example implant to which the hybrid abutments 300, 500, 800, 2000, 2100, 2200, 2300 may couple, and that other implants with varied dimensions, sizes, shapes, configurations, interlocking or interconnecting features with the hybrid abutments 300, 500, 800, 2000, 2100, 2200, 2300, and the like are contemplated without departing from the scope of the present disclosure.

FIG. 19 is a front elevation view of a monolithic hybrid abutment 1900, according to one or more embodiments of the present disclosure. It is noted that the hybrid abutment 1900 may be considered a straight, non-angled, or substantially straight abutment 1900, for purposes of the present disclosure. However, it should be understood that the variations of the monolithic hybrid abutment 1900 are contemplated for an angled hybrid abutment set at an angle ranging from 0° to 65°, without departing from the scope of the present disclosure. In addition, it is noted that aspects or features of (or embodiments directed to) the hybrid abutments 300, 500, 800 may be directed to the monolithic hybrid abutment 1900, without departing from the scope of the present disclosure.

The hybrid abutment 1900 includes a main body 1901. The hybrid abutment 1900 includes a restorative feature 1902 and an implant portion 1904, which are separated by a restorative surface or platform 1906. The restorative feature 1902 includes a ridge sidewall 1908. For example, the ridge sidewall 1908 may be straight, substantially straight, sloped, or contoured to conform to an arcuate shape. It is noted that the restorative feature 1902 may be considered a restoration portion of the hybrid abutment 1900, for purposes of the present disclosure. In addition, it is noted that the restorative feature 1902 is operable as a locating or centering feature of the hybrid abutment 1900 with respect to a dental restoration, as described in detail further herein.

The hybrid abutment 1900 includes a denture section 1910 with a sidewall 1912 that is contoured to conform to an arcuate shape, which extends between the ridge sidewall 1908 and a top surface 1914. It is noted that the denture section 1910 may be considered an overdenture portion of the hybrid abutment 1900, for purposes of the present disclosure.

In some embodiments, the ridge sidewall 1908 may include a sloped surface set at an angle defined relative to the restorative platform 1906. For example, the angle of the sloped surface may be selected such that the ridge sidewall 1908 does not intersect with the denture section 1910. For instance, the ridge sidewall 1908 may form a portion of a cone around the denture section 1910.

In embodiments, a platform section 1916 of the implant interface 1904 that includes the restorative platform 1906 has a greater diameter than the ridge sidewall 1908, and the ridge sidewall 1908 has a greater diameter than the top surface 1914. In these embodiments, the arcuate shape of the sidewall 1912 causes the denture section 1910 of the restorative feature 1902 to have a different diameter that at least ranges between the diameter of the ridge sidewall 1908 and the top surface 1914 at different cross-sections along the height of the denture section 1910. As described further herein, the arcuate shape of the sidewall 1912 is capable of coupling to a resilient insert or interior contoured coupling surface, depending on what is necessary to couple a particular restoration type to the hybrid abutment 1900.

A bore or aperture 1918 extends through the top surface 1914 and at least into the denture section 1910. In some embodiments, the bore or aperture 1918 is operable to engage with a connector (e.g., a fastener, or the like) operable to couple a restoration element to the hybrid abutment 1900, as described in detail further herein. In one non-limiting example, the bore or aperture 1918 may include threading (not shown), where the threading is operable to engage with complementary threading on the connector.

The implant portion 1904 is operable to be inserted into a jawbone along an installation or longitudinal axis A5. As illustrated in FIG. 19, a restorative axis (e.g., the axis for coupling a restoration to the hybrid abutment 1900) and an installation axis of the hybrid abutment 1900 are aligned or coaxial, both being depicted by the longitudinal axis A5.

The implant portion 1904 includes threading 1920 at a distal end. Although not shown, an aperture or bore may pass through a body 1922 of the implant portion 1904. For example, the aperture or bore may be orthogonal to the installation or longitudinal axis A5 of the implant portion 1904. Although not shown, one or more teeth may be positioned along the body 1922. For example, the one or more teeth may be positioned within the threading 1920. In addition, the one or more teeth may include a tooth proximate to the aperture or bore, such that osseous tissue or other biological tissue may be collected in the aperture or bore during installation and/or to allow for osseointegration with the jawbone by the implant portion 1904 after installation.

As illustrated in FIGS. 3A-18, the hybrid abutments 300, 500, 800 may generally be considered a “single-piece” build or configuration that includes receiver regions and restorative regions formed as a single body 301, 501, 801, for purposes of the present disclosure. In particular, a distal end of the single body engages (e.g., in insertable into and optionally interlocks with) a receiver such as an implant 404, 704, 1004. In addition, a proximal end of the single body is configured to receive restorative abutment components 402, 702, 1002. Further, an optional plug 600, 900 may be provided to fill a hole for a connector 706, 1006 within the single body. Similarly, the hybrid abutment 1900 of FIG. 19 may be understood as being a complete or full “single-piece” build or configuration with a body 1901 including both an implant portion and a restorative feature portion, for purposes of the present disclosure.

However, it should be understood that the hybrid abutments of the present disclosure are not limited to this “single-piece” build or configuration with a formed single body. Rather, the hybrid abutments of the present disclosure may include a “multi-piece” build or configuration that is fabricated and assembled from any number of components (e.g., 2, 3, . . . up to an N number of components) to form a main body for the hybrid abutment, without departing from the scope of the present disclosure.

FIGS. 20A-20F illustrate an example embodiment of a multi-piece build or configuration of a hybrid abutment 2000, according to one or more embodiments of the present disclosure. For example, FIGS. 20A-20F illustrates an angled hybrid abutment 2000 that may be set at an angle ranging from 0° to 65°. In particular, FIGS. 20A-20F generally illustrate an angled hybrid abutment 2000 with a 30° angle, in accordance with one or more embodiments of the present disclosure. To the extent possible, aspects of the hybrid abutments 300, 500, 800, 1900 are interchangeable and usable with the hybrid abutment 2000, and vice versa, unless otherwise noted.

The hybrid abutment 2000 includes a main body 2001 formed from a first portion 2003 and a second portion 2005 separated by a seam 2007. The hybrid abutment 2000 includes a restorative feature 2002 (e.g., in the second portion 2005) and a receiver interface 2004 (e.g., in the first portion 2003), which are separated by a restorative surface or platform 2006. For example, the seam 2007 between the first portion 2003 and the second portion 2005 may be positioned substantially at the platform 2006. In embodiments, the receiver interface 2004 includes a minimum cuff height (e.g., proximate to a front surface of the hybrid abutment 2000) and a maximum cuff height (e.g., proximate to a rear surface of the hybrid abutment 2000).

The restorative feature 2002 includes a ridge sidewall 2008. For example, the ridge sidewall 2008 may be straight, substantially straight, sloped, or contoured to conform to an arcuate or multi-sided polygonal shape. It is noted that the restorative feature 2002 may be considered a restoration portion of the hybrid abutment 2000, for purposes of the present disclosure. In addition, it is noted that the restorative feature 2002 is operable as a locating or centering feature of the hybrid abutment 2000 with respect to a dental restoration, as described in detail further herein.

In embodiments, the ridge sidewall 2008 may be contoured or shaped to receive a tool, such that the ridge sidewall 2008 may be considered an exterior tool interface, for purposes of the present disclosure. In some non-limiting examples, the exterior tool interface includes a polygonal cross-section formed from 2, 3, . . . up to an N number of sides. In some instances, the exterior tool interface includes six sides, or alternatively four sides, to receive and engage with a tool such as a wrench, socket, screwdriver, or other device. In additional instances, the ridge sidewall 2008 may include grooves into which protrusions from a tool may be inserted, without departing from the scope of the present disclosure.

In embodiments, the ridge sidewall 2008 may include contoured surfaces (e.g., similar to the conical or sloped surfaces of ridge sidewalls 2108, 2208, 2308, 2408, 2508 as described in detail further herein) in addition to the tool surfaces. For example, the ridge sidewall 2008 may include tool surfaces 2009A and conical or sloped surfaces 2009B, without departing from the scope of the present disclosure.

The hybrid abutment 2000 includes a denture section 2010 (e.g., in the second section 2005) with a sidewall 2012 that is contoured to conform to an arcuate shape, which extends between the ridge sidewall 2008 and a proximal surface 2014. It is noted that the denture section 2010 may be considered an overdenture portion of the hybrid abutment 2000, for purposes of the present disclosure.

In some embodiments, the ridge sidewall 2008 may be set at an angle defined relative to the restorative platform 2006. For example, the angle of the sloped surface may be selected such that the ridge sidewall 2008 does not intersect with the denture section 2010. For instance, the ridge sidewall 2008 may form a portion around the denture section 2010.

In embodiments, a platform section 2016 of the receiver interface 2004 that includes the restorative platform 2006 has a greater diameter than the ridge sidewall 2008, and the ridge sidewall 2008 has a greater diameter than the proximal surface 2014. In these embodiments, the arcuate shape of the sidewall 2012 causes the denture section 2010 of the restorative feature 2002 to have a different diameter that at least ranges between the diameter of the ridge sidewall 2008 and the proximal surface 2014 at different cross-sections along the height of the denture section 2010. As described further herein, the arcuate shape of the sidewall 2012 is capable of coupling to a resilient insert or interior contoured coupling surface, depending on what is necessary to couple a particular restoration type to the hybrid abutment 2000.

A primary bore or aperture 2018 extends through the proximal surface 2014 and at least into the denture section 2010. In some embodiments, the primary bore or aperture 2018 is operable to engage with a connector (e.g., a fastener, or the like) operable to couple a restoration element to the hybrid abutment 2000, as described in detail further herein. In one non-limiting example, the primary bore or aperture 2018 may include threading 2020, where the threading 2020 is operable to engage with complementary threading on the connector.

The hybrid abutment 2000 includes a receiver engagement section 2022 (e.g., in the first section 2003). In embodiments, at least a portion of the receiver engagement section 2022 includes a shaped region 2024. For example, the shaped region 2024 may be contoured or shaped to have a polygonal cross-section along the length of the shaped region 2024, as shown in FIG. 20A. For instance, the polygonal cross-section may be a hexagon, such that the shaped region 2024 has six sidewalls 2026. By way of another example, the shaped region 2024 may be substantially cylindrical in shape with a single sidewall 2026 that is formed by a circular cross-section along the length of the shaped region 2024.

It is noted the shaped region 2024 may assist in alignment and/or prevent rotation (e.g., by interlocking with a receiver) of the hybrid abutment 2000 during installation. In addition, it is noted herein that the receiver engagement section 2024 may be considered a receiver portion operable to be inserted into a jawbone along an installation axis A6i, for purposes of the present disclosure. Further, it is noted that the shaped region 2024 may include an external configuration (e.g., a protrusion that is inserted into a mated receptacle in the receiver) or may include an internal configuration (e.g., a receptacle that is configured to receive a mated protrusion from the receiver), without departing from the scope of the present disclosure.

In addition to the receiver engagement section 2022, a secondary bore or aperture 2028 is within a cavity 2029 within the first portion 2003. For example, the cavity 2029 may serve as a transition region between the first portion 2003 and the second portion 2005, to ensure correct mating between the two portions 2003, 2005 through the seating of the ridge sidewall 2008 on/proximate to the platform 2006. It should be understood that the dimensions of the cavity 2029 are only illustrative, and are not intended to be limiting on the present disclosure.

The secondary bore or aperture 2028 may extend through the shaped region 2024 and exit into the cavity 2029. In some embodiments, the secondary bore or aperture 2028 is operable to engage with a connector 2052 (e.g., a fastener, or the like) operable to couple the hybrid abutment 2000 to a receiver, as described in detail further herein. In one non-limiting example, the secondary bore or aperture 2028 may include threading 2030, where the threading 2030 is operable to engage with complementary threading on the connector 2052. In this regard, the hybrid abutment 2000 and the connector 2052 may be considered components of a system 2050, for purposes of the present disclosure.

As illustrated in FIG. 20B, the restorative axis (e.g., the axis for coupling a restoration to the hybrid abutment 2000) is depicted by the longitudinal axis A6r, and the installation axis (e.g., the axis for coupling the hybrid abutment 2000 to a receiver) is depicted by the longitudinal axis A6i. The longitudinal axes A6r, A6i are not co-axially aligned but instead are offset at an angle relative to one another (e.g., where the angle is substantially equivalent to the angle of the hybrid abutment 2000 including, but not limited to, 30°).

In embodiments, the shaped region 2024 of the receiver engagement section 2022 may generally be of lesser width or diameter than the platform section 2016. Due to the difference in diameters, the receiver interface 2004 may include one or more transition regions 2032 between the various regions 2016, 2024. It is noted the one or more transition regions 2032 may be curved or linear such that the one or more transition regions 2032 create an abrupt change in diameter, a constant slope change in diameter, a change in diameter that is contoured to conform to an arcuate shape between the adjacent regions, or a combination thereof. For example, a transition region 2032 may connect the platform section 2016 and the shaped region 2024, where the transition region 2032 includes an exterior sidewall 2034 that is arcuate to conform to the angle of the hybrid abutment 2000. However, it is noted that the shaped region 2024 of the receiver engagement section 2022 may be of equal or greater width or diameter than the platform section 2016, without departing from the scope of the present disclosure.

The first portion 2003 and the second portion 2005 including mated components of an interlocking assembly 2035. For example, the interlocking assembly 2035 may include threading 2036 in the first portion 2003 and corresponding threading 2038 in the second portion 2005. By way of another example, the interlocking assembly may include any tab-and-groove or other set of interlocking features known in the art.

Interlocking the second portion 2005 with the first portion 2003 closes the cavity 2029 at the seam 2007, enclosing the secondary bore or aperture 2028 (and a head of the connector 2052 installed therein, which is inserted within the second bore or aperture 2028 prior to the interlocking). In this regard, the primary bore or aperture 2018 may be protected by the restoration element such that unwanted matter (e.g., food, saliva, dental cleaning aids, surrounding tissue, etc.) do not get into the hybrid abutment 2000. In addition, the secondary bore or aperture 2028 may be protected from the entrance of unwanted matter by the second portion 2005, and optionally further protected by the restoration element. The use of the first portion 2003 and the second portion 2005 removes the need for an additional plug, such as plug 600, 900 in the single-piece builds or configurations described in the application. In addition, the use of the first portion 2003 and the second portion 2005 allows for the sidewall 2012 to provide a full snap geometry for a restorative, as compared to the partial snap geometry of the sidewall 512 that may be completed by contoured exterior surfaces of the plug 600 and/or the partial snap geometry of the sidewall 812 that may be completed by contoured exterior surfaces of the plug 900, respectively.

Although not illustrated, it should be understood that a straight or substantially straight build or configuration with an exterior tool interface on the ridge sidewall 2008 and with the seam 2007 at the platform 2006 is contemplated for the hybrid abutment 2000, without departing from the scope of the present disclosure.

FIGS. 21A-21F illustrate an example embodiment of a multi-piece build or configuration of a hybrid abutment 2100, according to one or more embodiments of the present disclosure. For example, FIGS. 21A-21F illustrate an angled hybrid abutment 2100 that may be set at an angle ranging from 0° to 65°. In particular, FIGS. 21A-21F generally illustrate an angled hybrid abutment 2100 with a 17° angle, in accordance with one or more embodiments of the present disclosure. To the extent possible, aspects of the hybrid abutments 300, 500, 800, 1900, 2000 are interchangeable and usable with the hybrid abutment 2100, and vice versa, unless otherwise noted.

The hybrid abutment 2100 includes a main body 2101 formed from a first portion 2103 and a second portion 2105 separated by a seam 2107. The hybrid abutment 2100 includes a restorative feature 2102 (e.g., in the second portion 2105) and a receiver interface 2104 (e.g., in the first portion 2103), which are separated by a restorative surface or platform 2106. For example, the seam 2107 between the first portion 2103 and the second portion 2105 may be positioned substantially at the platform 2106. In embodiments, the receiver interface 2104 includes a minimum cuff height (e.g., proximate to a front surface of the hybrid abutment 2100) and a maximum cuff height (e.g., proximate to a rear surface of the hybrid abutment 2100).

The restorative feature 2102 includes a ridge sidewall 2108. For example, the ridge sidewall 2108 may be straight, substantially straight, sloped, or contoured to conform to an arcuate or multi-sided polygonal shape. It is noted that the restorative feature 2102 may be considered a restoration portion of the hybrid abutment 2100, for purposes of the present disclosure. In addition, it is noted that the restorative feature 2102 is operable as a locating or centering feature of the hybrid abutment 2100 with respect to a dental restoration, as described in detail further herein.

In embodiments, the ridge sidewall 2108 may include grooves into which protrusions from a tool may be inserted, without departing from the scope of the present disclosure.

The hybrid abutment 2100 includes a denture section 2110 (e.g., in the second section 2105) with a sidewall 2112 that is contoured to conform to an arcuate shape, which extends between the ridge sidewall 2108 and a proximal surface 2114. It is noted that the denture section 2110 may be considered an overdenture portion of the hybrid abutment 2100, for purposes of the present disclosure.

In some embodiments, the ridge sidewall 2108 may be set at an angle defined relative to the restorative platform 2106. For example, the angle of the sloped surface may be selected such that the ridge sidewall 2108 does not intersect with the denture section 2110. For instance, the ridge sidewall 2108 may form a portion around the denture section 2110.

In embodiments, a platform section 2116 of the receiver interface 2104 that includes the restorative platform 2106 has a greater diameter than the ridge sidewall 2108, and the ridge sidewall 2108 has a greater diameter than the proximal surface 2114. In these embodiments, the arcuate shape of the sidewall 2112 causes the denture section 2110 of the restorative feature 2102 to have a different diameter that at least ranges between the diameter of the ridge sidewall 2108 and the proximal surface 2114 at different cross-sections along the height of the denture section 2110. As described further herein, the arcuate shape of the sidewall 2112 is capable of coupling to a resilient insert or interior contoured coupling surface, depending on what is necessary to couple a particular restoration type to the hybrid abutment 2100.

A primary bore or aperture 2118 extends through the proximal surface 2114 and at least into the denture section 2110. In some embodiments, the primary bore or aperture 2118 is operable to engage with a connector (e.g., a fastener, or the like) operable to couple a restoration element to the hybrid abutment 2100, as described in detail further herein. In one non-limiting example, the primary bore or aperture 2118 may include threading 2120, where the threading 2120 is operable to engage with complementary threading on the connector.

In embodiments, the primary bore or aperture 2118 may include an interior tool interface 2119. In some non-limiting examples, the interior tool interface 2119 includes a polygonal cross-section formed from 2, 3, . . . up to an N number of sides. In some instances, the exterior tool interface includes six sides, or alternatively four sides, to receive and engage with a tool such as a wrench, socket, screwdriver, or other device. In additional instances, the interior tool interface 2119 may include grooves into which protrusions from a tool may be inserted, without departing from the scope of the present disclosure.

The hybrid abutment 2100 includes a receiver engagement section 2122 (e.g., in the first section 2103). In embodiments, at least a portion of the receiver engagement section 2122 includes a shaped region 2124. For example, the shaped region 2124 may be contoured or shaped to have a polygonal cross-section along the length of the shaped region 2124, as shown in FIG. 21A. For instance, the polygonal cross-section may be a hexagon, such that the shaped region 2124 has six sidewalls 2126. By way of another example, the shaped region 2124 may be substantially cylindrical in shape with a single sidewall 2126 that is formed by a circular cross-section along the length of the shaped region 2124.

It is noted the shaped region 2124 may assist in alignment and/or prevent rotation (e.g., by interlocking with a receiver) of the hybrid abutment 2100 during installation. In addition, it is noted herein that the receiver engagement section 2124 may be considered a receiver portion operable to be inserted into a jawbone along an installation axis A7i, for purposes of the present disclosure. Further, it is noted that the shaped region 2124 may include an external configuration (e.g., a protrusion that is inserted into a mated receptacle in the receiver) or may include an internal configuration (e.g., a receptacle that is configured to receive a mated protrusion from the receiver), without departing from the scope of the present disclosure.

In addition to the receiver engagement section 2122, a secondary bore or aperture 2128 is within a cavity 2129 within the first portion 2103. For example, the cavity 2129 may serve as a transition region between the first portion 2103 and the second portion 2105, to ensure correct mating between the two portions 2103, 2105 through the seating of the ridge sidewall 2108 on/proximate to the platform 2106. It should be understood that the dimensions of the cavity 2129 are only illustrative, and are not intended to be limiting on the present disclosure.

The secondary bore or aperture 2128 may extend through the shaped region 2124 and exit into the cavity 2129. In some embodiments, the secondary bore or aperture 2128 is operable to engage with a connector 2152 (e.g., a fastener, or the like) operable to couple the hybrid abutment 2100 to a receiver, as described in detail further herein. In one non-limiting example, the secondary bore or aperture 2128 may include threading 2130, where the threading 2130 is operable to engage with complementary threading on the connector 2152. In this regard, the hybrid abutment 2100 and the connector 2152 may be considered components of a system 2150, for purposes of the present disclosure.

As illustrated in FIG. 21B, the restorative axis (e.g., the axis for coupling a restoration to the hybrid abutment 2100) is depicted by the longitudinal axis A7r, and the installation axis (e.g., the axis for coupling the hybrid abutment 2100 to a receiver) is depicted by the longitudinal axis A7i. The longitudinal axes A7r, A7i are not co-axially aligned but instead are offset at an angle relative to one another (e.g., where the angle is substantially equivalent to the angle of the hybrid abutment 2100 including, but not limited to, 17°).

In embodiments, the shaped region 2124 of the receiver engagement section 2122 may generally be of lesser width or diameter than the platform section 2116. Due to the difference in diameters, the receiver interface 2104 may include one or more transition regions 2132 between the various regions 2116, 2124. It is noted the one or more transition regions 2132 may be curved or linear such that the one or more transition regions 2132 create an abrupt change in diameter, a constant slope change in diameter, a change in diameter that is contoured to conform to an arcuate shape between the adjacent regions, or a combination thereof. For example, a transition region 2132 may connect the platform section 2116 and the shaped region 2124, where the transition region 2132 includes an exterior sidewall 2134 that is arcuate to conform to the angle of the hybrid abutment 2100. However, it is noted that the shaped region 2124 of the receiver engagement section 2122 may be of equal or greater width or diameter than the platform section 2116, without departing from the scope of the present disclosure.

The first portion 2103 and the second portion 2105 including mated components of an interlocking assembly 2135. For example, the interlocking assembly 2135 may include threading 2136 in the first portion 2103 and corresponding threading 2138 in the second portion 2105. By way of another example, the interlocking assembly may include any tab-and-groove or other set of interlocking features known in the art.

Interlocking the second portion 2105 with the first portion 2103 closes the cavity 2129 at the seam 2107, enclosing the secondary bore or aperture 2128 (and a head of the connector 2152 installed therein, which is inserted within the second bore or aperture 2128 prior to the interlocking). In this regard, the primary bore or aperture 2118 may be protected by the restoration element such that unwanted matter (e.g., food, saliva, dental cleaning aids, surrounding tissue, etc.) do not get into the hybrid abutment 2100. In addition, the secondary bore or aperture 2128 may be protected from the entrance of unwanted matter by the second portion 2105, and optionally further protected by the restoration element. The use of the first portion 2103 and the second portion 2105 removes the need for an additional plug, such as plug 600, 900 in the single-piece builds or configurations described in the application. In addition, the use of the first portion 2103 and the second portion 2105 allows for the sidewall 2112 to provide a full snap geometry for a restorative, as compared to the partial snap geometry of the sidewall 512 that may be completed by contoured exterior surfaces of the plug 600 and/or the partial snap geometry of the sidewall 812 that may be completed by contoured exterior surfaces of the plug 900, respectively.

Although not illustrated, it should be understood that a straight or substantially straight build or configuration with an interior tool interface 2119 and with the seam 2107 at the platform 2106 is contemplated for the hybrid abutment 2100, without departing from the scope of the present disclosure.

FIGS. 22A-22L illustrate example embodiments of a multi-piece build or configuration of a hybrid abutment 2200, according to one or more embodiments of the present disclosure. For example, FIGS. 22A-22L illustrates an angled hybrid abutment 2200 that may be set at an angle ranging from 0° to 65°. In particular, FIGS. 22A-22F generally illustrate an angled hybrid abutment 2200A with a 17° angle, in accordance with one or more embodiments of the present disclosure. In addition, FIGS. 22G-22L generally illustrate an angled hybrid abutment 2200B with a 30° angle, in accordance with one or more embodiments of the present disclosure. To the extent possible, aspects of the hybrid abutments 300, 500, 800, 1900, 2000, 2100 are interchangeable and usable with the hybrid abutment 2200, and vice versa, unless otherwise noted. In addition, it should be understood that embodiments directed to the “hybrid abutment 2200” are directed to either the hybrid abutment 2200A and/or the hybrid abutment 2200B, unless otherwise noted, without departing from the scope of the present disclosure.

The hybrid abutment 2200 includes a main body 2201 formed from a first portion 2203 and a second portion 2205 separated by a scam 2207. The hybrid abutment 2200 includes a restorative feature 2202 (e.g., in the second portion 2205) and a receiver interface 2204 (e.g., in the first portion 2203), which are separated by a restorative surface or platform 2206. In embodiments, the receiver interface 2204 includes a minimum cuff height (e.g., proximate to a front surface of the hybrid abutment 2200) and a maximum cuff height (e.g., proximate to a rear surface of the hybrid abutment 2200).

The restorative feature 2202 includes a ridge sidewall 2208. For example, the ridge sidewall 2208 may be straight, substantially straight, sloped, or contoured to conform to an arcuate or multi-sided polygonal shape. It is noted that the restorative feature 2202 may be considered a restoration portion of the hybrid abutment 2200, for purposes of the present disclosure. In addition, it is noted that the restorative feature 2202 is operable as a locating or centering feature of the hybrid abutment 2200 with respect to a dental restoration, as described in detail further herein.

In embodiments, the ridge sidewall 2208 may include grooves into which protrusions from a tool may be inserted, without departing from the scope of the present disclosure.

The hybrid abutment 2200 includes a denture section 2210 (e.g., in the second section 2205) with a sidewall 2212 that is contoured to conform to an arcuate shape, which extends between the ridge sidewall 2208 and a proximal surface 2214. It is noted that the denture section 2210 may be considered an overdenture portion of the hybrid abutment 2200, for purposes of the present disclosure.

In some embodiments, the ridge sidewall 2208 may be set at an angle defined relative to the restorative platform 2206. For example, the angle of the sloped surface may be selected such that the ridge sidewall 2208 does not intersect with the denture section 2210. For instance, the ridge sidewall 2208 may form a portion around the denture section 2210.

In embodiments, a platform section 2216 of the receiver interface 2204 that includes the restorative platform 2206 has a greater diameter than the ridge sidewall 2208, and the ridge sidewall 2208 has a greater diameter than the proximal surface 2214. In these embodiments, the arcuate shape of the sidewall 2212 causes the denture section 2210 of the restorative feature 2202 to have a different diameter that at least ranges between the diameter of the ridge sidewall 2208 and the proximal surface 2214 at different cross-sections along the height of the denture section 2210. As described further herein, the arcuate shape of the sidewall 2212 is capable of coupling to a resilient insert or interior contoured coupling surface, depending on what is necessary to couple a particular restoration type to the hybrid abutment 2200.

A primary bore or aperture 2218 extends through the proximal surface 2214 and at least into the denture section 2210. In some embodiments, the primary bore or aperture 2218 is operable to engage with a connector (e.g., a fastener, or the like) operable to couple a restoration element to the hybrid abutment 2200, as described in detail further herein. In one non-limiting example, the primary bore or aperture 2218 may include threading 2220, where the threading 2220 is operable to engage with complementary threading on the connector.

In embodiments, the primary bore or aperture 2218 may include an interior tool interface 2219. In some non-limiting examples, the interior tool interface 2219 includes a polygonal cross-section formed from 2, 3, . . . up to an N number of sides. In some instances, the exterior tool interface includes six sides, or alternatively four sides, to receive and engage with a tool such as a wrench, socket, screwdriver, or other device. In additional instances, the interior tool interface 2219 may include grooves into which protrusions from a tool may be inserted, without departing from the scope of the present disclosure.

The hybrid abutment 2200 includes a receiver engagement section 2222 (e.g., in the first section 2203). In embodiments, at least a portion of the receiver engagement section 2222 includes a shaped region 2224. For example, the shaped region 2224 may be contoured or shaped to have a polygonal cross-section along the length of the shaped region 2224, as shown in FIG. 22A. For instance, the polygonal cross-section may be a hexagon, such that the shaped region 2224 has six sidewalls 2226. By way of another example, the shaped region 2224 may be substantially cylindrical in shape with a single sidewall 2226 that is formed by a circular cross-section along the length of the shaped region 2224.

It is noted the shaped region 2224 may assist in alignment and/or prevent rotation (e.g., by interlocking with a receiver) of the hybrid abutment 2200 during installation. In addition, it is noted herein that the receiver engagement section 2224 may be considered a receiver portion operable to be inserted into a jawbone along an installation axis A8i, for purposes of the present disclosure. Further, it is noted that the shaped region 2224 may include an external configuration (e.g., a protrusion that is inserted into a mated receptacle in the receiver) or may include an internal configuration (e.g., a receptacle that is configured to receive a mated protrusion from the receiver), without departing from the scope of the present disclosure.

In addition to the receiver engagement section 2222, a secondary bore or aperture 2228 is within a cavity 2229 within the first portion 2203. For example, the cavity 2229 may serve as a transition region between the first portion 2203 and the second portion 2205, to ensure correct mating between the two portions 2203, 2205 through the seating of a section of the ridge sidewall 2208 on the second portion 2205 on/in a section of the ridge sidewall 2208 on the first portion 2203. It should be understood that the dimensions of the cavity 2229 are only illustrative, and are not intended to be limiting on the present disclosure.

The secondary bore or aperture 2228 may extend through the shaped region 2224 and exit into the cavity 2229. In some embodiments, the secondary bore or aperture 2228 is operable to engage with a connector 2252 (e.g., a fastener, or the like) operable to couple the hybrid abutment 2200 to a receiver, as described in detail further herein. In one non-limiting example, the secondary bore or aperture 2228 may include threading 2230, where the threading 2230 is operable to engage with complementary threading on the connector 2252. In this regard, the hybrid abutment 2200 and the connector 2252 may be considered components of a system 2250, for purposes of the present disclosure.

As illustrated in FIG. 22B, the restorative axis (e.g., the axis for coupling a restoration to the hybrid abutment 2200) is depicted by the longitudinal axis A8r, and the installation axis (e.g., the axis for coupling the hybrid abutment 2200 to a receiver) is depicted by the longitudinal axis A8i. The longitudinal axes A8r, A8i are not co-axially aligned but instead are offset at an angle relative to one another (e.g., where the angle is substantially equivalent to the angle of the hybrid abutment 2200 including, but not limited to, 17° for hybrid abutment 2200A and/or 30° for hybrid abutment 2200B).

In embodiments, the shaped region 2224 of the receiver engagement section 2222 may generally be of lesser width or diameter than the platform section 2216. Due to the difference in diameters, the receiver interface 2204 may include one or more transition regions 2232 between the various regions 2216, 2224. It is noted the one or more transition regions 2232 may be curved or linear such that the one or more transition regions 2232 create an abrupt change in diameter, a constant slope change in diameter, a change in diameter that is contoured to conform to an arcuate shape between the adjacent regions, or a combination thereof. For example, a transition region 2232 may connect the platform section 2216 and the shaped region 2224, where the transition region 2232 includes an exterior sidewall 2234 that is arcuate to conform to the angle of the hybrid abutment 2200. However, it is noted that the shaped region 2224 of the receiver engagement section 2222 may be of equal or greater width or diameter than the platform section 2216, without departing from the scope of the present disclosure.

The first portion 2203 and the second portion 2205 including mated components of an interlocking assembly 2235. For example, the interlocking assembly 2235 may include threading 2236 in the first portion 2203 and corresponding threading 2238 in the second portion 2205. By way of another example, the interlocking assembly may include any tab-and-groove or other set of interlocking features known in the art.

Interlocking the second portion 2205 with the first portion 2203 closes the cavity 2229 at the seam 2207, enclosing the secondary bore or aperture 2228 (and a head of the connector 2252 installed therein, which is inserted within the second bore or aperture 2228 prior to the interlocking). Unlike the positioning of the seam 2007 at the platform 2006 and the seam 2107 at the platform 2106, the seam 2207 between the first portion 2203 and the second portion 2205 is positioned within the ridge sidewall 2208. Positioning the seam 2207 within the ridge sidewall 2208 causes a first section of the ridge sidewall 2208 is formed with the first portion 2203 and a second section of the ridge sidewall 2208 is formed with the second portion 2205. In this regard, the primary bore or aperture 2218 may be protected by the restoration element such that unwanted matter (e.g., food, saliva, dental cleaning aids, surrounding tissue, etc.) do not get into the hybrid abutment 2200. In addition, the secondary bore or aperture 2228 may be protected from the entrance of unwanted matter by the second portion 2205, and further protected by the restoration element and the seam 2207 is positioned within the restoration element. The use of the first portion 2203 and the second portion 2205 removes the need for an additional plug, such as plug 600, 900 in the single-piece builds or configurations described in the application. In addition, the use of the first portion 2203 and the second portion 2205 allows for the sidewall 2212 to provide a full snap geometry for a restorative, as compared to the partial snap geometry of the sidewall 512 that may be completed by contoured exterior surfaces of the plug 600 and/or the partial snap geometry of the sidewall 812 that may be completed by contoured exterior surfaces of the plug 900, respectively.

Although not illustrated, it should be understood that a straight or substantially build or configuration with an interior tool interface 2219 and with the seam 2207 at the platform 2206 is contemplated for the hybrid abutment 2200, without departing from the scope of the present disclosure

FIGS. 23A-23D illustrate example embodiments of a multi-piece build or configuration of a hybrid abutment 2300, according to one or more embodiments of the present disclosure. For example, it is noted that the hybrid abutment 2300 may be considered a straight, non-angled, or substantially straight abutment 2300, for purposes of the present disclosure. To the extent possible, aspects of the hybrid abutments 300, 500, 800, 1900, 2000, 2100, 2200 are interchangeable and usable with the hybrid abutment 2300, and vice versa, unless otherwise noted.

The hybrid abutment 2300 includes a main body 2301 formed from a first portion 2303 and a second portion 2305 separated by a scam 2307. The hybrid abutment 2300 includes a restorative feature 2302 (e.g., in the second portion 2305) and a receiver interface 2304 (e.g., in the first portion 2303), which are separated by a restorative surface or platform 2306. In embodiments, the receiver interface 2304 includes a minimum cuff height (e.g., proximate to a front surface of the hybrid abutment 2300) and a maximum cuff height (e.g., proximate to a rear surface of the hybrid abutment 2300).

The receiver portion 2304 is operable to be inserted into a jawbone along a restorative or longitudinal axis A9. As illustrated in FIG. 23B, a restorative axis (e.g., the axis for coupling a restoration to the hybrid abutment 2300) and an installation axis of the hybrid abutment 2300 are aligned or coaxial, both being depicted by the longitudinal axis A9.

The restorative feature 2302 includes a ridge sidewall 2308. For example, the ridge sidewall 2308 may be straight, substantially straight, sloped, or contoured to conform to an arcuate or multi-sided polygonal shape. It is noted that the restorative feature 2302 may be considered a restoration portion of the hybrid abutment 2300, for purposes of the present disclosure. In addition, it is noted that the restorative feature 2302 is operable as a locating or centering feature of the hybrid abutment 2300 with respect to a dental restoration, as described in detail further herein.

In embodiments, the ridge sidewall 2308 may include grooves into which protrusions from a tool may be inserted, without departing from the scope of the present disclosure.

The hybrid abutment 2300 includes a denture section 2310 (e.g., in the second section 2305) with a sidewall 2312 that is contoured to conform to an arcuate shape, which extends between the ridge sidewall 2308 and a proximal surface 2314. It is noted that the denture section 2310 may be considered an overdenture portion of the hybrid abutment 2300, for purposes of the present disclosure.

In some embodiments, the ridge sidewall 2308 may be set at an angle defined relative to the restorative platform 2306. For example, the angle of the sloped surface may be selected such that the ridge sidewall 2308 does not intersect with the denture section 2310. For instance, the ridge sidewall 2308 may form a portion around the denture section 2310.

In embodiments, a platform section 2316 of the receiver interface 2304 that includes the restorative platform 2306 has a greater diameter than the ridge sidewall 2308, and the ridge sidewall 2308 has a greater diameter than the proximal surface 2314. In these embodiments, the arcuate shape of the sidewall 2312 causes the denture section 2310 of the restorative feature 2302 to have a different diameter that at least ranges between the diameter of the ridge sidewall 2308 and the proximal surface 2314 at different cross-sections along the height of the denture section 2310. As described further herein, the arcuate shape of the sidewall 2312 is capable of coupling to a resilient insert or interior contoured coupling surface, depending on what is necessary to couple a particular restoration type to the hybrid abutment 2300.

A primary bore or aperture 2318 extends through the proximal surface 2314 and at least into the denture section 2310. In some embodiments, the primary bore or aperture 2318 is operable to engage with a connector (e.g., a fastener, or the like) operable to couple a restoration element to the hybrid abutment 2300, as described in detail further herein. In one non-limiting example, the primary bore or aperture 2318 may include threading 2320, where the threading 2320 is operable to engage with complementary threading on the connector.

In embodiments, the primary bore or aperture 2318 may include an interior tool interface 2319. In some non-limiting examples, the interior tool interface 2319 includes a polygonal cross-section formed from 2, 3, . . . up to an N number of sides. In some instances, the exterior tool interface includes six sides, or alternatively four sides, to receive and engage with a tool such as a wrench, socket, screwdriver, or other device. In additional instances, the interior tool interface 2319 may include grooves into which protrusions from a tool may be inserted, without departing from the scope of the present disclosure.

The hybrid abutment 2300 includes a receiver engagement section 2322 (e.g., in the first section 2303). In embodiments, at least a portion of the receiver engagement section 2322 includes a shaped region 2324. For example, the shaped region 2324 may be contoured or shaped to have a polygonal cross-section along the length of the shaped region 2324, as shown in FIG. 23A. For instance, the polygonal cross-section may be a hexagon, such that the shaped region 2324 has six sidewalls 2326. By way of another example, the shaped region 2324 may be substantially cylindrical in shape with a single sidewall 2326 that is formed by a circular cross-section along the length of the shaped region 2324.

It is noted the shaped region 2324 may assist in alignment and/or prevent rotation (e.g., by interlocking with a receiver) of the hybrid abutment 2300 during installation. In addition, it is noted herein that the receiver engagement section 2324 may be considered a receiver portion operable to be inserted into a jawbone, for purposes of the present disclosure. Further, it is noted that the shaped region 2324 may include an external configuration (e.g., a protrusion that is inserted into a mated receptacle in the receiver) or may include an internal configuration (e.g., a receptacle that is configured to receive a mated protrusion from the receiver), without departing from the scope of the present disclosure.

In addition to the receiver engagement section 2322, a secondary bore or aperture 2328 is within a cavity 2329 within the first portion 2303. For example, the cavity 2329 may serve as a transition region between the first portion 2303 and the second portion 2305, to ensure correct mating between the two portions 2303, 2305 through the seating of a section of the ridge sidewall 2308 on the second portion 2305 on/in a section of the ridge sidewall 2308 on the first portion 2303. It should be understood that the dimensions of the cavity 2329 are only illustrative, and are not intended to be limiting on the present disclosure.

The secondary bore or aperture 2328 may extend through the shaped region 2324 and exit into the cavity 2329. In some embodiments, the secondary bore or aperture 2328 is operable to engage with a connector 2352 (e.g., a fastener, or the like) operable to couple the hybrid abutment 2300 to a receiver, as described in detail further herein. In one non-limiting example, the secondary bore or aperture 2328 may include threading 2330, where the threading 2330 is operable to engage with complementary threading on the connector 2352. In this regard, the hybrid abutment 2300 and the connector 2352 may be considered components of a system 2350, for purposes of the present disclosure.

In embodiments, the shaped region 2324 of the receiver engagement section 2322 may generally be of lesser width or diameter than the platform section 2316. Due to the difference in diameters, the receiver interface 2304 may include one or more transition regions 2332 between the various regions 2316, 2324. It is noted the one or more transition regions 2332 may be curved or linear such that the one or more transition regions 2332 create an abrupt change in diameter, a constant slope change in diameter, a change in diameter that is contoured to conform to an arcuate shape between the adjacent regions, or a combination thereof. For example, a transition region 2332 may connect the platform section 2316 and the shaped region 2324, where the transition region 2332 includes an exterior sidewall 2334 that is arcuate to conform to the angle of the hybrid abutment 2300. However, it is noted that the shaped region 2324 of the receiver engagement section 2322 may be of equal or greater width or diameter than the platform section 2316, without departing from the scope of the present disclosure.

The first portion 2303 and the second portion 2305 including mated components of an interlocking assembly 2335. For example, the interlocking assembly 2335 may include threading 2336 in the first portion 2303 and corresponding threading 2338 in the second portion 2305. By way of another example, the interlocking assembly may include any tab-and-groove or other set of interlocking features known in the art.

Interlocking the second portion 2305 with the first portion 2303 closes the cavity 2329 at the seam 2307, enclosing the secondary bore or aperture 2328 (and a head of the connector 2352 installed therein, which is inserted within the second bore or aperture 2328 prior to the interlocking). Unlike the positioning of the seam 2007 at the platform 2006 and the seam 2107 at the platform 2106, the seam 2307 between the first portion 2303 and the second portion 2305 is positioned within the ridge sidewall 2308. Positioning the seam 2307 within the ridge sidewall 2308 causes a first section of the ridge sidewall 2308 is formed with the first portion 2303 and a second section of the ridge sidewall 2308 is formed with the second portion 2305. In this regard, the primary bore or aperture 2318 may be protected by the restoration element such that unwanted matter (e.g., food, saliva, dental cleaning aids, surrounding tissue, etc.) do not get into the hybrid abutment 2300. In addition, the secondary bore or aperture 2328 may be protected from the entrance of unwanted matter by the second portion 2305, and further protected by the restoration element and the seam 2307 is positioned within the restoration element. In addition, the use of the first portion 2303 and the second portion 2305 allows for the sidewall 2312 to provide a full snap geometry for a restorative, as compared to the partial snap geometry of the sidewall 512 that may be completed by contoured exterior surfaces of the plug 600 and/or the partial snap geometry of the sidewall 812 that may be completed by contoured exterior surfaces of the plug 900, respectively.

It is contemplated that the use of a multi-piece build or configuration is beneficial, as it removes the need for a plug 600, 900 following the insertion of a connector to couple the hybrid abutments to an implant 404, 704, 1004 (or other receiver). Instead, the first portion 2003, 2103, 2203, 2303 may first be seated within the implant 404, 704, 1004 (or other receiver). A connector 2052, 2152, 2252, 2352 may then be inserted into the first portion 2003, 2103, 2203, 2303, coupling the first portion 2003, 2103, 2203, 2303 to the implant 404, 704, 1004 (or other receiver). Further, the second portion 2005, 2105, 2205, 2305 may then be coupled to the first portion 2003, 2103, 2203, 2303, forming the complete body 2001, 2101, 2201, 2301 of the hybrid abutments 2000, 2100, 2200, 2300. This results in a seam 2007, 2107, 2207, 2307 between the first portion 2003, 2103, 2203, 2303 and the second portion 2005, 2105, 2205, 2307 that less complex (e.g., being a substantially circular aperture in the first portion 2003, 2103, 2203, 2303 that receives and mates with a substantially circular plug region of the second portion 2005, 2105, 2205, 2307), as compared to the plug 600, 900 that needs to be contoured to the various regions of the hybrid abutment 500, 800. As previously noted, this also allows for a full snap geometry on the second portion 2005, 2105, 2205, 2305 (e.g., the sidewall 2012, 2112, 2212, 2312) of the hybrid abutment 2000, 2100, 2200, 2300, as compared to the partial snap geometry surface of the sidewall 512, 812 of the hybrid abutment 500, 800 (e.g., that is completed with contoured exterior surfaces of the plug 600, 900 respectively).

FIG. 24A-24D illustrate example embodiments of a multi-piece build or configuration of a monolithic hybrid abutment 2400, according to one or more embodiments of the present disclosure. For example, FIGS. 24A-24D illustrate an angled monolithic hybrid abutment 2400 that may be set at an angle ranging from 0° to 65°. In particular, FIGS. 24A-24D generally illustrate an angled monolithic hybrid abutment 2400 with a 17° angle, in accordance with one or more embodiments of the present disclosure. It is noted that aspects or features of (or embodiments directed to) the hybrid abutments 300, 500, 800, 1900, 2000, 2100, 2200, 2300 may be directed to the monolithic hybrid abutment 2400, to the extent possible without departing from the scope of the present disclosure.

The hybrid abutment 2400 includes a main body 2401 formed from a first portion 2403 and a second portion 2405 separated by a scam 2407. The hybrid abutment 2400 includes a restorative feature 2402 (e.g., in the second portion 2405) and an implant portion 2404 (e.g., in the first portion 2403), which are separated by a restorative surface or platform 2406.

The restorative feature 2402 includes a ridge sidewall 2408. For example, the ridge sidewall 2408 may be straight, substantially straight, sloped, or contoured to conform to an arcuate shape. It is noted that the restorative feature 2402 may be considered a restoration portion of the hybrid abutment 2400, for purposes of the present disclosure. In addition, it is noted that the restorative feature 2402 is operable as a locating or centering feature of the hybrid abutment 2400 with respect to a dental restoration, as described in detail further herein.

In embodiments, the ridge sidewall 2408 may include grooves into which protrusions from a tool may be inserted, without departing from the scope of the present disclosure.

The hybrid abutment 2400 includes a denture section 2410 with a sidewall 2412 that is contoured to conform to an arcuate shape, which extends between the ridge sidewall 2408 and a proximal surface 2414. It is noted that the denture section 2410 may be considered an overdenture portion of the hybrid abutment 2400, for purposes of the present disclosure.

In some embodiments, the ridge sidewall 2408 may include a sloped surface set at an angle defined relative to the restorative platform 2406. For example, the angle of the sloped surface may be selected such that the ridge sidewall 2408 does not intersect with the denture section 2410. For instance, the ridge sidewall 2408 may form a portion of a cone around the denture section 2410.

In embodiments, a platform section 2416 of the receiver interface 2404 that includes the restorative platform 2406 has a greater diameter than the ridge sidewall 2408, and the ridge sidewall 2408 has a greater diameter than the proximal surface 2414. In these embodiments, the arcuate shape of the sidewall 2412 causes the denture section 2410 of the restorative feature 2402 to have a different diameter that at least ranges between the diameter of the ridge sidewall 2408 and the proximal surface 2414 at different cross-sections along the height of the denture section 2410. As described further herein, the arcuate shape of the sidewall 2412 is capable of coupling to a resilient insert or interior contoured coupling surface, depending on what is necessary to couple a particular restoration type to the hybrid abutment 2400.

A bore or aperture 2418 extends through the proximal surface 2414 and at least into the denture section 2410. In some embodiments, the bore or aperture 2418 is operable to engage with a connector (e.g., a fastener, or the like) operable to couple a restoration element to the hybrid abutment 2400, as described in detail further herein. In one non-limiting example, the bore or aperture 2418 may include threading (not shown), where the threading is operable to engage with complementary threading on the connector.

In embodiments, the primary bore or aperture 2418 may include an interior tool interface 2419. In some non-limiting examples, the interior tool interface 2419 includes a polygonal cross-section formed from 2, 3, . . . up to an N number of sides. In some instances, the exterior tool interface includes six sides, or alternatively four sides, to receive and engage with a tool such as a wrench, socket, screwdriver, or other device. In additional instances, the interior tool interface 2419 may include grooves into which protrusions from a tool may be inserted, without departing from the scope of the present disclosure.

As illustrated in FIG. 24B, the restorative axis (e.g., the axis for coupling a restoration to the hybrid abutment 2400) is depicted by the longitudinal axis A10r, and the installation axis (e.g., the axis for along which the implant portion 2404 is operable to be inserted into a jawbone) is depicted by the longitudinal axis A10i. The longitudinal axes A10r, A10i are not co-axially aligned but instead are offset at an angle relative to one another (e.g., where the angle is substantially equivalent to the angle of the hybrid abutment 2400 including, but not limited to, 17°).

The implant portion 2404 includes threading 2420 at a distal end. Although not shown, an aperture or bore may pass through a body 2422 of the implant portion 2404. For example, the aperture or bore may be orthogonal to the installation or longitudinal axis A10i of the implant portion 2404. Additionally, one or more teeth 2424 may be positioned along the body 2422. For example, the one or more teeth may be positioned within the threading 2420. In addition, the one or more teeth may include a tooth proximate to the aperture or bore, such that osseous tissue or other biological tissue may be collected in the aperture or bore during installation and/or to allow for osseointegration with the jawbone by the implant portion 2404 after installation.

The first portion 2403 and the second portion 2405 including mated components of an interlocking assembly 2435. For example, the interlocking assembly 2435 may include threading 2436 in the first portion 2403 and corresponding threading 2438 in the second portion 2405. By way of another example, the interlocking assembly may include any tab-and-groove or other set of interlocking features known in the art.

Interlocking the second portion 2405 with the first portion 2403 closes a cavity 2429 within the first portion 2403 at the seam 2407. For example, the cavity 2429 may serve as a transition region between the first portion 2403 and the second portion 2405, to ensure correct mating between the two portions 2403, 2405 through the seating of a section of the ridge sidewall 2408 on the second portion 2405 on/in a section of the ridge sidewall 2408 on the first portion 2403. It should be understood that the dimensions of the cavity 2429 are only illustrative, and are not intended to be limiting on the present disclosure.

Unlike the positioning of the seam 2007 at the platform 2006 and the seam 2107 at the platform 2106, the seam 2407 between the first portion 2403 and the second portion 2405 is positioned within the ridge sidewall 2408. Positioning the seam 2407 within the ridge sidewall 2408 causes a first section of the ridge sidewall 2408 is formed with the first portion 2403 and a second section of the ridge sidewall 2408 is formed with the second portion 2405. In this regard, the primary bore or aperture 2418 may be protected by the restoration element such that unwanted matter (e.g., food, saliva, dental cleaning aids, surrounding tissue, etc.) do not get into the hybrid abutment 2400. In addition, the cavity 2429 may be protected from the entrance of unwanted matter by the second portion 2405, and further protected by the restoration element and the scam 2407 is positioned within the restoration element. In addition, the use of the first portion 2403 and the second portion 2405 allows for the sidewall 2412 to provide a full snap geometry for a restorative, as compared to the partial snap geometry of the sidewall 512 that may be completed by contoured exterior surfaces of the plug 600 and/or the partial snap geometry of the sidewall 812 that may be completed by contoured exterior surfaces of the plug 900, respectively.

FIGS. 25A-25D illustrate example embodiments of a multi-piece build or configuration of a monolithic hybrid abutment 2500, according to one or more embodiments of the present disclosure. It is noted that the hybrid abutment 2500 may be considered a straight, non-angled, or substantially straight abutment 2500, for purposes of the present disclosure. It is noted that aspects or features of (or embodiments directed to) the hybrid abutments 300, 500, 800, 1900, 2000, 2100, 2200, 2300, 2400 may be directed to the monolithic hybrid abutment 2500, to the extent possible without departing from the scope of the present disclosure.

The hybrid abutment 2500 includes a main body 2501 formed from a first portion 2503 and a second portion 2505 separated by a seam 2507. The hybrid abutment 2500 includes a restorative feature 2502 (e.g., in the second portion 2505) and an implant portion 2504 (e.g., in the first portion 2503), which are separated by a restorative surface or platform 2506.

The restorative feature 2502 includes a ridge sidewall 2508. For example, the ridge sidewall 2508 may be straight, substantially straight, sloped, or contoured to conform to an arcuate shape. It is noted that the restorative feature 2502 may be considered a restoration portion of the hybrid abutment 2500, for purposes of the present disclosure. In addition, it is noted that the restorative feature 2502 is operable as a locating or centering feature of the hybrid abutment 2500 with respect to a dental restoration, as described in detail further herein.

In embodiments, the ridge sidewall 2508 may include grooves into which protrusions from a tool may be inserted, without departing from the scope of the present disclosure.

The hybrid abutment 2500 includes a denture section 2510 with a sidewall 2512 that is contoured to conform to an arcuate shape, which extends between the ridge sidewall 2508 and a proximal surface 2514. It is noted that the denture section 2510 may be considered an overdenture portion of the hybrid abutment 2500, for purposes of the present disclosure.

In some embodiments, the ridge sidewall 2508 may include a sloped surface set at an angle defined relative to the restorative platform 2506. For example, the angle of the sloped surface may be selected such that the ridge sidewall 2508 does not intersect with the denture section 2510. For instance, the ridge sidewall 2508 may form a portion of a cone around the denture section 2510.

In embodiments, a platform section 2516 of the receiver interface 2504 that includes the restorative platform 2506 has a greater diameter than the ridge sidewall 2508, and the ridge sidewall 2508 has a greater diameter than the proximal surface 2514. In these embodiments, the arcuate shape of the sidewall 2512 causes the denture section 2510 of the restorative feature 2502 to have a different diameter that at least ranges between the diameter of the ridge sidewall 2508 and the proximal surface 2514 at different cross-sections along the height of the denture section 2510. As described further herein, the arcuate shape of the sidewall 2512 is capable of coupling to a resilient insert or interior contoured coupling surface, depending on what is necessary to couple a particular restoration type to the hybrid abutment 2500.

A bore or aperture 2518 extends through the proximal surface 2514 and at least into the denture section 2510. In some embodiments, the bore or aperture 2518 is operable to engage with a connector (e.g., a fastener, or the like) operable to couple a restoration element to the hybrid abutment 2500, as described in detail further herein. In one non-limiting example, the bore or aperture 2518 may include threading (not shown), where the threading is operable to engage with complementary threading on the connector.

In embodiments, the primary bore or aperture 2518 may include an interior tool interface 2519. In some non-limiting examples, the interior tool interface 2519 includes a polygonal cross-section formed from 2, 3, . . . up to an N number of sides. In some instances, the exterior tool interface includes six sides, or alternatively four sides, to receive and engage with a tool such as a wrench, socket, screwdriver, or other device. In additional instances, the interior tool interface 2519 may include grooves into which protrusions from a tool may be inserted, without departing from the scope of the present disclosure.

The implant portion 2504 is operable to be inserted into a jawbone along a restorative or longitudinal axis A11. As illustrated in FIG. 25B, the restorative axis (e.g., the axis for coupling a restoration to the hybrid abutment 2500) A11 and the installation axis of the hybrid abutment 2500 are aligned or coaxial.

The implant portion 2504 includes threading 2520 at a distal end. Although not shown, an aperture or bore may pass through a body 2522 of the implant portion 2504. For example, the aperture or bore may be orthogonal to the restorative axis A11 of the implant portion 2504. Additionally, one or more teeth 2524 may be positioned along the body 2522. For example, the one or more teeth may be positioned within the threading 2520. In addition, the one or more teeth may include a tooth proximate to the aperture or bore, such that osseous tissue or other biological tissue may be collected in the aperture or bore during installation and/or to allow for osseointegration with the jawbone by the implant portion 2504 after installation.

The first portion 2503 and the second portion 2505 including mated components of an interlocking assembly 2535. For example, the interlocking assembly 2535 may include threading 2536 in the first portion 2503 and corresponding threading 2538 in the second portion 2505. By way of another example, the interlocking assembly may include any tab-and-groove or other set of interlocking features known in the art.

Interlocking the second portion 2505 with the first portion 2503 closes a cavity 2529 at within the first portion 2503 at the seam 2507. For example, the cavity 2529 may serve as a transition region between the first portion 2503 and the second portion 2505, to ensure correct mating between the two portions 2503, 2505 through the seating of a section of the ridge sidewall 2508 on the second portion 2505 on/in a section of the ridge sidewall 2508 on the first portion 2503. It should be understood that the dimensions of the cavity 2529 are only illustrative, and are not intended to be limiting on the present disclosure.

Unlike the positioning of the seam 2007 at the platform 2006 and the seam 2107 at the platform 2106, the seam 2507 between the first portion 2503 and the second portion 2505 is positioned within the ridge sidewall 2508. Positioning the seam 2507 within the ridge sidewall 2508 causes a first section of the ridge sidewall 2508 is formed with the first portion 2503 and a second section of the ridge sidewall 2508 is formed with the second portion 2505. In this regard, the primary bore or aperture 2518 may be protected by the restoration element such that unwanted matter (e.g., food, saliva, dental cleaning aids, surrounding tissue, etc.) do not get into the hybrid abutment 2500. In addition, the cavity 2529 may be protected from the entrance of unwanted matter by the second portion 2505, and further protected by the restoration element and the seam 2507 is positioned within the restoration element. In addition, the use of the first portion 2503 and the second portion 2505 allows for the sidewall 2512 to provide a full snap geometry for a restorative, as compared to the partial snap geometry of the sidewall 512 that may be completed by contoured exterior surfaces of the plug 600 and/or the partial snap geometry of the sidewall 812 that may be completed by contoured exterior surfaces of the plug 900, respectively.

Although the monolithic hybrid abutments 2400, 2500 are illustrated with respective interior tool interfaces 2419, 2519, it should be understood that the monolithic hybrid abutments 2400, 2500 may alternatively or in addition include exterior tool interfaces, without departing from the scope of the present disclosure. For example, the respective ridge sidewalls 2408, 2508 may be contoured or shaped to receive a tool (e.g., similar to the ridge sidewall 2008 of the hybrid abutment 2000) such that the ridge sidewalls 2408, 2508 may be considered an exterior tool interface, for purposes of the present disclosure. In additional instances, the ridge sidewalls 2408, 2508 may include grooves into which protrusions from a tool may be inserted, without departing from the scope of the present disclosure. In general, it should be understood that any of the hybrid abutments 300, 500, 800, 1900, 2000, 2100, 2200, 2300, 2400, 2500 may include an exterior tool interface and/or an interior tool interface, without departing from the scope of the present disclosure, such that the embodiments provided herein are illustrative and not to be interpreted as limiting.

It is contemplated that a seal (e.g., an adhesive, a fluid seal formed from a gel, liquid or paste such as cement or medical-grade threadlocker, a solid seal such as a gasket, or the like) may be installed between the first portion 2003, 2103, 2203, 2303, 2403, 2503 and the second portion 2005, 2105, 2205, 2305, 2405, 2505, to further prevent unwanted matter from entering within the body 2001, 2101, 2201, 2301, 2401, 2501 of the hybrid abutment 2000, 2100, 2200, 2300, 2400, 2500.

It is contemplated that the various restoratives described throughout the present disclosure may seat on the platform 306, 506, 806, 1906, 2006, 2106, 2206, 2306, 2406, 2506, the ridge sidewalls 308, 508, 808, 1908, 2008, 2108, 2208, 2308, 2408, 2508, and/or the sidewalls 312, 512, 812, 1912, 2012, 2112, 2212, 2312, 2412, 2512, either individually or in combination, when installed on the hybrid abutments 300, 500, 800, 1900, 2000, 2100, 2200, 2300, 2400, 2500, without departing from the scope of the present disclosure.

It is contemplated that the mating regions between the receiver interface 304, 504, 804, 2004, 2104, 2204, 2304 of the hybrid abutment 300, 500, 800, 200, 2100, 2200, 2300 and a receiver may be any internal or external interlocking assembly including, but not limited to, friction or interference fit, external or internal hex (or any polygon shape having 2, 3, . . . up to an N number of sides), seating flat on implant platform, morse taper, tissue level connections, and the like without departing from the scope of the present disclosure.

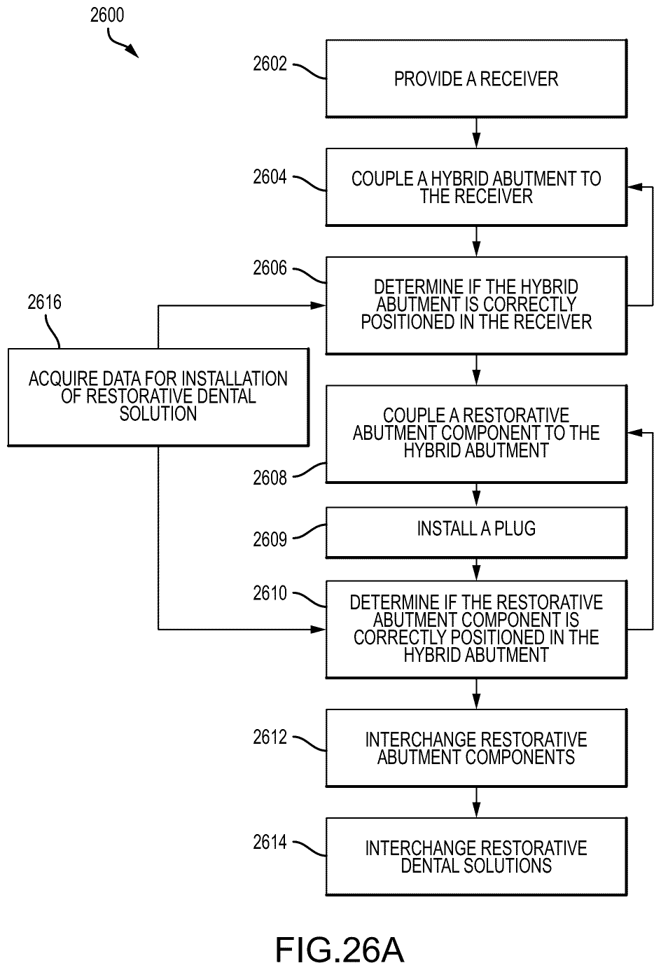

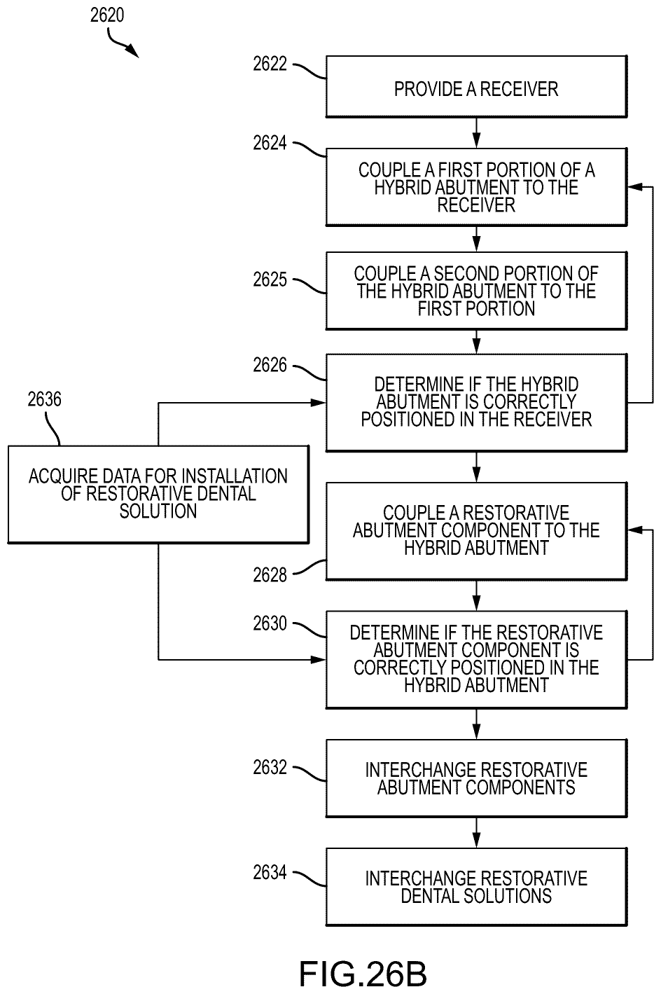

Operation and use of the hybrid abutments as described throughout the present disclosure may include one or more of the following steps, as illustrated in FIG. 26A which depicts a flow diagram of a method or process 2600. It is noted any of the embodiments, aspects, or components of the hybrid abutments 300, 500, 800, 1900 and the corresponding components of the restorative systems 400, 700, 1000 may be understood as being included in one or more of the following steps.

The method optionally includes, but is not limited to, providing 2602 a receiver. In some embodiments, the receiver is an analog. In other embodiments, the receiver is an implant 404, 704, 1004. It is noted that the implant 404, 704, 1004 may be installed by a clinician prior to, during, or after the clinician designing the restorative dental components. In addition, it is noted that the implant 404, 704, 1004 may be pre-installed (e.g., by another person or clinician) prior the beginning the restorative dental components, as the implant 404, 704, 1004 may be re-used from a previous dental restoration and retrofitted to engage components of the restorative dental solutions including the hybrid abutments 300, 500, 800 and accompanying restorative abutment components as described throughout the present disclosure. It is noted that the installing 2602 of the implant 404, 704, 1004 may be optional where the monolithic hybrid abutment 1900 is used.

The method optionally includes, but is not limited to, coupling 2604 a hybrid abutment to the receiver. In some embodiments, where the receiver is an implant 404, 704, 1004, the hybrid abutment 300 may be coupled to the receiver interface 304 via corresponding threading. In other embodiments, the hybrid abutments 500, 800 may be coupled to the implants 404, 704, 1004 via connectors 706, 1006 that pass through a secondary bore or aperture 528, 828 in the hybrid abutments 500, 800, respectively. It is noted that the coupling 2604 may be optional where the monolithic hybrid abutment 1900 is used instead of the hybrid abutments 300, 500, 800 with corresponding receiver interface 304 and/or implants 404, 704, 1004, without departing from the scope of the present disclosure.

The method optionally includes, but is not limited to, determining 2606 if the hybrid abutment is correctly positioned in the receiver. It is noted that the coupling 2604 and/or determining 2606 may be repeated as necessary.

The method includes, but is not limited to, coupling 2608 a restorative abutment component to the hybrid abutment. In some embodiments, a snap cap 702, 1002 (or, generally, a resilient insert or other interior contoured coupling surface) is coupled to a restorative region 310, 510, 810, 1910 of a restorative feature 302, 502, 802, 1902 of the hybrid abutment 300, 500, 800, 1900, respectively. In other embodiments, a restorative component 412, 714 is coupled to the restorative region 310, 510, 810, 1900 and/or a ridge sidewall 308, 508, 808, 1908 of the restorative feature 302, 502, 802, 1902 of the hybrid abutment 300, 500, 800, 1900, respectively.

The method optionally includes, but is not limited to, installing 2609 a plug 600, 900, where the hybrid abutments 500, 800 are coupled 2604 to the receiver.

The method optionally includes, but is not limited to, determining 2610 if the restorative abutment component is correctly positioned in the hybrid abutment. It is noted that the coupling 2608, installing 2609, and/or determining 2610 may be repeated as necessary.

The method optionally includes, but is not limited to, interchanging 2612 restorative abutment components. Due to the configuration of the restorative regions 310, 510, 810 of the hybrid abutments 300, 500, 800, respectively, the restorative abutment components 402, 412, 702, 714, 1002 may be interchanged without removal of the hybrid abutments 300, 500, 800 and/or the receiver. It is noted that the interchanging 2612 may similarly performed between monolithic hybrid abutments 1900, without departing from the scope of the present disclosure.

The method includes, but is not limited to, interchanging 2614 restorative dental solutions. Due to the configuration of the restorative regions 310, 510, 810 of the hybrid abutments 300, 500, 800, 1900, respectively, the restorative dental solutions overdenture solution and the solution may be interchanged without removal of the hybrid abutments 300, 500, 800, 1900 and/or the receiver.

The method optionally includes, but is not limited to, acquiring 2616 data for the installation of restorative dental solutions. For example, the acquired data may be utilized to position the implants, hybrid abutments, and/or protheses (e.g., restorative abutment components) in the patient's mount. By way of another example, the acquired data may be utilized to design the implants, hybrid abutments, and/or protheses (e.g., restorative abutment components) such as a restorative dental solution. The restorative dental solution may include an overdenture solution or a solution to couple to the hybrid abutment. It is noted that the restorative dental solution may be designed by a clinician prior to, during, or after the clinician installing the implant and/or the hybrid abutment and/or the restorative abutment components. In addition, it is noted that the restorative dental solution may be designed and/or installed (e.g., by another person or clinician) after installing the implant and/or the hybrid abutment and/or the restorative abutment components. Further, it is noted the determining may be done by the clinician or by a computer or processing unit (e.g., either following a prompt or automatically) following the receipt of inputs from the clinician).

Operation and use of the hybrid abutments as described throughout the present disclosure may include one or more of the following steps, as illustrated in FIG. 26B which depicts a flow diagram of a method or process 2620. It is noted any of the embodiments, aspects, or components of the hybrid abutments 2000, 2100, 2200, 2300, 2400, 2500 and the corresponding components of the restorative systems 2050, 2150, 2250, 2350 may be understood as being included in one or more of the following steps.

The method optionally includes, but is not limited to, providing 2622 a receiver. In some embodiments, the receiver is an analog. In other embodiments, the receiver is an implant 404, 704, 1004. It is noted that the implant 404, 704, 1004 may be installed by a clinician prior to, during, or after the clinician designing the restorative dental components. In addition, it is noted that the implant 404, 704, 1004 may be pre-installed (e.g., by another person or clinician) prior the beginning the restorative dental components, as the implant 404, 704, 1004 may be re-used from a previous dental restoration and retrofitted to engage components of the restorative dental solutions including the hybrid abutments 2000, 2100, 2200, 2300 and accompanying restorative abutment components as described throughout the present disclosure. It is noted that the installing 2622 of the implant 404, 704, 1004 may be optional where the monolithic hybrid abutments 2400, 2500 are used.

The method optionally includes, but is not limited to, coupling 2624 a first portion of a hybrid abutment to the receiver. In some embodiments, where the receiver is an implant 404, 704, 1004, the first portions 2003, 2103, 2203, 2303 of the hybrid abutments 2000, 2100, 2200, 2300 may be coupled to the implants 404, 704, 1004 via connectors 2052, 2152, 2252, 2352 that pass through a secondary bore or aperture 2028, 2128, 2228, 2328 in the hybrid abutments 2000, 2100, 2200, 2300, respectively. It is noted that step 2624 may be optional where a monolithic hybrid abutment 2400, 2500 with a first portion 2403, 2503 is used instead of the hybrid abutments 2000, 2100, 2200, 2300 with corresponding implants 404, 704, 1004, without departing from the scope of the present disclosure.

The method includes, but is not limited to, coupling 2625 a second portion of the hybrid abutment to the first portion of the hybrid abutment. In some embodiments, the second portions 2005, 2105, 2205, 2305, 2405, 2505 may be coupled to the first portions 2003, 2103, 2203, 2303, 2403, 2403 of the hybrid abutments 2000, 2100, 2200, 2300, 2400, 2500, respectively. For example, mated threading 2036, 2136, 2236, 2336, 2436, 2536 of the first portions 2003, 2103, 2203, 2303, 2403, 2503 and threading 2038, 2138, 2238, 2338, 2438, 2538 of the second portions 2005, 2105, 2205, 2305, 2405, 2505 may be joined together.

In an optional step 2326, the method includes, but is not limited to, determining if the hybrid abutment is correctly positioned in the receiver. It is noted that the coupling 2624, coupling 2625, and/or determining 2626 may be repeated as necessary.

The method includes, but is not limited to, coupling 2628 a restorative abutment component to the hybrid abutment. In some embodiments, a snap cap 702, 1002 (or, generally, a resilient insert or other interior contoured coupling surface) is coupled to a restorative region 2010, 2110, 2210, 2310, 2410, 2510 of a restorative feature 2002, 2102, 2202, 2302, 2402, 2502 of the hybrid abutment 2000, 2100, 2200, 2300, 2400, 2500, respectively. In other embodiments, a restorative component 412, 714 is coupled to the restorative region 2010, 2110, 2210, 2310, 2410, 2510 and/or a ridge sidewall 2008, 2108, 2208, 2308, 2408, 2508 of the restorative feature 2002, 2102, 2202, 2302, 2402, 2502 of the hybrid abutment 2000, 2100, 2200, 2300, 2400, 2500, respectively.

The method optionally includes, but is not limited to, determining 2630 if the restorative abutment component is correctly positioned in the hybrid abutment. It is noted that the coupling 2628 and determining 2630 may be repeated as necessary.

The method optionally includes, but is not limited to, interchanging 2632 restorative abutment components. Due to the configuration of the restorative regions 2010, 2110, 2210, 2310 of the hybrid abutments 2000, 2100, 2200, respectively, the restorative abutment components 402, 412, 702, 714, 1002 may be interchanged without removal of the hybrid abutments 2000, 2100, 2200, 2310 and/or the receiver. It is noted that the interchanging 2632 may similarly performed with monolithic hybrid abutments 2400, 2500, without departing from the scope of the present disclosure.

The method optionally includes, but is not limited to, interchanging 2634 restorative dental solutions. Due to the configuration of the restorative regions 2010, 2110, 2210, 2310, 2410, 2510 of the hybrid abutments 2000, 2100, 2200, 2300, 2400, 2510, respectively, the restorative dental solutions overdenture solution and the solution may be swapped without removal of the hybrid abutments 2000, 2100, 2200, 2300, 2400, 2500 and/or the receiver.

The method optionally includes, but is not limited to, acquiring 2636 data for the installation of restorative dental solutions. For example, the acquired data may be utilized to position the implants, hybrid abutments, and/or protheses (e.g., restorative abutment components) in the patient's mount. By way of another example, the acquired data may be utilized to design the implants, hybrid abutments, and/or protheses (e.g., restorative abutment components) such as a restorative dental solution. The restorative dental solution may include an overdenture solution or a solution to couple to the hybrid abutment. It is noted that the restorative dental solution may be designed by a clinician prior to, during, or after the clinician installing the implant and/or the hybrid abutment and/or the restorative abutment components. In addition, it is noted that the restorative dental solution may be designed and/or installed (e.g., by another person or clinician) after installing the implant and/or the hybrid abutment and/or the restorative abutment components. Further, it is noted the determining may be done by the clinician or by a computer or processing unit (e.g., either following a prompt or automatically) following the receipt of inputs from the clinician).

The acquiring 2616 of data in FIG. 26A and/or acquiring 2636 of data in FIG. 26B may include one or more of the following substeps or subprocesses corresponding to a transient (or in-between) installation phase (or phases) that exist between implant placement and the “final” restoration. For example, the substeps or subprocesses may include, but are not limited to, helping heal the tissue, protecting the implant, supporting a temporary restoration (full arch or other restoration), deriving coordinate data from a digital scan, acquiring coordinate data from a temporarily placed marker, physically picking up the location of the hybrid abutment, and the like. In some instances, the data acquisition methods may include, but are not limited to, photography, computer tomography (CT) scanning, intra-oral scanning, photogrammetry, laser scanning, desktop (or extra-oral) scanning, magnetic resonance imaging (MRI) scanning, robotically sensed/probed/detected imaging, video recording, other data acquisition methods both with and without a fixed common coordinate system, a combination or one or more of these methods above, and the like. Non-limiting examples of substeps or subprocesses corresponding to a transient (or in-between) installation phase (or phases) are found in U.S. Pat. No. 10,327,869, issued on Jun. 25, 2019, and U.S. Pat. No. 10,831,729, issued on Oct. 27, 2020, which are each incorporated herein by reference in the entirety.

In this regard, the hybrid abutment of the present disclosure enables a broad range of restoration types and/or styles, while also enabling the restoration type and/or style to be adapted over time based on patient abilities (e.g., ability to maintain a fixed restoration versus maintaining a daily removable restoration), patient finances (e.g., starting with a simple and cost-efficient removable restoration before advancing to a highly aesthetic (but more costly) fixed restoration), and technological changes and material advancements. The hybrid abutments of the present disclosure facilitate changes over time while minimizing the likelihood of having to replace the other components, as compared to needing to change the abutment and/or implant and complete restoration in existing dental restoration systems. In one non-limiting example, a fixed restoration could be retrofitted with the hybrid abutments of the present disclosure to be removable and vice versa, as compared to needing to make an entirely new restoration and/or change out the underlying components (at minimum the abutments, but also in some cases the implants) in existing dental restoration systems.

It is noted that aspects of the present disclosure are directed to components both disclosed and not disclosed in this disclosure exist to facilitate this in-between phase, during which the implants and tissue are healing and the necessary data is being acquired to support the design and fabrication of a temporary or permanent prosthesis or dental restoration. These components are capable of interfacing with the hybrid abutment specified throughout the disclosure as a part of steps of a process of installing the dental restoration.

While the steps have been discussed and illustrated in relation to a particular sequence of events, it should be appreciated that changes, additions, and omissions to this sequence can occur without materially affecting the operation of the disclosed embodiments, configuration, and aspects.

The systems, devices and methods discussed in the present application are directed to hybrid dental abutments for restorative solutions. The hybrid dental abutments provide an improvement over the abutment and the overdenture abutment individually, while also providing a singular solution from which a wide range of removable and fixed restoration solutions can be achieved. The improvements of the hybrid dental abutment re-configures select aspects reduce the overall height of the restoration system to a minimum. In addition, the improvements of the hybrid dental abutment allow for the usability of both the abutment geometry and the overdenture abutment geometry.

The hybrid abutments 300, 500, 800, 1900, 2000, 2100, 2200, 2300, 2400, 2500 along with the corresponding caps or secondary or restorative abutment components 402, 702, 1002, 1319 and the exemplary restorative component 1210, 1300 provides a full spectrum of restorative solutions for both removable and fixed usage, including for both overdenture solutions and abutment solutions. The hybrid nature of the hybrid abutments 300, 500, 800, 1900, 2000, 2100, 2200, 2300, 2400, 2500 provides a clinician with the ability to defer deciding whether to install an overdenture solution or an abutment in a patient, as either restorative solution may be covered to the hybrid abutments 300, 500, 800, 1900, 2000, 2100, 2200, 2300, 2400, 2500. For example, a patient may start with a more cost-effective overdenture-style restoration, which has a shorter lifespan than a fixed-style restoration, and then upgrade to a fixed-style restoration without having to change out the abutments.

In addition, backwards compatibility options exist for restorative components that include interfacing with the hybrid abutments 300, 500, 800, 1900, 2000, 2100, 2200, 2300, 2400, 2500, as the dimensions used for the low-profile system may be similar to the standard dimensions for known abutments. Further, the overall height or compactness of a known abutment is maintained with the hybrid abutments 300, 500, 800, 1900, 2000, 2100, 2200, 2300, 2400, 2500, with little or no increase in height as compared to a known overdenture solution. Maintaining a substantially similar height is beneficial so that the hybrid abutments 300, 500, 800, 1900, 2000, 2100, 2200, 2300, 2400, 2500 are compatible with existing restoratives for a standard or known abutment system. However, it is noted that the total stack-up height for the dental restoration system may also be decreased with the configuration of the abutment solution and the overdenture solution on a single hybrid abutment 300, 500, 800, 1900, 2000, 2100, 2200, 2300, 2400, 2500. By reducing the cone height, the stack-up height of existing or known fixed abutment restoratives may be maintained while also reducing the overdenture snapped restoratives, also leading to opportunities to create new fixed restoratives are available to reduce the height of both the abutment restorations and the overdenture solution restorations.

Further, integrating the overdenture solutions connection type with the abutment connection type, when used in conjunction with resilient inserts, allows for the leveraging and usage of “snap on/off” components throughout the restorative process.

It is noted herein that the hybrid abutments 300, 500, 800, 1900, 2000, 2100, 2200, 2300, 2400, 2500 are not limited to usage with the various dental restoratives/prostheses and/or the implants described herein. In addition, it should be understood any modifications that may be necessary to couple to the hybrid abutments 300, 500, 800, 1900, 2000, 2100, 2200, 2300, 2400, 2500 to other dental restoratives/prostheses and/or the implants not described herein are contemplated, without departing from the scope of the present disclosure.

In embodiments, select aspects of the hybrid abutments 300, 500, 800, 1900, 2000, 2100, 2200, 2300, 2400, 2500 may be parts of the respective implants and/or the dental restorations to which the hybrid abutments 300, 500, 800, 1900, 2000, 2100, 2200, 2300, 2400, 2500 arc coupled. For example, the hybrid abutments 300, 500, 800, 1900, 2000, 2100, 220, 2300, 2400, 25000 could be fully part of the implant, and/or the dental restoration could be monolithic and include the mating component geometry. In one instance, where a resilient insert is required, the insert could be placed in the monolithic dental restoration, or be assembled to or integrated with the hybrid abutments 300, 500, 800, 1900, 2000, 2100, 2200, 2300, 2400, 2500.

Each of the following non-limiting examples may stand on its own, or may be combined in various permutations or combinations with one or more of the other examples.

Example 1 is a hybrid abutment for a restorative dental system, the abutment comprising: a restoration portion and an overdenture portion, wherein the restoration portion and the overdenture portion are each operable to couple to at least one restorative abutment component of a plurality of restorative abutment components along a restorative axis; a receiver interface comprising at least one region operable to couple to a corresponding region on a receiver along an installation axis; and a restorative platform separating the restoration portion and the overdenture portion from the receiver interface, wherein the plurality of restorative abutment components are interchangeable without changing the hybrid abutment.

In Example 2, the subject matter of Example 1 optionally includes wherein the restorative axis and the installation axis are coaxial, and wherein the restoration portion, the overdenture portion, and the receiver interface are substantially straight.

In Example 3, the subject matter of Example 2 optionally further comprises a bore at least within the restoration portion, wherein the bore is operable to receive a connector to secure a restorative abutment component of the plurality of restorative abutment components to the restoration portion along the restorative axis.

In Example 4, the subject matter of Example 2 optionally includes the at least one region of the receiver interface comprising threading at a distal end of the receiver interface, wherein the threading is operable to secure the receiver interface to threading in the corresponding region of the receiver along the installation axis.

In Example 5, the subject matter of Example 1 optionally further comprises a restoration bore at least within the restoration portion, wherein the restoration bore is operable to receive a restoration connector to secure a restorative abutment component of the plurality of restorative abutment components to the restoration portion at the angle and along the restorative axis.

In Example 6, the subject matter of Example 1 optionally further includes wherein the restoration bore includes an interior tool interface.

In Example 7, the subject matter of Example 1 optionally includes wherein the restorative axis and the installation axis are offset at an angle, and wherein the restoration portion and the overdenture portion are each offset at an angle from the receiver interface.

In Example 8, the subject matter of Example 7 optionally further comprises a receiver bore within the restoration portion, the overdenture portion, and the receiver interface, wherein the receiver bore is operable to receive a receiver connector to secure the receiver interface to the receiver along the installation axis.

In Example 9, the subject matter of Example 8 optionally includes wherein the receiver bore is operable to receive a plug that is configured to prevent matter from entering an interior of the hybrid abutment via the receiver bore.

In Example 10, the subject matter of Example 1 optionally includes wherein the restoration portion, the overdenture portion, and the receiver interface are components of a main body for the hybrid abutment, and wherein the main body comprises a first portion and a second portion separated by a seam.

In Example 11, the subject matter of Example 10 optionally includes wherein the scam is located between a platform of the first portion and a ridge sidewall of the restoration portion on the second portion.

In Example 12, the subject matter of Example 10 optionally includes wherein the seam is located within a ridge sidewall of the restoration portion such that the ridge sidewall has sections in both the first portion and the second portion.

In Example 13, the subject matter of Example 1 optionally includes wherein a ridge sidewall of the restoration portion that is an exterior tool interface.

In Example 14, the subject matter of Example 1 optionally includes wherein the receiver is an implant operable to be installed within a jawline of a patient.

Example 15 is a restorative dental system, comprising: a plurality of restorative abutment components; and a hybrid abutment, comprising: a restoration portion and an overdenture portion, wherein the restoration portion and the overdenture portion are each operable to couple to at least one restorative abutment component of the plurality of restorative abutment components along a restorative axis; a receiver interface comprising at least one region operable to couple to a corresponding region on a receiver along an installation axis; and a restorative platform separating the restoration portion and the overdenture portion from the receiver interface, wherein the plurality of restorative abutment components are interchangeable without changing the hybrid abutment.

In Example 16, the subject matter of Example 15 optionally includes wherein the plurality of restorative abutment components includes a resilient member that defines an interior cavity with an interior arcuate surface, wherein the overdenture portion includes an exterior sidewall that is contoured to conform to the interior arcuate surface of the resilient member, and wherein the resilient member is at least partially embedded within an overdenture.

In Example 17, the subject matter of Example 15 optionally includes wherein the plurality of restorative abutment components includes a restorative component that at least includes an interior cavity, wherein the restoration portion includes a ridge sidewall that is contoured to conform to an interior surface of the restoration portion.

In Example 18, the subject matter of Example 16 optionally includes wherein the restorative component includes a resilient member that defines the interior cavity, wherein the resilient member includes an interior arcuate surface on a portion of the interior cavity, and wherein the restoration portion includes an exterior sidewall that is contoured to conform to the interior arcuate surface of the resilient member.

In Example 19, the subject matter of Example 15 optionally includes wherein the plurality of restorative abutment components includes a restorative component with a first proximal portion with a channel and a neck, and a second distal portion with the interior cavity that is operable to engage the hybrid abutment, wherein the channel is removable from the neck.

In Example 20, the subject matter of Example 15 optionally includes wherein the restorative axis and the installation axis are coaxial, and wherein the restoration portion and the receiver interface are substantially straight.

In Example 21, the subject matter of Example 20 optionally further comprises a bore at least within the restoration interface, wherein the bore is operable to receive a connector to secure a restorative abutment component of the plurality of restorative abutment components to the restoration interface along the restorative axis.

In Example 22, the subject matter of Example 20 optionally includes the at least one region of the receiver interface comprising threading at a distal end of the receiver interface, wherein the threading is operable to secure the receiver interface to threading in the corresponding region of the receiver along the installation axis.

In Example 23, the subject matter of Example 15 optionally includes wherein the restorative axis and the installation axis are offset at an angle, and wherein the restoration portion and the overdenture portion are each offset at an angle from the receiver interface.

In Example 24, the subject matter of Example 23 optionally further comprises a restoration bore at least within the restoration portion, wherein the restoration bore is operable to receive a restoration connector to secure a restorative abutment component of the plurality of restorative abutment components to the restoration portion at the angle and along the restorative axis.

In Example 25, the subject matter of Example 23 optionally further comprises a receiver bore within the restoration portion, the overdenture portion, and the receiver interface, wherein the receiver bore is operable to receive a receiver connector to secure the receiver interface to the receiver along the installation axis.

In Example 26, the subject matter of Example 23 optionally further comprises a plug insertable into the receiver bore and configured to prevent matter from entering an interior of the hybrid abutment via the receiver bore.

Example 27 is a method for installing a dental restorative system, the method comprising: coupling a hybrid abutment to a receiver; and coupling a restorative abutment component of a plurality of restorative abutment components to at least one of a restoration portion and an overdenture portion of the hybrid abutment, wherein the restoration portion and the overdenture portion are each operable to couple to at least one restorative abutment component of the plurality of restorative abutment components along a restorative axis, wherein the plurality of restorative abutment components are interchangeable without changing the hybrid abutment.

In Example 28, the subject matter of Example 27 optionally further comprises inserting a plug within a receiver bore of the hybrid abutment after insertion of a connector into the receiver bore to couple the hybrid abutment to the receiver.

In Example 29, the subject matter of Example 27 optionally further includes wherein coupling the hybrid abutment to the receiver comprises: coupling a first portion of the hybrid abutment to the receiver; inserting a connector into a receiver bore and a cavity within the first portion of the hybrid abutment; and coupling a second portion of the hybrid abutment to the first portion of the hybrid abutment.

In Example 30, the subject matter of Example 27 optionally includes wherein coupling a restorative abutment component of a plurality of restorative abutment components to the hybrid abutment comprises: engaging a resilient insert within the restorative abutment component to the hybrid abutment; or engaging the resilient insert within the restorative abutment component to the hybrid abutment and coupling the restorative abutment component to the hybrid abutment via a connector, wherein the restorative abutment component is interchangeable between being coupled to the hybrid abutment via the resilient insert and the connector to only being coupled to the hybrid abutment via the resilient insert.

In Example 31, the subject matter of Example 27 optionally further comprises acquiring data for the installation of restorative dental solutions. The acquired data is for at least one of positioning one or more of the receiver, the hybrid abutment, and the plurality of restorative abutment components; and designing one or more of the receiver, the hybrid abutment, and the plurality of restorative abutment components.

Example 32 is a hybrid abutment for a restorative dental system, the abutment comprising: a restoration portion and an overdenture portion, wherein the restoration portion and the overdenture portion are each operable to couple to at least one restorative abutment component of a plurality of restorative abutment components along a restorative axis; an implant portion operable to be inserted into a jawbone along an installation axis; and a restorative platform separating the restoration portion and the overdenture portion from the implant portion, wherein the plurality of restorative abutment components is interchangeable without changing the hybrid abutment.

In Example 33, the subject matter of Example 32 optionally further includes wherein the restoration portion, the overdenture portion, and the implant portion are components of a main body for the hybrid abutment, and wherein the main body comprises a first portion and a second portion separated by a seam.

In Example 34, the subject matter of Example 33 optionally further includes wherein the seam is located between a platform of the first portion and a ridge sidewall of the restoration portion on the second portion.

In Example 35, the subject matter of Example 33 optionally further includes wherein the seam is located within a ridge sidewall of the restoration portion such that the ridge sidewall has sections in both the first portion and the second portion.

In additional Examples, any one or more of the above aspects/embodiments as substantially disclosed herein.

In additional Examples, any one or more of the aspects/embodiments as substantially disclosed herein optionally in combination with any one or more other aspects/embodiments as substantially disclosed herein.

In additional Examples, one or means adapted to perform any one or more of the above aspects/embodiments as substantially disclosed herein.

In additional Examples, any one or more of the features disclosed herein.

In additional Examples, any one or more of the features as substantially disclosed herein.

In additional Examples, any one or more of the features as substantially disclosed herein in combination with any one or more other features as substantially disclosed herein.

In additional Examples, any one of the aspects/features/embodiments in combination with any one or more other aspects/features/embodiments.

In additional Examples, use of any one or more of the aspects or features as disclosed herein.

It is to be appreciated that any feature described herein can be claimed in combination with any other feature(s) as described herein, regardless of whether the features come from the same described embodiment.

The above detailed description includes references to the accompanying drawings, which form a part of the detailed description. The drawings show, by way of illustration, specific embodiments in which the present disclosure can be practiced. These embodiments are also referred to herein as “examples.” Such examples can include elements in addition to those shown or described. However, examples are also contemplated in which only those elements shown or described are provided. Moreover, examples are also contemplated using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. The transitional phrase “consisting of” excludes any element, step, or ingredient not specified in the claim, but does not exclude additional components or steps that are unrelated to the disclosure such as impurities ordinarily associated therewith. The transitional phrase “consisting essentially of” limits the scope of a claim to the specified materials or steps and those that do not materially affect the basic and novel characteristic(s) of the claimed present disclosure. Moreover, in the following claims, the terms “first,” “second,” and “third,” etc. are used merely as labels, and are not intended to impose numerical requirements on their objects.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or a class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The above description is intended to be illustrative, and not restrictive. For example, the above-described examples (or one or more aspects thereof) may be used in combination with each other. Other embodiments can be used, such as by one of ordinary skill in the art upon reviewing the above description. A number of variations and modifications of the disclosure can be used. It would be possible to provide for some features of the disclosure without providing others. In addition, it would be possible to combine some features of the disclosure without combining all.

References in the specification to “being operable” or “is operable” may be understood as “being configured to” or “is configured to,” “being capable of” or “is capable of,” and the like.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably, and include any type of methodology, process, mathematical operation, or technique.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

Unless otherwise indicated, all numbers expressing quantities, dimensions, conditions, ratios, ranges, and so forth used in the specification and claims are to be understood as being modified in all instances by the term “about” or “approximately” or “substantially”. Accordingly, unless otherwise indicated, all numbers expressing quantities, dimensions, conditions, ratios, ranges, and so forth used in the specification and claims may be increased or decreased by about approximately 10%, or in some instances by substantially 5%, to achieve satisfactory results. Additionally, where the meaning of the terms “about” or “approximately” or “substantially” as used herein would not otherwise be apparent to one of ordinary skill in the art, the terms “about” and “approximately” should be interpreted as meaning within plus or minus 10% of the stated value and, in some instances, the term “substantially” should be interpreted as meaning within plus or minus 5% of the stated value.

All ranges described herein may be reduced to any sub-range or portion of the range, or to any value within the range without deviating from the present disclosure. For example, the range “5 to 55” includes, but is not limited to, the sub-ranges “5 to 20” as well as “17 to 54.”

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present disclosure should be determined with reference to the appended claims, along with the full scope of equivalents to which such claims are entitled.

What is claimed is:

1. A hybrid abutment for a restorative dental system, the hybrid abutment comprising:
a restoration portion and an overdenture portion, wherein the restoration portion and the overdenture portion are each operable to couple to at least one restorative abutment component of a plurality of restorative abutment components along a restorative axis;
a receiver interface comprising at least one region operable to couple to a corresponding region on a receiver along an installation axis; and
a restorative platform separating the restoration portion and the overdenture portion from the receiver interface,
wherein the plurality of restorative abutment components are interchangeable without changing the hybrid abutment.

2. The hybrid abutment of claim 1, wherein the restorative axis and the installation axis are coaxial, and wherein the restoration portion, the overdenture portion, and the receiver interface are substantially straight.

3. The hybrid abutment of claim 1, further comprising a restoration bore at least within the restoration portion, wherein the restoration bore is operable to receive a restoration connector to secure a restorative abutment component of the plurality of restorative abutment components to the restoration portion along the restorative axis.

4. The hybrid abutment of claim 3, wherein the restoration bore includes an interior tool interface.

5. The hybrid abutment of claim 1, wherein the restorative axis and the installation axis are offset at an angle, and wherein the restoration portion and the overdenture portion are each offset at an angle from the receiver interface.

6. The hybrid abutment of claim 5, further comprising a receiver bore within the restoration portion, the overdenture portion, and the receiver interface, wherein the receiver bore is operable to receive a receiver connector to secure the receiver interface to the receiver along the installation axis.

7. The hybrid abutment of claim 5, wherein the receiver bore is operable to receive a plug that is configured to prevent matter from entering an interior of the hybrid abutment via the receiver bore.

8. The hybrid abutment of claim 1, wherein the restoration portion, the overdenture portion, and the receiver interface are components of a main body for the hybrid abutment, and wherein the main body comprises a first portion and a second portion separated by a seam.

9. The hybrid abutment of claim 8, wherein the seam is located between a platform of the first portion and a ridge sidewall of the restoration portion on the second portion.

10. The hybrid abutment of claim 8, wherein the seam is located within a ridge sidewall of the restoration portion such that the ridge sidewall has sections in both the first portion and the second portion.

11. The hybrid abutment of claim 1, wherein a ridge sidewall of the restoration portion is an exterior tool interface.

12. The hybrid abutment of claim 1, wherein the receiver is an implant operable to be installed within a jawline of a patient.

13. A restorative dental system, comprising:
a plurality of restorative abutment components; and
a hybrid abutment, comprising:
a restoration portion and an overdenture portion, wherein the restoration portion and the overdenture portion are each operable to couple to at least one restorative abutment component of the plurality of restorative abutment components along a restorative axis;
a receiver interface comprising at least one region operable to couple to a corresponding region on a receiver along an installation axis; and
a restorative platform separating the restoration portion and the overdenture portion from the receiver interface,
wherein the plurality of restorative abutment components are interchangeable without changing the hybrid abutment.

14. The restorative dental system of claim 13, wherein the plurality of restorative abutment components includes a resilient member that defines an interior cavity with an interior arcuate surface, wherein the overdenture portion includes an exterior sidewall that is contoured to conform to the interior arcuate surface of the resilient member, and wherein the resilient member is at least partially embedded within an overdenture.

15. The restorative dental system of claim 13, wherein the plurality of restorative abutment components includes a restorative component that at least includes an interior cavity, wherein the restoration portion includes a ridge sidewall that is contoured to conform to an interior surface of the restoration portion.

16. The restorative dental system of claim 15, wherein the plurality of restorative abutment components includes a restorative component with a first proximal portion with a channel and a neck, and a second distal portion with the interior cavity that is operable to engage the hybrid abutment, wherein the channel is removable from the neck.

17. A method for installing a dental restorative system, the method comprising:
coupling a hybrid abutment to a receiver; and
coupling a restorative abutment component of a plurality of restorative abutment components to at least one of a restoration portion and an overdenture portion of the hybrid abutment, wherein the restoration portion and the overdenture portion are each operable to couple to at least one restorative abutment component of the plurality of restorative abutment components along a restorative axis,
wherein the plurality of restorative abutment components are interchangeable without changing the hybrid abutment.

18. The method of claim 17, the method further comprising:
inserting a plug within a receiver bore of the hybrid abutment after insertion of a connector into the receiver bore to couple the hybrid abutment to the receiver.

19. The method of claim 17, wherein coupling the hybrid abutment to the receiver comprises:
coupling a first portion of the hybrid abutment to the receiver;
inserting a connector into a receiver bore and a cavity within the first portion of the hybrid abutment; and
coupling a second portion of the hybrid abutment to the first portion of the hybrid abutment.

20. The method of claim 17, wherein coupling a restorative abutment component of a plurality of restorative abutment components to the hybrid abutment comprises:
engaging a resilient insert within the restorative abutment component to the hybrid abutment; or
engaging the resilient insert within the restorative abutment component to the hybrid abutment and coupling the restorative abutment component to the hybrid abutment via a connector,
wherein the restorative abutment component is interchangeable between being coupled to the hybrid abutment via the resilient insert and the connector to only being coupled to the hybrid abutment via the resilient insert.
